(19) United States
(12) Patent Application Publication
(10) Pub. No.: US 2018/0282017 A1
(43) Pub. Date: Oct. 4, 2018

(54) COMPOSITE PALLET

(71) Applicant: Bastian Solutions, LLC, Indianapolis, IN (US)

(72) Inventors: William A. Bastian, II, Carmel, IN (US); Garrett Clark, Carmel, IN (US); Sean Regan, Brownsburg, IN (US)

(73) Assignee: Bastian Solutions, LLC, Indianapolis, IN (US)

(21) Appl. No.: 15/941,771

(22) Filed: Mar. 30, 2018

Related U.S. Application Data
(63) Continuation-in-part of application No. 15/941,416, filed on Mar. 30, 2018.
(60) Provisional application No. 62/479,975, filed on Mar. 31, 2017.
(60) Provisional application No. 62/479,701, filed on Mar. 31, 2017.
(60) Provisional application No. 62/479,701, filed on Mar. 31, 2017.

(51) Int. Cl. B65D 19/00; B28B 1/16

(52) U.S. Cl. CPC B65D 19/0069; B28B 1/16; B65D 2519/00039; B65D 2519/00044; B65D 2519/00562; B65D 2519/00273; B65D 2519/00293; B65D 2519/00373; B65D 2519/00144

(57) ABSTRACT

A composite pallet is made of concrete fill material that is enclosed in a frame structure. The frame structure includes a first frame member and a second frame member. The first frame member has a first frame member cavity that contains the concrete fill material. The first frame member has a tenon, and the second frame member has a mortice in which the tenon of the first frame member is received. The tenon of the first frame member defines a fill gap through which the fill material is able to flow during manufacturing. The frame structure is made of sheet metal that has seams located inside the frame structure.

### CROSS REFERENCE TO RELATED APPLICATIONS

This application claims the benefit of U.S. Provisional Patent Application No. 62/479,975, filed on Mar. 31, 2017, which is hereby incorporated by reference.

This application claims the benefit of U.S. Provisional Patent Application No. 62/479,701, filed on Mar. 31, 2017, which is hereby incorporated by reference.

This application is a continuation-in-part of U.S. patent application Ser. No. 15/941,416, filed on Mar. 30, 2018, entitled “Fiber Reinforced Composite Core Formulation” (Attorney Docket No. 003436-000144), which claims the benefit of U.S. Provisional Patent Application No. 62/479,701, filed on Mar. 31, 2017, which are hereby incorporated by reference.

### BACKGROUND

Pallets are widely used throughout industry because they make it easier to move heavy loads. Most pallets can easily carry a load of 1,000 kg (2,205 lb.) or even more. Typical pallets are designed to be hauled by forklift trucks of different sizes or even by hand-pumped and hand-drawn pallet jacks. For environmental and economic purposes, there has been a trend to recycle and, more significantly, reuse pallets. Traditional pallets are made from inexpensive wood. However, there are a number of significant drawbacks to wood pallets. While the wood in the pallet can be recycled, wood pallets have a tendency to break and splinter after repeated use. Wood pallets typically last for about 10 shipping trips or runs. Nails at times pop from the pallet which can be hazardous. Wood pallets are undesirable for international shipments because they can harbor invasive insects and plant diseases. Although wood can be heat treated or chemically fumigated, wood pallets still might not be allowed in a number of situations. Even some countries and international agreements require most pallets shipped across national borders to be made of materials that are incapable of being a carrier of invasive species of insects and plant diseases, and they may still require heat treating and/or fumigation.

Thus, there is a need for improvement in this field.

### SUMMARY

The applicant has previously developed a unique composite pallet made of concrete which was described in U.S. patent application Ser. No. 14/745,914 filed Jun. 22, 2015, published as US Patent Application Publication No. 2016/0368659, and is hereby incorporated by reference in its entirety. While further developing the design, a number of problems were unexpectedly discovered that prevented the development of a commercially successful pallet design. One of the main issues was the manufacturability and durability of the composite concrete pallet. Using a plastic outer covering or shell that acted as a mold unexpectedly bent at inopportune times during manufacturing and was found to be an expensive option. It was found that creating a frame structure for the pallet out of sheet metal, such as steel or stainless steel, provided the desired weight and strength characteristics as well as ease in manufacturability. Sheet metal is used to form the frame members that are assembled together to form the frame structure. The sheet metal is formed into the desired shape through a continuous roll forming and/or stamping process in one example. A unique mortise and tenon joint system was developed to facilitate ease in assembling of the frame structure and filling of the frame members with the composite concrete or cement material. The tenons are designed with gaps that allow the composite concrete fill material to readily flow between the various frame members in the frame structure of the pallet. This ensures that the pallet is fully filled with the composite concrete material and reduces the occurrence of any voids which can weaken the pallet. The joint system also is configured to facilitate filling from the corners of the pallet so that the corresponding adjoining frame members can be filled at the same time which in turn allows the pallet to be filled rapidly and completely. Corner caps are used to seal the composite concrete material inside the corners of the frame structure as well as to act as bumpers to prevent chipping during use. The open joint design allows the fill material to flow and completely fill a deck of the pallet through a single opening. The joints are also designed so that the same fasteners, which are used to secure the adjoining frame members together at the joint, also secure the frame members to spacers that form the fork openings of the pallet.

The sheet metal that is used to form the frame structure is too thin by itself to provide the requisite strength for the pallet. The metal sheets are joined together to form a series of seams that are positioned around the fork openings so as to reduce the risk of the seams catching any items on the pallet or other objects as well as provide additional strength to the pallet. With the seams positioned internally around the fork opening, when the pallet is lifted by a forklift or other lifting device, the force applied by the forks (and weight of the pallet as well as items packed on the pallet) further deform or crimp the seams so that the connection between the at least two metal sheets at the seam is further strengthened. The seams also help during assembly by aligning the spacers with the various decks of the pallet. Once cured inside the frame structure, the composite concrete or cement material provides the required strength so that the pallet has the requisite price, strength capabilities, and weight as well as other properties comparable to that of wooden pallets, if so desired. The sheet metal for the frame structure in essence acts as an exoskeleton or mold in which the composite concrete or cement material is cured and housed. In one form, the sheet metal completely surrounds the composite concrete or cement fill material, and in another form, the composite concrete or cement fill material is partially exposed on the pallet. The sheet metal further helps to protect the concrete from chipping, environmental hazards, or other damage. Fiber reinforcement ribs can also be embedded in the composite concrete fill material so as to provide additional lightweight strength. Foam inserts can also be incorporated to facilitate dampening as well as reduce the overall weight of the pallet.

The concrete is durable so that the pallet can be reused, and the concrete pallet has been again designed to be inexpensive so as to have a cost comparable to traditional wood pallets. In some (but not all) cases, the concrete pallet has been configured and/or formulated with concrete material to have a weight and strength comparable to traditional wood pallets. Wood pallets were found to be less durable than the concrete pallet described herein. Wood pallets typically last for about 10 shipping trips or runs. In contrast, the concrete pallet described and illustrated herein is durable enough to last for around 60 trips. By being made of concrete, the pallet is able to be heated treated, fumigated, and/or otherwise exposed to various chemicals with little risk for damage. Unlike wood, concrete is typically inflammable which is especially helpful in reducing the risk of fire in large manufacturing and/or warehousing operations. The concrete material can include glass bubbles such as microspheres or bubbles made from recycled material. The concrete material can include various concrete mixtures, such as Fiber Reinforced Concrete (FRC) or an Engineered Cementitious Composite (ECC).

Aspect 1 generally concerns a system that includes a concrete filled pallet having a snap connected spacer structure.

Aspect 2 generally concerns the system of aspect 1 in which the spacer structure includes a spacer block with part of a snap connector.

Aspect 3 generally concerns the system of aspect 2 in which the cap is secured to the end of a concrete filled frame member that is snap connected to the spacer block.

Aspect 4 generally concerns the system of aspect 3 in which the cap secures two concrete filled frame members together.

Aspect 5 generally concerns the system of aspect 4 in which the cap is a corner cap securing frame members at a transverse orientation.

Aspect 6 generally concerns the system of aspect 5 in which the frame member has a mitered edge angled at an acute angle.

Aspect 7 generally concerns the system of aspect 3 in which the cap has a frame socket receiving end of the frame member.

Aspect 8 generally concerns the system of aspect 7 in which the frame socket has a frame plug extending into the frame member.

Aspect 9 generally concerns the system of aspect 8 in which the frame plug extends into one of multiple fill cavities in the frame member.

Aspect 10 generally concerns the system of aspect 9 in which the frame plug extends into a fill cavity that does not have concrete.

Aspect 11 generally concerns the system of aspect 10 in which the frame member has an empty intermediate cavity between concrete filled cavities.

Aspect 12 generally concerns the system of aspect 11 in which the concrete filled cavity with a support rib received in a rib support channel.

Aspect 13 generally concerns the system of aspect 3 in which the cap is a slat cap secured to a deck slat.

Aspect 14 generally concerns the system of aspect 15 in which the slat cap has a rail notch through which a rail extends.

Aspect 15 generally concerns the system of aspect 3 in which the snap connector includes a cap connector protrusion and a spacer connector socket.

Aspect 16 generally concerns the system of aspect 2 in which the mid-spacer connector is secured to the frame member with part of the snap connector.

Aspect 17 generally concerns the system of aspect 16 in which the mid-spacer connector has a muntin notch supporting a pallet muntin structure.

Aspect 18 generally concerns the system of aspect 17 in which the mid-spacer connector is connected to a spacer block having a muntin notch.

Aspect 19 generally concerns the system of aspect 18 in which the spacer block has two connector sockets at each end.

Aspect 20 generally concerns the system of aspect 17 in which the spacer block is a muntin spacer with muntin notches formed in a cross pattern.

Aspect 21 generally concerns the system of aspect 17 in which the muntin structure supports one or more panels.

Aspect 22 generally concerns the system of aspect 21 in which the fiber reinforcement rib supports at least one of the panels.

Aspect 23 generally concerns the system of aspect 1 in which the top and bottom deck snap connector together through the spacer structure.

Aspect 24 generally concerns the system of aspect 1 in which the concrete includes fibers and microspheres.

Aspect 25 generally concerns the system of aspect 24 in which the frame member is filled with concrete has a metal exterior.

Aspect 26 generally concerns a method that includes a method of snap connecting a deck filled with concrete to a fork spacer structure.

Aspect 27 generally concerns the method of aspect 26 in which the snap connecting a second deck to the spacer structure.

Aspect 28 generally concerns the method of aspect 26 in which the priming fill cavities with a slurry.

Aspect 29 generally concerns the method of aspect 26 in which the filling interior and exterior cavities with the concrete while an intermediate cavity is empty.

Aspect 30 generally concerns the method of aspect 29 in which the inserting a frame plug of a frame socket into the intermediate cavity.

Aspect 31 generally concerns the method of aspect 26 in which the mixing cement, reinforcement fibers, and microspheres before filling.

Aspect 32 generally concerns the method of aspect 31 in which the attaching metal frame members together with a corner cap that is snap connected to a corner spacer.

Aspect 33 generally concerns the system or method of any previous aspect in which the spacer structure includes a spacer block with part of a snap connector.

Aspect 34 generally concerns the system or method of any previous aspect in which the cap is secured to the end of a concrete filled frame member that is snap connected to the spacer block.

Aspect 35 generally concerns the system or method of any previous aspect in which the cap secures two concrete filled frame members together.

Aspect 36 generally concerns the system or method of any previous aspect in which the cap is a corner cap securing frame members at a transverse orientation.

Aspect 37 generally concerns the system or method of any previous aspect in which the frame member has a mitered edge angled at an acute angle.

Aspect 38 generally concerns the system or method of any previous aspect in which the cap has a frame socket receiving end of the frame member.

Aspect 39 generally concerns the system or method of any previous aspect in which the frame socket has a frame plug extending into the frame member.

Aspect 40 generally concerns the system or method of any previous aspect in which the frame plug extends into one of multiple fill cavities in the frame member.

Aspect 41 generally concerns the system or method of any previous aspect in which the frame plug extends into a fill cavity that does not have concrete.

Aspect 42 generally concerns the system or method of any previous aspect in which the frame member has an empty intermediate cavity between concrete filled cavities.

Aspect 43 generally concerns the system or method of any previous aspect in which the concrete filled cavity with a support rib received in a rib support channel.

Aspect 44 generally concerns the system or method of any previous aspect in which the cap is a slat cap secured to a deck slat.

Aspect 45 generally concerns the system or method of any previous aspect in which the slat cap has a rail notch through which a rail extends.

Aspect 46 generally concerns the system or method of any previous aspect in which the snap connector includes a cap connector protrusion and a spacer connector socket.

Aspect 47 generally concerns the system or method of any previous aspect in which the mid-spacer connector is secured to the frame member with part of the snap connector.

Aspect 48 generally concerns the system or method of any previous aspect in which the mid-spacer connector has a muntin notch supporting a pallet muntin structure.

Aspect 49 generally concerns the system or method of any previous aspect in which the mid-spacer connector is connected to a spacer block having a muntin notch.

Aspect 50 generally concerns the system or method of any previous aspect in which the spacer block has two connector sockets at each end.

Aspect 51 generally concerns the system or method of any previous aspect in which the spacer block is a muntin spacer with muntin notches formed in a cross pattern.

Aspect 52 generally concerns the system or method of any previous aspect in which the muntin structure supports one or more panels.

Aspect 53 generally concerns the system or method of any previous aspect in which the fiber reinforcement rib supports at least one of the panels.

Aspect 54 generally concerns the system or method of any previous aspect in which the top and bottom deck snap connector together through the spacer structure.

Aspect 55 generally concerns the system or method of any previous aspect in which the concrete includes fibers and microspheres.

Aspect 56 generally concerns the system or method of any previous aspect in which the frame member is filled with concrete has a metal exterior.

Aspect 57 generally concerns the system or method of any previous aspect in which the snap connecting a second deck to the spacer structure.

Aspect 58 generally concerns the system or method of any previous aspect in which the priming fill cavities with a slurry.

Aspect 59 generally concerns the system or method of any previous aspect in which the filling interior and exterior cavities with the concrete while an intermediate cavity is empty.

Aspect 60 generally concerns the system or method of any previous aspect in which the inserting a frame plug of a frame socket into the intermediate cavity.

Aspect 61 generally concerns the system or method of any previous aspect in which the mixing cement, reinforcement fibers, and microspheres before filling.

Aspect 62 generally concerns the system or method of any previous aspect in which the attaching metal frame members together with a corner cap that is snap connected to a corner spacer.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a top perspective view of a pallet according to one embodiment.

FIG. 2 is a bottom perspective view of the FIG. 1 pallet.

FIG. 3 is a top view of the FIG. 1 pallet.

FIG. 4 is a bottom view of the FIG. 1 pallet.

FIG. 5 is a cross-sectional view of the FIG. 1 pallet as taken along line 5-5 in FIG. 3.

FIG. 6 is a cross-sectional view of the FIG. 1 pallet as taken along line 6-6 in FIG. 3.

FIG. 7 is a side view of the FIG. 1 pallet.

FIG. 8 is an end view of the FIG. 1 pallet.

FIG. 9 is a cross-sectional view of the FIG. 1 pallet as taken along line 9-9 in FIG. 7.

FIG. 10 is a cross-sectional view of the FIG. 1 pallet as taken along line 10-10 in FIG. 8.

FIG. 11 is a top, partial exploded view of the FIG. 1 pallet.

FIG. 12 is a first bottom, partial exploded view of the FIG. 1 pallet.

FIG. 13 is a second bottom, partial exploded view of the FIG. 1 pallet.

FIG. 14 is a perspective view of a block or support structure found in the FIG. 1 pallet.

FIG. 15 is a perspective view of a corner cap or bumper found in the FIG. 1 pallet.

FIG. 16 is an enlarged perspective view of a corner of the FIG. 1 pallet with the FIG. 15 corner cap removed.

FIG. 17 is an enlarged perspective view of one end of a frame member in the form of a top deck rail found in the FIG. 1 pallet.

FIG. 18 is an end view of the FIG. 17 rail.

FIG. 19 is a top view of the FIG. 17 rail.

FIG. 20 is a bottom view of the FIG. 17 rail.

FIG. 21 is a side view of the FIG. 17 rail.

FIG. 22 is an enlarged perspective view of one end of a frame member in the form of a bottom deck rail found in the FIG. 1 pallet.

FIG. 23 is an end view of the FIG. 22 rail.

FIG. 24 is a perspective view of a frame member in the form of a top deck stile found in the FIG. 1 pallet.

FIG. 25 is an end view of the FIG. 24 stile.

FIG. 26 is a top view of the FIG. 24 stile.

FIG. 27 is a bottom view of the FIG. 24 stile.

FIG. 28 is a side view of the FIG. 24 stile.

FIG. 29 is a perspective view of a frame member in the form of a bottom deck stile found in the FIG. 1 pallet.

FIG. 30 is an end view of the FIG. 29 stile.

FIG. 31 is an enlarged perspective view of one end of a frame member in the form of a muntin structure found in the FIG. 1 pallet.

FIG. 32 is an end view of the FIG. 32 muntin structure.

FIG. 33 is a top perspective view of the FIG. 32 muntin structure.

FIG. 34 is a bottom perspective view of the FIG. 32 muntin structure.

FIG. 35 is a top perspective view of the FIG. 32 muntin structure with a cover layer removed.

FIG. 36 is a partial perspective view of the FIG. 32 structure engaged with a frame member.

FIG. 37 is a cross-sectional view of one variation of a frame member that includes fiber reinforced support ribs and filled with a composite cement fill material.

FIG. 38 is a cross-sectional view of another variation of a frame member that includes fiber reinforced support ribs along with foam material and the composite cement fill material.

FIG. 39 is a perspective view of a nozzle used to fill the FIG. 1 pallet.

FIG. 40 is an enlarged perspective view of the FIG. 39 nozzle before filling the FIG. 1 pallet.

FIG. 41 is a perspective view of the FIG. 39 nozzle coupled to the FIG. 1 pallet during filling of the FIG. 1 pallet.

FIG. 42 is an enlarged perspective view of the FIG. 39 nozzle coupled to the FIG. 1 pallet shown in FIG. 41.

FIG. 43 shows a large perspective view of the FIG. 15 corner cap sealing the corner of the FIG. 1 pallet to prevent leakage of the composite cement material.

FIG. 44 shows an enlarged cross-sectional view of the FIG. 1 pallet.

FIG. 45 shows a top perspective view of a pallet according to another example.

FIG. 46 shows a bottom perspective view of the FIG. 45 pallet.

FIG. 47 shows a top partial exploded view of the FIG. 45 pallet.

FIG. 48 shows a bottom partial exploded view of the FIG. 45 pallet.

FIG. 49 shows an enlarged exploded view of a frame member joined in the FIG. 45 pallet.

FIG. 50 shows an enlarged perspective view of one corner of the FIG. 45 pallet.

FIG. 51 shows an exploded view of a muntin structure and stile found in the FIG. 45 pallet.

FIG. 52 shows a top perspective view of a corner cap found in the FIG. 45 pallet.

FIG. 53 is a bottom perspective view of the FIG. 52 corner cap.

FIG. 54 is a top perspective view of a pallet according to another example.

FIG. 55 is a bottom perspective view of the FIG. 54 pallet.

FIG. 56 is a partial exploded perspective view of the FIG. 54 pallet.

FIG. 57 is a partial exploded view of selected frame members found in a top deck of the FIG. 54 pallet.

FIG. 58 is a partial exploded view of a bottom deck found in the FIG. 54 pallet.

FIG. 59 is a bottom perspective view of a corner cap found in the FIG. 54 pallet.

FIG. 60 is a top perspective view of the FIG. 59 corner cap.

FIG. 61 is a top perspective view of a pallet according to another example.

FIG. 62 is a bottom perspective view of the FIG. 61 pallet.

FIG. 63 is a top view of the FIG. 61 pallet.

FIG. 64 is a bottom view of the FIG. 61 pallet.

FIG. 65 is a front view of the FIG. 61 pallet.

FIG. 66 is a side view of the FIG. 61 pallet.

FIG. 67 is an exploded view of the FIG. 61 pallet with selected components removed.

FIG. 68 is a top perspective view of the FIG. 61 pallet with selected components removed.

FIG. 69 is an exploded view of a frame member and spacer joint found in the FIG. 61 pallet.

FIG. 70 is a top view of a frame member found in the FIG. 61 pallet.

FIG. 71 is a front perspective view of the FIG. 70 frame member.

FIG. 72 is a front view of the FIG. 70 frame member.

FIG. 73 is a top perspective view of a corner cap found in the FIG. 61 pallet.

FIG. 74 is a front perspective view of the FIG. 73 corner cap.

FIG. 75 is a rear perspective view of the FIG. 73 corner cap.

FIG. 76 is a top perspective view of a corner spacer.

FIG. 77 is a bottom perspective view of the FIG. 76 corner spacer.

FIG. 78 is a side perspective view of the FIG. 76 corner spacer.

FIG. 79 is an exploded view of a rail muntin joint found in the FIG. 61 pallet.

FIG. 80 is a top perspective view of a mid-spacer connector found in the FIG. 79 rail muntin joint.

FIG. 81 is a bottom perspective view of the FIG. 80 mid-spacer connector.

FIG. 82 is a top perspective view of a rail spacer found in the FIG. 79 rail muntin joint.

FIG. 83 is a bottom perspective view of the FIG. 82 rail spacer.

FIG. 84 is an exploded view of a slat joint found in the FIG. 61 pallet.

FIG. 85 is a top perspective view of a slat found in the FIG. 84 slat joint.

FIG. 86 is a front perspective view of the FIG. 85 slat.

FIG. 87 is a front perspective view of the FIG. 85 slat when filled with concrete.

FIG. 88 is a top perspective view of a slat cap found in the found in the FIG. 84 slat joint.

FIG. 89 is a bottom perspective view of the FIG. 88 slat cap.

FIG. 90 is a front perspective view of the FIG. 88 slat cap.

FIG. 91 is an exploded view of a stile muntin joint found in the FIG. 61 pallet.

FIG. 92 is a top perspective view of a stile spacer found in the FIG. 79 stile muntin joint.

FIG. 93 is a bottom perspective view of the FIG. 92 stile spacer.

FIG. 94 is an exploded view of a muntin support joint found in the FIG. 61 pallet.

FIG. 95 is a top perspective view of a muntin spacer found in the FIG. 94 muntin support joint.

FIG. 96 is a bottom perspective view of the FIG. 95 muntin spacer.

FIG. 97 is a flowchart of a technique for manufacturing planks that are incorporated into the illustrated pallets.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

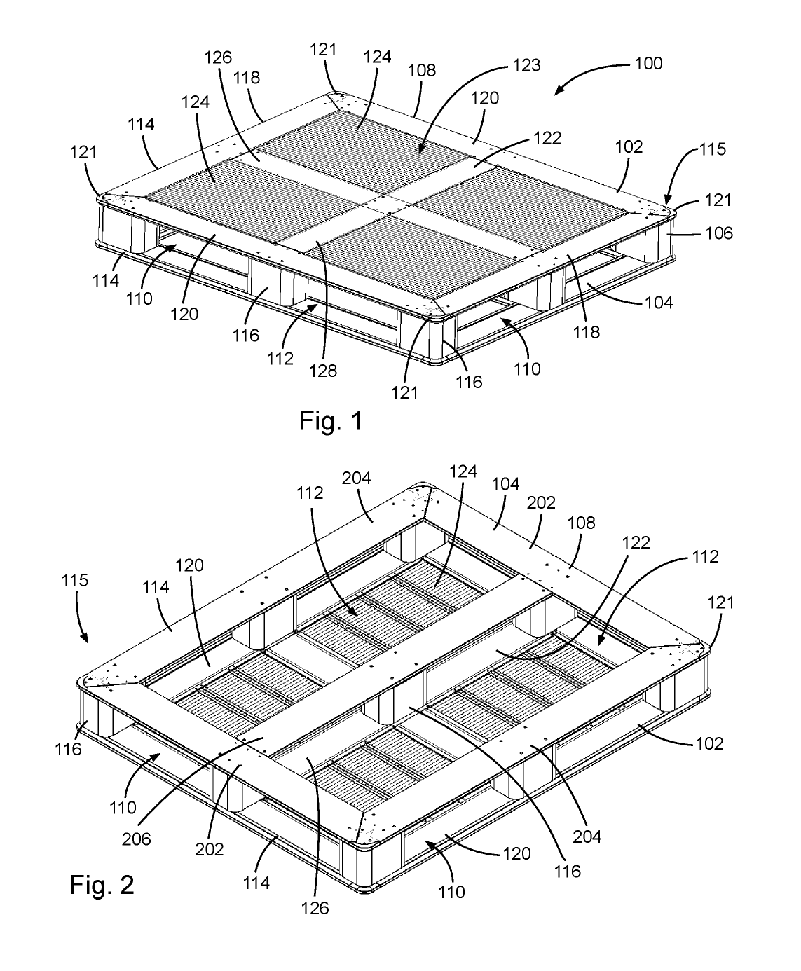

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

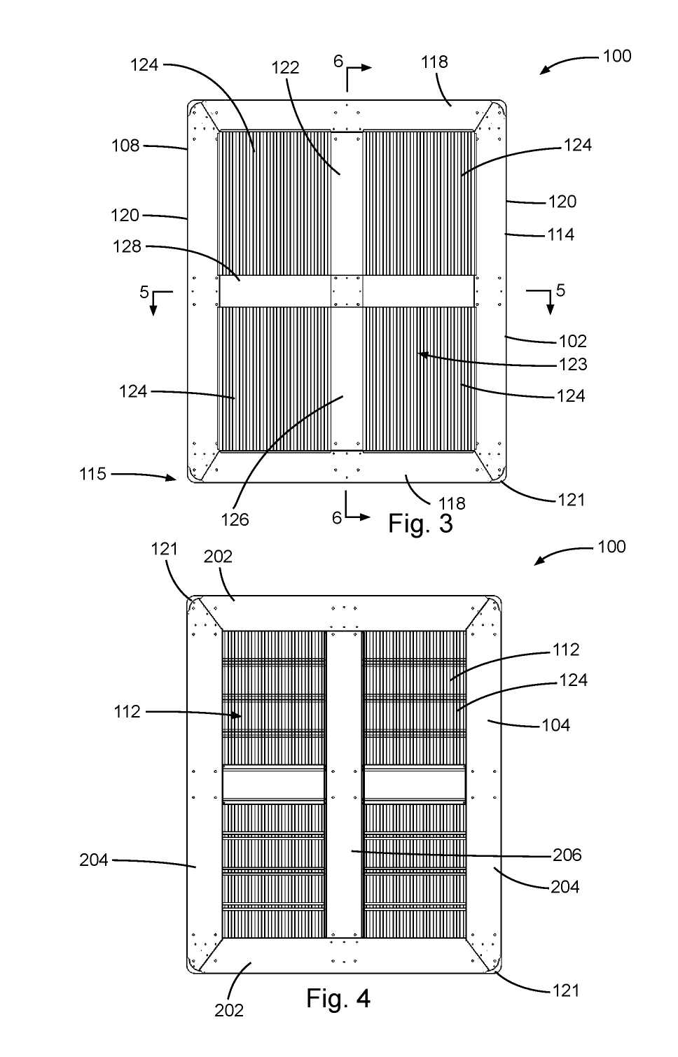

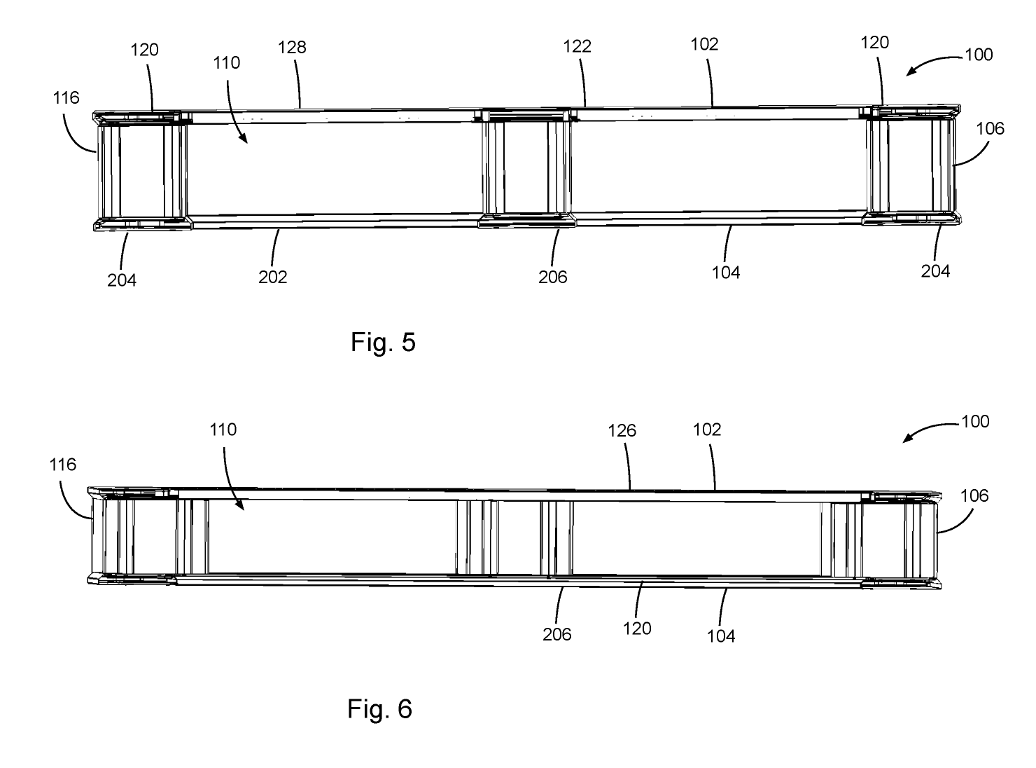

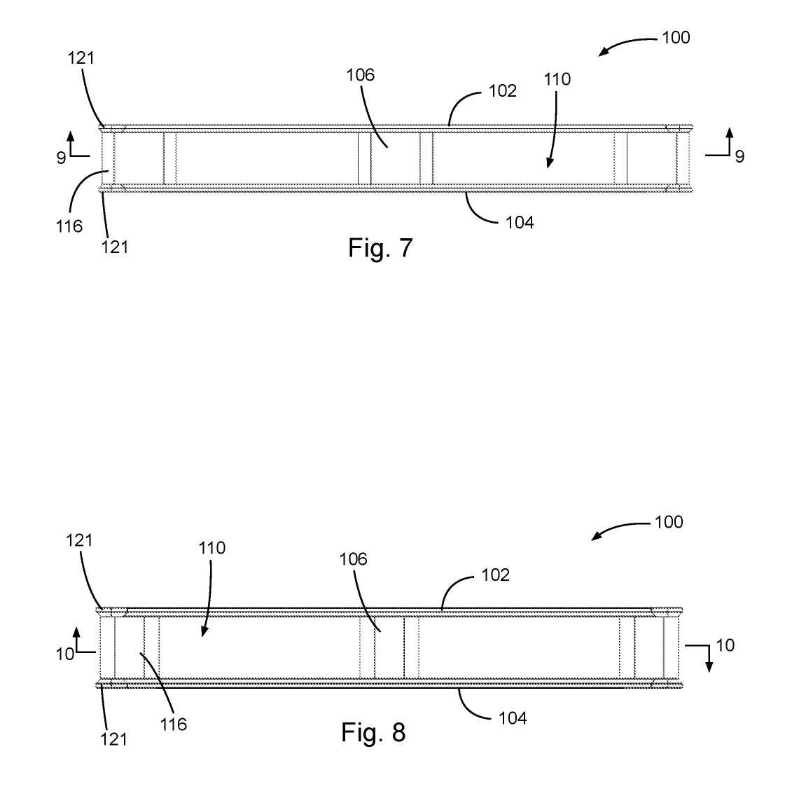

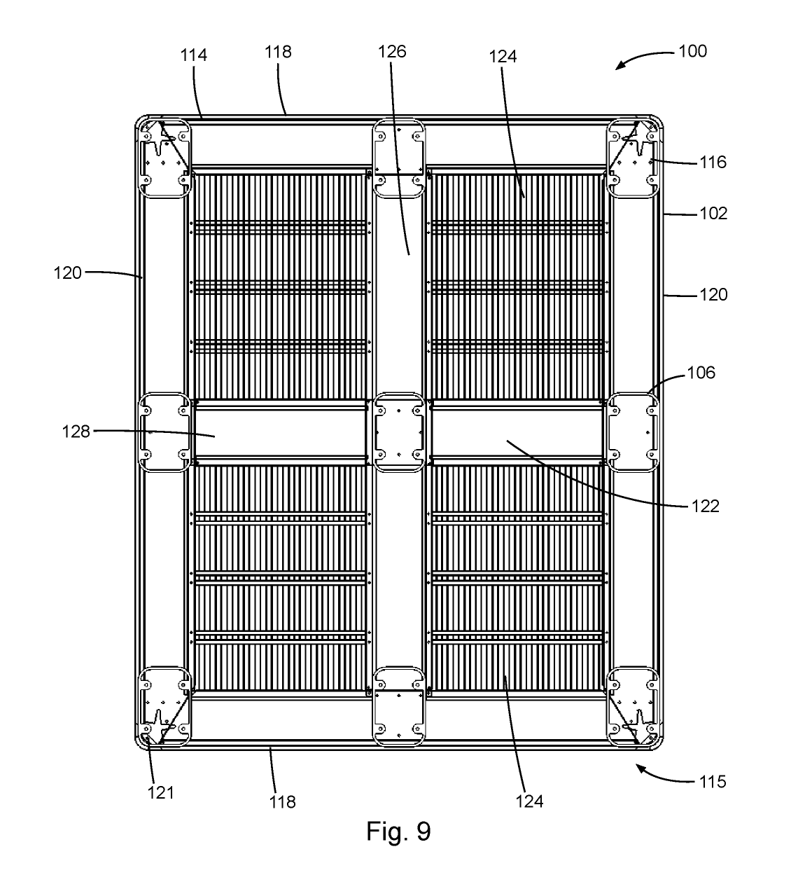

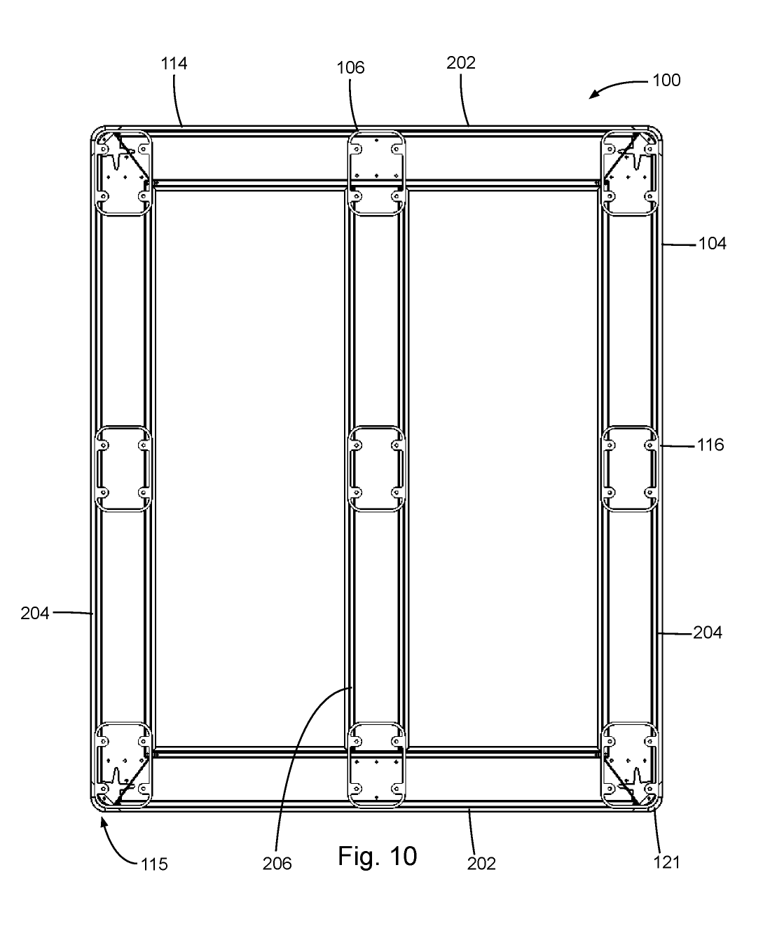

A pallet 100 will be initially described with reference to FIGS. 1 to 10. As noted above, FIGS. 1 and 2 respectively show a top and bottom perspective views of the pallet 100, and FIGS. 3 and 4 respectively illustrate top and bottom views of the pallet 100. Again, FIGS. 5 and 6 illustrate cross-sectional views of the pallet 100 as taken along lines 5-5 and 6-6, respectively, in FIG. 3. FIG. 7 is a side view of the pallet 100, and FIG. 8 is an end view of the pallet 100. It should be noted that the ends and sides of the pallet 100 shown in FIGS. 7 and 8 are mirror images of one another such that they generally have the same (mirrored) configuration at the opposite ends and sides. Once more, FIG. 9 is a cross-sectional view of the pallet 100 as taken along line 9-9 in FIG. 7, and FIG. 10 is a cross-sectional view of the pallet 100 as taken along line 10-10 in FIG. 8.

The pallet 100 in one example is made in part from a composite fiber reinforced concrete or cement fill material that is encased inside an exoskeleton or frame structure. By being made of concrete or cement, the pallet 100 can be made more durable as compared to traditional wooden pallets which have a tendency to splinter. Moreover, traditional wood and plastic pallets are able to burn which can create dangerous situations in warehouse environments. It should be recognized that the concrete pallet 100 will normally not burn. In addition, the concrete pallet 100 can be used in harsh environmental/chemical conditions and, unlike wooden pallets, does not need to be fumigated for undesirable wood boring insects or other invasive organisms. The pallet 100 and its components are made of concrete material, such as fiber reinforced concrete material and, more specifically, engineered cementitious concrete (ECC).

As will be explained further below, the pallet 100 has been designed to have the weight and cost comparable to traditional wooden pallets. In one form, the pallet 100 is made of fiber reinforced concrete so as to improve its tensile strength and durability, and in one particular form, the pallet 100 is made of ECC so as to further promote strength and durability. The concrete material can include bubbles such as glass microspheres, expanded glass, and/or glass bubbles made from recycled material so as to reduce the overall weight of the pallet. The concrete material forming the pallet 100 in some forms is also dyed to create different colors to readily identify different types or kinds of pallets. As will be explained below, the pallet 100 can further include bumpers on the corners and elsewhere to prevent or minimize chipping. By having comparable weight, the composite pallet 100 can be more readily adapted to existing equipment and processes. For instance, material handling equipment or vehicles, such as trucks, conveyors, storage racks, robots, and scales, do not need to be retrofitted to compensate for additional load because the pallet 100 generally weighs the same as traditional pallets, or even weighs less in some cases. A metal frame structure that encases the fiber reinforced concrete fill material also aids in the durability of the pallet 100. Various types of materials can be used to form the above-described pallets. By way of non-limiting examples, all or part of these pallets can be made of concrete, such as FRC, ECC, lightweight ECC, self-compacting ECC, sprayable ECC, and/or extrudable ECC. The concrete can further contain air voids, glass bubbles, polymer spheres, and/or lightweight aggregate. A more complete description of the formulation of the composite concrete or cement that fills the pallet is provided in U.S. Patent Application No. 62/479,701, filed Mar. 31, 2017 entitled “Fiber Reinforced Composite Core Formulation” (Attorney Docket Number 003436-000104), which is hereby incorporated by reference in its entirety.

As will be described in greater detail below, a unique feature is that the pallet is filled with a composite concrete fill material. The frame structure has a unique design that promotes the flow of the concrete such multiple frame members can be filled with concrete through a single opening. The concrete was especially formulated to not only be lightweight but also require the requisite strength. More specifically, the concrete mix was designed to facilitate its flow through the frame structure without any significant blockage. In one form, the exemplary mix includes approximately: 315 g of water, 400 g of cement, 40 g of glass microspheres, 380 g of hollow fly ash sphere or a hollow alumino silicate sphere, 4.5 g of superplasticizer, 1.8 g of viscosity agent, and 9 g of polypropylene reinforcing fibers. The cement is Type 1 Portland Cement. The hollow microsphere used is from 3M Company under the tradename 3M™ Glass Bubbles K1 with a density of 0.125 g/cc, a particle size distribution between 60 to 69 μm, a mean particle size of 65 μm, and made of soda-lime-borosilicate glass with a crush strength of 250 PSI. The hollow fly ash sphere includes a hollow alumino silicate sphere made by Cenostar Corporation under the tradename Cenosphere Microsphere with a density of 60 to 0.85 g/cc, a particle size distribution between 200 to 600 μm, a bulk density of 0.35 g/cc, a true density less than 0.98 g/cc, and a crush strength between 1600 and 3200 PSI. It was discovered that a close almost 1:1 ratio of cement to hollow fly ash sphere converted to a target density of the cured fiber reinforced concrete composite between 750 kg/m3 to 950 kg/m3. The superplasticizer was Melflux® superplasticizer from BASF Corporation. The viscosity control agent was Starvis® stabilizer/rheology modifier agent from BASF Corporation.

As shown in FIG. 1, the pallet 100 includes a top deck 102, a bottom deck 104, and a spacer structure 106 disposed between the top deck 102 and the bottom deck 104. Together the top deck 102, bottom deck 104, and spacer structure 106 together form a frame or exoskeleton structure 108 in which the composite concrete fill material is encased. While the frame structure 108 in one example completely encases the concrete fill material, in other examples the concrete fill material can be exposed such that the exoskeleton 108 has openings. During use, items such as boxes are usually, but not always, stacked on the top deck 102 while the bottom deck 104 rests on the ground or floor. It should be noted that the directional terms “top” and “bottom” when referring to the decks 102, 104 are not meant to limit the decks 102, 104 along with the pallet 100 to a particular orientation and/or use case. The use of this directional terminology is mainly for the convenience of the reader so as to easily appreciate the relative locations of various components in the pallet 100. For example, in certain cases, the pallet 100 can be flipped such that items are packed on the bottom deck 104 and the top deck 102 rests against the ground to support the load. The spacer structure 106 defines one or more fork openings 110 that are configured to receive forks, such as from a forklift or hand jack. In the illustrated example, the fork openings 110 are tapered to facilitate guiding the forks into the fork openings 110, and as depicted, the fork openings 110 are positioned on all sides around the pallet 100 so that a forklift can access and lift the pallet 100 from any side. The bottom deck 104 defines one or more jack openings 112. Among other things, the jack openings 112 allow the wheels of a hand jack to bear against the floor or ground. These jack openings 112 can also help reduce the weight of the pallet 100 as well as promote ventilation of air and drainage of fluid from the pallet 100.

The frame structure 108 includes a series of frame members 114 that are joined together at corners 115 of the pallet 100 to form the top 102 and bottom 104 decks. The unfilled frame members 114 by themselves provide very little in the way of structural support. In one example, the frame members 114 are formed by sheets of metal, such as steel, that are rolled formed and/or pressed into the resulting shape of the frame member 114. The sheets of metal are relatively thin such that the sheet provides very little support even when formed in the final shape. The structural support is provided by the hardened concrete fill material filled inside the frame members. In essence, the frame members 114 act as molds in which the composite material is filled and cured. As depicted in FIGS. 1, 2, and 5 to 8, the spacer structure 106 for the frame structure 108 includes one or more blocks or supports 116 that are sandwiched between the top deck 102 and the bottom deck 104. In one form, all or some of the blocks 116 are filled with the composite material so as to provide additional strength, but in other examples, all or some of the blocks 116 are unfilled with the composite fill material and/or filled partially or fully with relatively less dense material, such as polystyrene foam material, so as to reduce the overall weight of the pallet 100. In the illustrated example, the blocks 116 are arranged in a 3-by-3 array so as to promote even support of the top deck 102, but other types of arrangements can be used.

Looking at FIGS. 1, 3, and 9, the frame members 114 of the top deck 102 include one or more top deck rails 118 that are connected to one or more top deck stiles 120 at the corners 115 of the pallet 100. To seal the composite material inside the frame members 114 and help reduce damage to the pallet 100 as well as other objects, the pallet 100 includes a corner cap 121 configured to enclose one or more corners 115 of the deck 102, 104. The corner caps 121 can be made from a variety of materials such as rubber and plastic. In the illustrated example, the corner caps 121 are positioned at the joints formed between the frame members 114. As will be explained in greater detail below, the frame members 114 of the pallet 100 are filled with the composite material at the corners 115. The corner caps 121 enclose or seal the corners 115 so as to prevent leakage of the composite material from the frame structure 108 once filled. With the frame structure 108 sealed, the composite material, such as concrete, can cure during and/or after manufacturing of the pallet 100, such as during storage and/or shipping. In the illustrated example, both the top 102 and bottom 104 decks have a rectangular shape, but the decks 102, 104 (as well as the overall shape of the pallet 100) can be shaped differently in other examples. As shown, the top deck 102 includes a pair of opposing rails 118 that are connected together by a similarly opposing pair of the stiles 120 at the corners 115 of the pallet 100 to form a rectangular shape.

Extending within the top deck rails 118 and stiles 120, a muntin structure 122 defines window openings 123 where one or more panels or panes 124 are supported. In the illustrated example, the muntin structure 122 includes a first or rail muntin 126 that extends between the top deck rails 118 and a second or stile muntin 128 that extends between the stiles 120. The muntins 126, 128 form a cross-shaped pattern such that the muntin structure 122 is cross-shaped in the depicted example, but the muntin structure 122 can be shaped differently in other examples. In one form, the muntins 126, 128 are integrally formed with one another to form a single unit, and in another form, the muntins 126, 128 are separate components that are joined together. The muntin structure 122 further provides structural support for items placed on the top deck 102. The muntin structure 122 along with the top deck rails 118 and stiles 120 support the panels 124 in the windows 123. The panels 124, if so desired, can also provide structural support for items on the top deck 102. In one variation, the panels 124 are designed to be lightweight so as to reduce the overall weight of the pallet 100, and in one example, the panels 124 are corrugated foam boards that are skim coated with a layer of the composite material on one or both sides of the panels 124. In another variation, a fiber glass mesh is embedded inside the skim coated concrete fill material on the panel 124 so as to add strength. The panel 124 can be a textile sheet or mesh that covers the windows 123 so as to act like a trampoline or taught cover. Alternatively or additionally, the panels 124 as well as the rest of the pallet 100 in other examples are coated with a protective coating, such as polyurethane or an epoxy. For one use case, the panels 124 provide some structural support so as to for example prevent an individual from being hurt by accidentally stepping through the pallet 100 or support lighter items, but the panels 124 are not designed to fully support a complete load of heavy items placed on the pallet 100. In another example, the panels 124 are designed to support heavy items or a full load. The top deck 102 in a further example does not include all or some of the panels 124 shown in the drawings so as to further reduce the weight of the pallet 100. For instance, all or some of the windows 123 can be open in the top deck 102.

Turning to FIGS. 2, 4, and 10, the frame members 114 of the bottom deck 104 include one or more bottom deck rails 202 that are connected to one or more bottom deck stiles 204 at the corners 115 of the pallet 100. In the illustrated example, the bottom deck 104 includes a pair of opposing bottom deck rails 202 that are connected at the corners 115 of the pallet 100 to similarly opposing pairs of the bottom deck stiles 204. The bottom deck 104 further includes a bottom deck slat 206 that is connected to and extends between the bottom deck rails 202 so as to provide additional structural support for the bottom deck 104. In another variation, the bottom deck 104 includes a muntin structure configured similarly to the muntin structure 122 found in the top deck 102. In one form, the muntin structure in the bottom deck 104 is open such that the muntin structure does not include any of the panels 124. In other forms, the bottom deck 104 can be closed or covered by one or more of the panels 124. In still yet another example, the top 102 and bottom 104 decks have the same construction so as to be generally identical (e.g., with or without the muntin structure 122, panels 124, etc.).

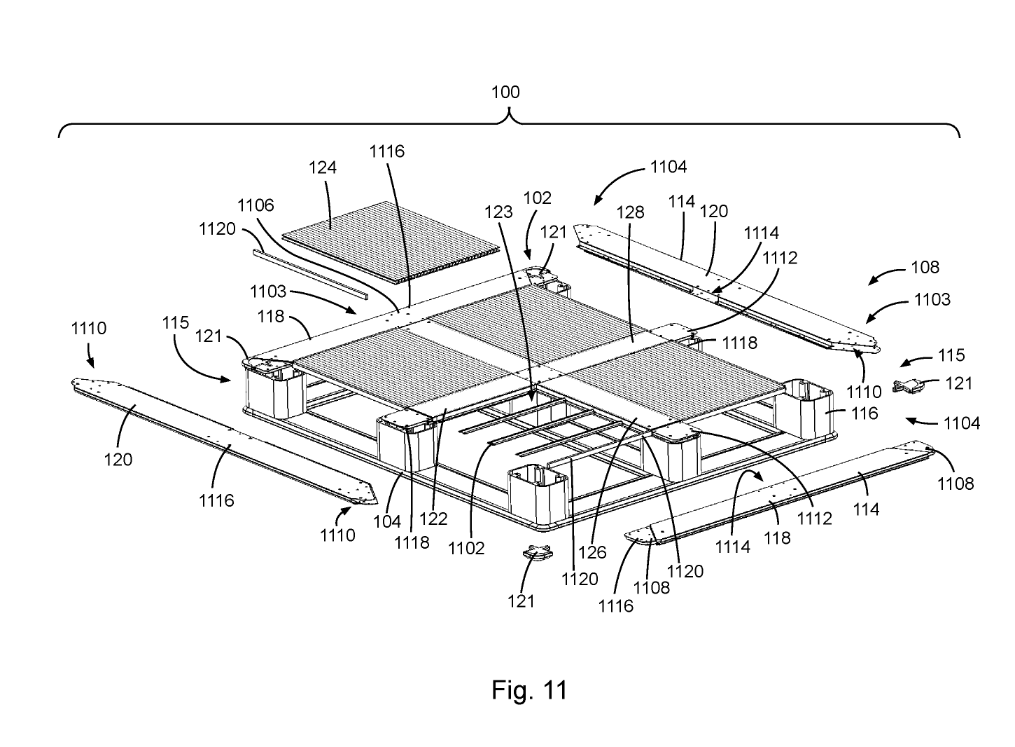

FIG. 11 shows an exploded view of the top deck 102. As can be seen, the panel 124 is further supported in the window opening 123 by one or more panel supports or slats 1102. In the illustrated example, the slats 1102 are secured to extend between the top deck stiles 120 and the rail muntin 126. It should be recognized that the slats 1102 can be oriented in other manners and shaped differently than is illustrated. For instance, the slats 1102 can extend between the stile muntin 128 and the top deck rails 118 in other variations. In one form, fasteners, such as screws, bolts, and/or rivets, are used to attach the slats 1102 to the muntin structure 122 and the frame members 114. In other examples, the slats 1102 can be attached to the pallet 100 in other manners, such as through adhesives and/or welding, to name just a few. Alternatively or additionally, some or all of the slats 1102 can be integrally formed into the other components of the top deck 102.

The frame structure 108 of the top deck 102 and bottom deck 104 are generally constructed through a series of joints 1103 that are located at the blocks 116. With the joints 1103 being located at the blocks 116, manufacturing is simplified and the overall strength of the pallet 100 is enhanced. The joints 1103 are also designed to facilitate the flow of the fill material during filling so that the top 102 and bottom 104 decks can be properly filled. Fasteners, such as screws, rivets, and/or bolts, can be used to secure the frame members 114 and/or muntin structure 122 at the same time directly to the blocks 116. During fastening, the various components are likewise interlocked with one another at the joints 1103, as will be explained in greater detail below. For example, at the corners 115 of the pallet 100, frame member joints 1104 are formed between the top deck rails 118 and the top deck stiles 120. Muntin joints 1106 are formed between the muntin structure 122 and the top deck rails 118 and stiles 120. In the illustrated example, the frame member 1104 and muntin 1106 joints are in the form of mortise and tenon type joints. Opposing ends of the top deck rails 118 have tenons 1108 that are received inside corresponding mortise openings 1110 that are defined at opposing ends of the top deck stiles 120. As can be seen, the ends of the top deck rails 118 and stiles 120 have an angular or mitered shape at the frame member joints 1104. Between the ends of the frame members 114, the muntin joints 1106 are formed between the muntin structure 122 and the frame members 114. The muntin structure 122 includes muntin tenons 1112 that are received inside corresponding mortise openings 1114 defined in the sides of the top deck rails 118 and stiles 120. At the joints 1103 where the frame members 114 and the muntin structure 122 overlap the blocks 116, the frame members 114 and the muntin structure 122 have fastener openings 1116 in which fasteners 1118, such as screws and/or bolts, secure the top deck 102 to the blocks 116. In the illustrated embodiment, fiber reinforcing ribs 1120 are embedded in the composite material inside the frame members 114 as well as muntin structure 122 to provide additional strength. It should be recognized that other types of joints, besides those illustrated, can be used to join the components of the frame structure 108 in other circumstances, such as butt joints, biscuit joints, bridle joints, dado joints, dovetail joints, finger joints, lap joints, pocket hole joints, rabbet joints, and tongue and groove type joints, to name just a few examples.

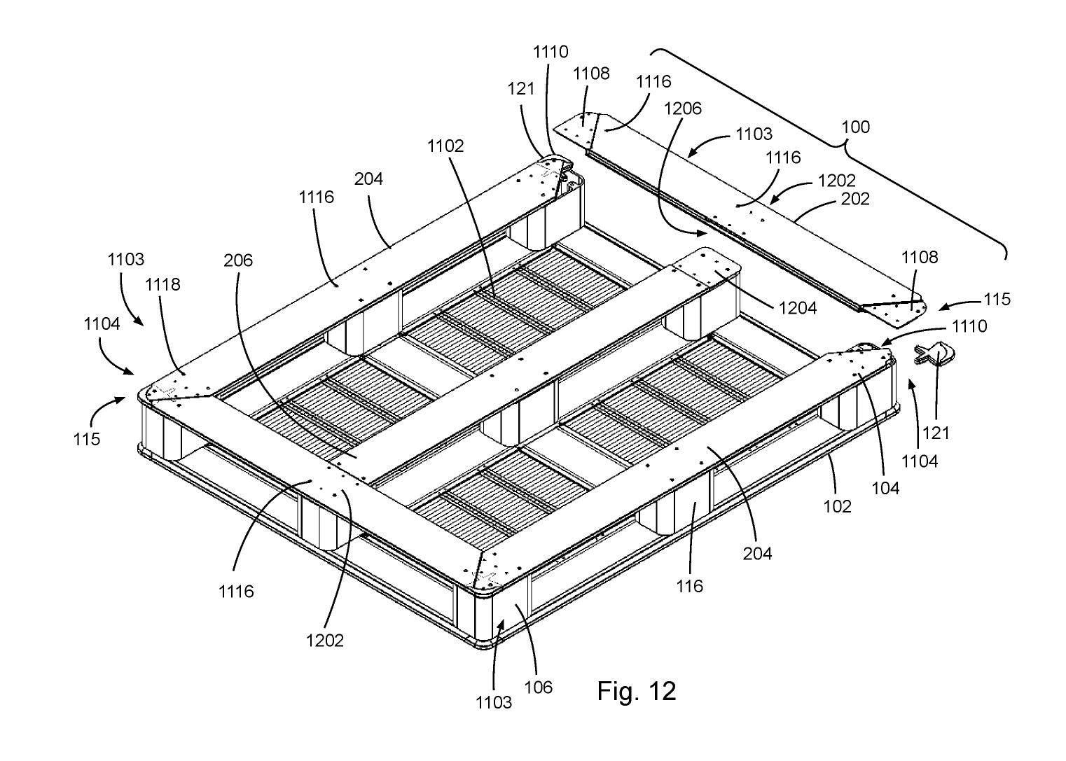

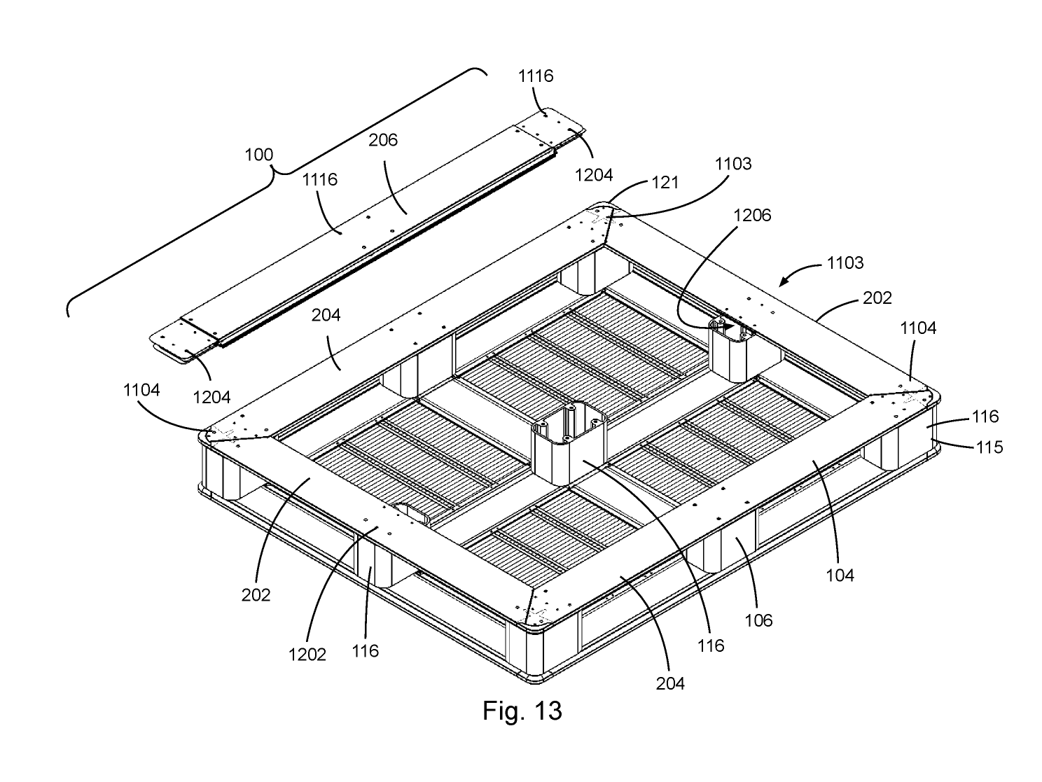

FIGS. 12 and 13 show two different bottom perspective exploded views of the pallet 100. Like in the top deck 102, the bottom deck 104 has frame member joints 1104 at the corners 115 of the pallet. As can be seen in FIG. 12, the bottom deck rails 202 have tenons 1108 at both ends that are received in corresponding mortise openings 1110 in the bottom deck stiles 204. Deck slat joints 1202 are formed between the bottom deck slats 206 and the bottom deck rails 202. Referring to FIGS. 12 and 13, the bottom deck slat 206 has tenons 1204 at both ends that are received in corresponding mortise openings 1206 in the bottom deck rails 202. In the illustrated example, the bottom deck stiles 204 do not have mortise openings 1110, 1206, but in other examples, the bottom deck stiles 204 have mortise openings to form a joint with other bottom deck slats 206 and/or muntin structures 122. Like in the top deck 102, the joints 1103 in the bottom deck 104 have fastener openings 1116 that are aligned so that the fasteners 1118 are able to secure the bottom deck 104 to the corresponding blocks 116.

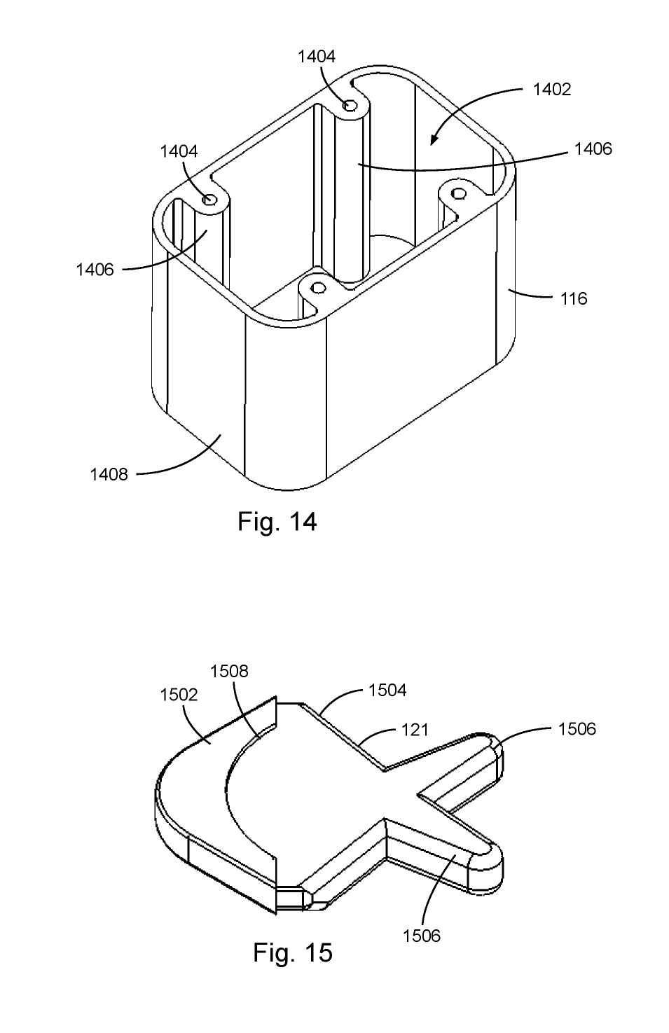

A perspective view of the block 116 is shown in FIG. 14. As can be seen, the block 116 defines a fill cavity 1402 in which the fill material and/or foam spacer can be filled, if desired. At both ends, the block 116 has fastener holes 1404 that are positioned to align with the fastener openings 1116 when the pallet 100 is assembled. In the illustrated example, both ends of the block 116 have the same configuration, but in other variations, the ends of the block 116 can be configured differently. The fastener holes 1404 are defined in fastener ribs 1406 that extend within the fill cavity 1402. The fastener holes 1404 along with the fastener ribs 1406 extend the full length of the block 116 so that the fasteners 1118 can be secured to both sides or ends of the block 116. In one form, the fasteners 1118 extend through the complete length of the fastener holes 1404, and in other forms, fasteners 1118 extend only partially through the length of the fastener holes 1404. In the depicted example, the block 116 has four fastener holes 1404, but more or less fastener holes 1404 can be found in other examples. To reduce chipping and help with positioning the forks within the fork openings 110 (FIG. 1), the blocks 116 have rounded corners 1408.

FIG. 15 shows a perspective view of the corner cap 121. It should be noted that the corner cap 121 in the illustrated example is generally symmetrical such that the top and bottom sides have the same features. As shown, the cap 121 includes a crown 1502, a body 1504, and one or more roots 1506. Between the crown 1502 and body 1504, the cap 121 has a lip or ledge 1508. In the depicted example, the crown 1502 has a rounded corner shape. The crown 1502 extends above the body 1504 so that the cap 121 is flush with the top 102 and bottom 104 decks, as is shown in FIGS. 7 and 8. To put it another way, the crown 1502 is flush with the outer surfaces of the stiles 120, 204 when inserted into the frame member joints 1104. When inserted, the body 1504 of the cap 121 is positioned inside the joints 1103 of the frame members 114. In the illustrated example, two roots 1506 extend from the body 1504, but in other examples, the cap 121 can have more or less roots 1506 (or even none). The roots 1506 extend at an angle so as to create an hourglass shape between the roots 1506 and the body 1504. The cap 121 acts as a plug to keep the fill material inside the pallet 100 after being filled. The roots 1506 are embedded in the fill material such that the roots 1506 help to retain the caps 121 in the frame member joints 1104. The ledge 1508 is configured to engage the frame members 114 so as to limit or stop movement of the cap 121 during insertion as well as to further seal the frame members 114. The ledge 1508 has a curved or arched shape so as to coincide with a portion of the end of the frame members 114 at the frame member joints 1104.

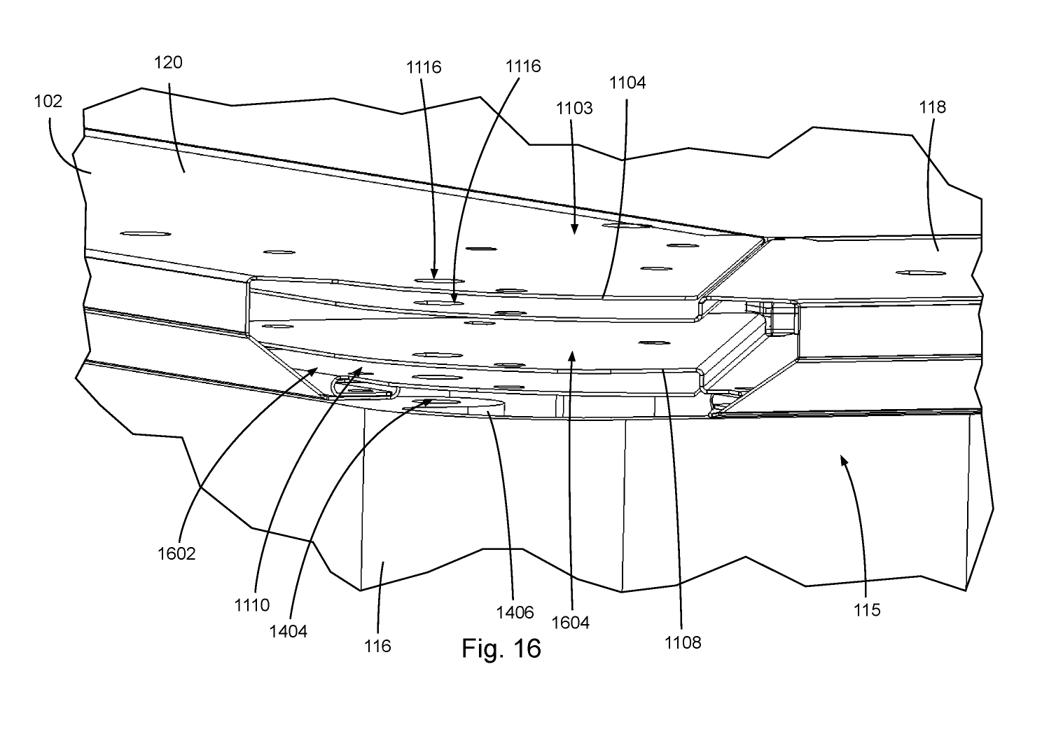

FIG. 16 shows an enlarged perspective view of one of the corners 115 of the top deck. More specifically, it illustrates one of the frame member joints 1104 before being filled by the composite fill material and being enclosed by the cap 121. While the frame member joints 1104 will be described with respect to the top deck 102, it should be recognized that the frame member joints 1104 in the bottom deck 104 have the same general construction as illustrated. As can be seen, the corner 115 of the top deck 102 is truncated so as to form a fill opening 1602 where the fill material can be filled and subsequently enclosed by the cap 121. At the frame member joint 1104, the tenon 1108 of the rail 118 is inserted inside the mortise opening 1110 of the stile 120. When the tenon 1108 is nested in the mortise opening 1110, the fastener openings 1116 of the rails 118 and stiles 120 are horizontally aligned with the fastener holes 1404 of the block 116 so that the fastener 1118 (FIG. 11) is able to extend through the rails 118 and stiles 120 in a straight manner so as to be secured in the fastener holes 1404 of the block 116. Once the fastener 1118 is secured, the rails 118 and stiles 120 are unable to be pulled apart without being damaged. This configuration allows for quick assembly of both the top 102 and bottom 104 decks with the blocks 116. The tenon 1108 and the mortise opening 1110 form a fill gap 1604 which opens at the fill opening 1602 so as to provide a space for transmitting the fill material to fill the inside of the rails 118, stiles 120, and muntin structure 122 of the top deck 102 (or bottom deck 104).

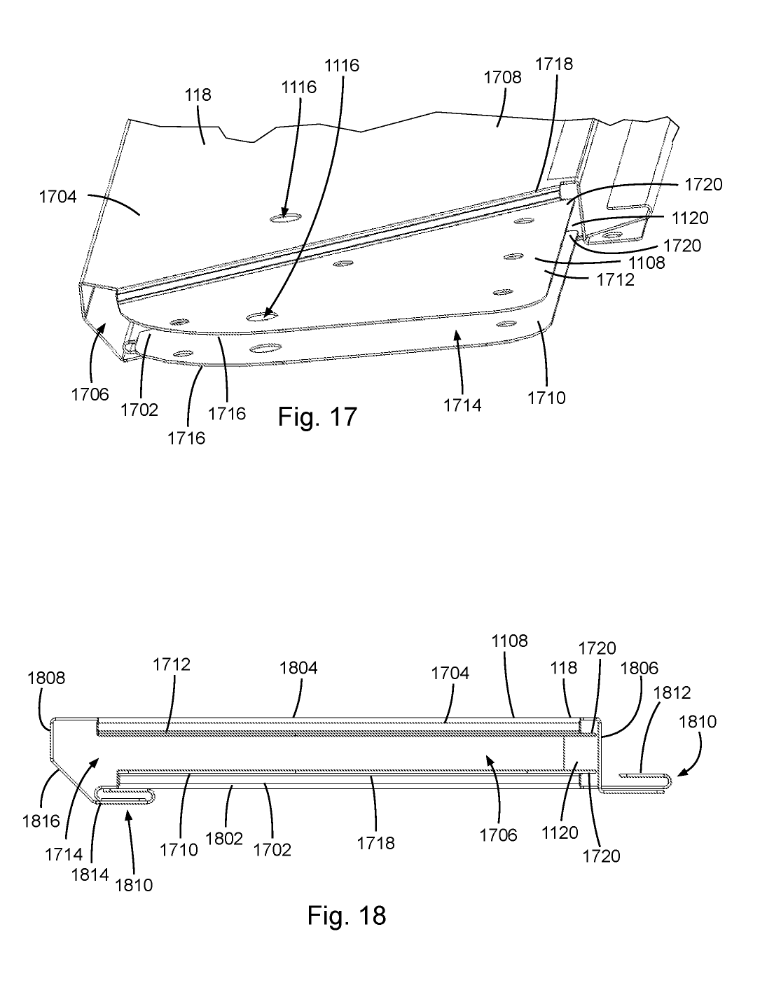

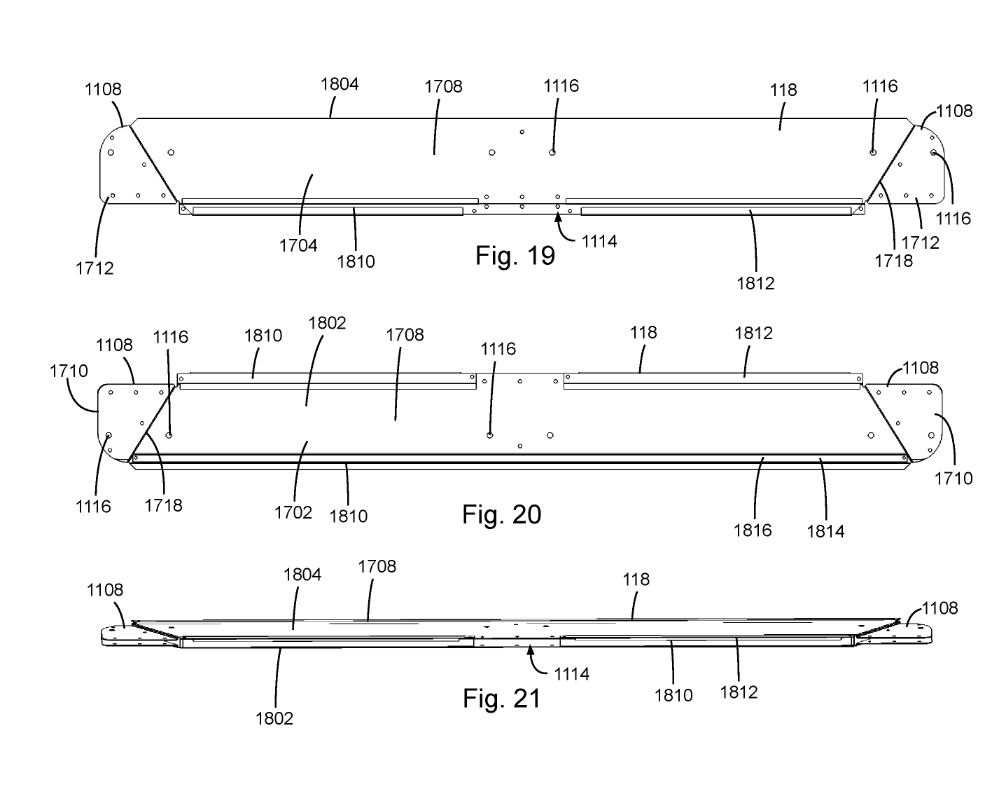

FIG. 17 shows an enlarged perspective view of the tenon 1108 of the top deck rail 118, and FIG. 18 shows an end view of the top deck rail 118. FIGS. 19, 20, and 21 respectively show top, bottom, and side views of the top deck rail 118. From the earlier discussion, it should be recognized that the bottom deck rail 202 has a similar general construction as the top deck rail 118, and for the sake of clarity as well as brevity, the following description applies to both types of rails 118, 202, unless noted otherwise. As can be seen, the top deck rail 118 is formed by a base sheet 1702 that is covered by a cover sheet 1704 to define a fill cavity 1706 in a main body 1708 in which the fill material is filled. The main body 1708, which defines the fill cavity 1706, is thicker than the tenon 1108. The cover sheet 1704 at the main body 1708 forms in part the outer surface of the pallet 100. At the tenon 1108, the base sheet 1702 and the cover sheet 1704 respectively have base 1710 and cover 1712 tenon tabs. As can be seen, the tenon tabs 1710, 1712 are offset from the main body 1708 so as to form the thinner tenon 1108. The base tenon tab 1710 and the cover tenon tab 1712 are spaced apart from one another to form a tenon gap 1714 in which at least a portion of the cap 121 is received and through which the concrete fill material is filled. In the illustrated example, the tenon tabs 1710, 1712 each have a cap engagement edge 1716 so as to form the truncated corner that forms the fill opening 1602. The cap engagement edge 1716 coincides in shape so as to engage the ledge 1508 of the cap 121 (FIG. 15). In the illustrated embodiment, the cap engagement edge 1716 is arched shaped to generally coincide in shape with the ledge 1508 of the cap 121, but the edge 1716 can have a different shape in other embodiments. As can be seen, the interface between the body 1708 and the tabs 1710, 1712 is in the form of a miter edge 1718 that is angled at a transverse angle relative to the longitudinal axis of the top deck rail 118. In one form, the miter edge 1718 is angled at a 45° angle, but the miter edge 1718 can be angled at different angles in other variations. The base 1710 and the cover tenon 1712 tabs further include rib retention lips 1720 that are positioned to retain the fiber reinforced ribs 1120 within the fill cavity 1706 in the main body 1708.

Turning to FIG. 18, the top deck rail 118 has an inner surface 1802 and an outer surface 1804 positioned opposite the inner surface 1802. Typically, but not always, the inner surface 1802 generally faces the fork openings 110 in the pallet 100. The outer surface 1804 forms the outer surface of the pallet 100 that normally, but not always, contacts the ground or items packed on the pallet 100. Spanning between the inner 1802 and outer 1804 surfaces, the top deck rail 118 has a window facing edge 1806 and an outer peripheral edge 1808 that is positioned opposite the window facing edge 1806. The window facing edge 1806 faces the window opening 123 (FIG. 1) when the pallet 100 is assembled. The outer peripheral edge 1808 in part forms the outer peripheral edge of the pallet 100. The top deck rail 118 includes seams 1810 where the base sheet 1702 and the cover sheet 1704 are joined together. In the illustrated example, the seams 1810 are generally in the form of a grooved seam joint and/or a single bottom seam, but in other examples, other types of seams for joining sheet metal can be used, such as a lap seam, a countersunk lap seam, an outside lap seam, a standing seam, a flat lock seam, a grooved flat lock seam, a lap bottom seam, and/or an insert bottom seam, to name just a few. To avoid the seams 1810 catching, being damaged and/or damaging other items, the seams 1810 are positioned in the interior of the pallet 100. Being located in such a manner, the seams 1810 can also help provide additional structural support for the rail 118 during assembly. At the window facing edge 1806, the seam 1810 forms a window ledge 1812 upon which panels 124 directly or indirectly rest. In the illustrated example, the window ledge 1812 is formed by a single bottom seam, but other types of seams can be used in other examples. The window ledge 1812 in the illustrated example is continuous, but the window ledge 1812 in other examples can be discontinuous. In other forms, the window ledge 1812 can include fastener openings for securing the panel slats 1102 when oriented to engage with the top deck rails 118. At the outer peripheral edge 1808, the seam 1810 forms a spacer ledge 1814 that is configured to help align the spacer blocks 116 with the rail 118 during assembly. As depicted, the spacer ledge 1814 extends above the inner surface 1802. In the depicted example, the spacer ledge 1814 is formed by a flat lock seam between the base sheet 1702 and the cover sheet 1704, but other types of joints can be used. As shown, the outer peripheral edge 1808 has a beveled surface 1816 that forms the bevel of the pallet 100 for directing the forks into the fork openings 110. The beveled surface 1816 guides the forks so as to minimize damage to the pallet 100. As can be seen, the seams 1810 are generally positioned around the fork openings 110. With the seams 1810 positioned internally around the fork openings 110, when the pallet 100 is lifted by a forklift or other lifting device, the force applied by the forks (and weight of the pallet as well as items packed on the pallet) further deform or crimp the seams 18010 such that the connection between the two sheets 1702, 1704 at the seam 1810 is further strengthened. Again, the angle of the beveled surface 1816 in conjunction with the location of the seam 1810 around the fork opening 110 further helps in this fork-crimping action. In a similar fashion, the force applied by items packed on the panels 124 (through the panel supports 1102) helps to further crimp or lock the seam 1810 at the spacer ledge 1814 which in turn strengthens the connection between the sheets 1702, 1704. Looking at FIGS. 19, 20, and 21, approximately midway along the length of the top deck rail 118, the window facing edge 1806 of the rail 118 defines the mortise opening 1114.

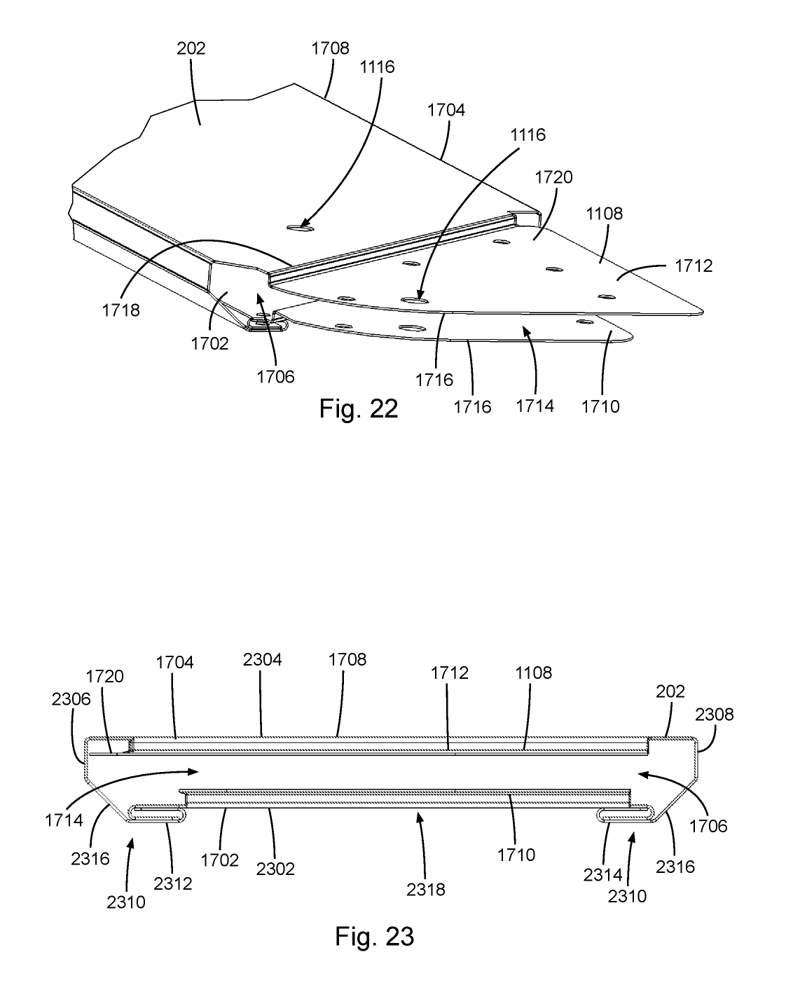

FIGS. 22 and 23 respectively show enlarged perspective and end views of the of the bottom deck rail 202. The bottom deck rail 202 is constructed in a fashion similar to that of the top deck rail 118 such that the bottom deck rail 202 shares a number of features in common with the top deck rail 118. For example, the bottom deck rail 202 includes the base sheet 1702, the cover sheet 1704, the fill cavity 1706, the main body 1708, the base tenon tab 1710, the cover tenon tab 1712, the tenon gap 1714, the arched peripheral edge 1716, the miter edge 1718, and the rib retention lips 1720 of the type described above with respect to the top deck rail 118. For the sake of clarity as well as brevity, these as well as other common features will not be discussed in detail below, but please refer to the previous discussion of these features.

Looking at FIG. 23, unlike the top deck rail 118, the bottom deck rail 202 does not include the window ledge 1812 in this particular example. In other examples, the bottom deck rail 202 can include the window ledge 1812, if so desired. The bottom deck rail 202 has an inner surface 2302 and an outer surface 2304 positioned opposite the inner surface 2302. Typically, but not always, the inner surface 2302 generally faces the fork openings 110 in the pallet 100. The outer surface 2304 forms the outer surface of the pallet 100 that normally, but not always, contacts the ground (or items packed on the pallet 100). Spanning between the inner 2302 and outer 2304 surfaces, the bottom deck rail 202 has a jack opening facing edge 2306 and an outer peripheral edge 2308 that is positioned opposite the jack opening facing edge 2306. The jack opening facing edge 2306 faces the jack opening 112 (FIG. 1) when the pallet 100 is assembled. The outer peripheral edge 2308 in part forms the outer peripheral edge of the pallet 100. The bottom deck rail 202 includes seams 2310 where the base sheet 1702 and the cover sheet 1704 are joined together. In the illustrated example, the seams 2310 are generally in the form of a grooved seam joint, but in other examples, other types of seams for joining sheet metal can be used, such as a lap seam, a countersunk lap seam, an outside lap seam, a standing seam, a flat lock seam, a grooved flat lock seam, a lap bottom seam, and/or an insert bottom seam, to name just a few. To avoid the seams 2310 catching, being damaged and/or damaging other items, the seams 2310 are positioned in the interior of the pallet 100 (e.g., facing the fork openings 110). The seams 2130 also strengthen the rail 202.

At the jack opening facing edge 2306 and the outer peripheral edge, the seams 2310 form first 2312 and second 2314 spacer ledges, respectively, that are configured to help generally align the spacer blocks 116 with the rail 202 during assembly. As depicted, the spacer ledges 2312, 2314 extend above the inner surface 2302. In the depicted example, the spacer ledges 2312, 2314 are formed by flat lock seams between the base sheet 1702 and the cover sheet 1704, but other types of joints can be used. As shown, both edges 2306, 2308 have a beveled surface 2316 that forms the bevel of the pallet 100 for directing the forks into or out of the fork openings 110. The beveled surface 2316 guides the forks so as to minimize damage to the pallet 100. As can be seen, the seams 2310 (2312, 2314) form a spacer channel 2318 in which the spacer blocks 116 can be received. As described before with reference to FIG. 12, approximately midway along the length of the bottom deck rail 202, the jack opening facing edge 2306 of the rail 202 defines the mortise opening 1206.

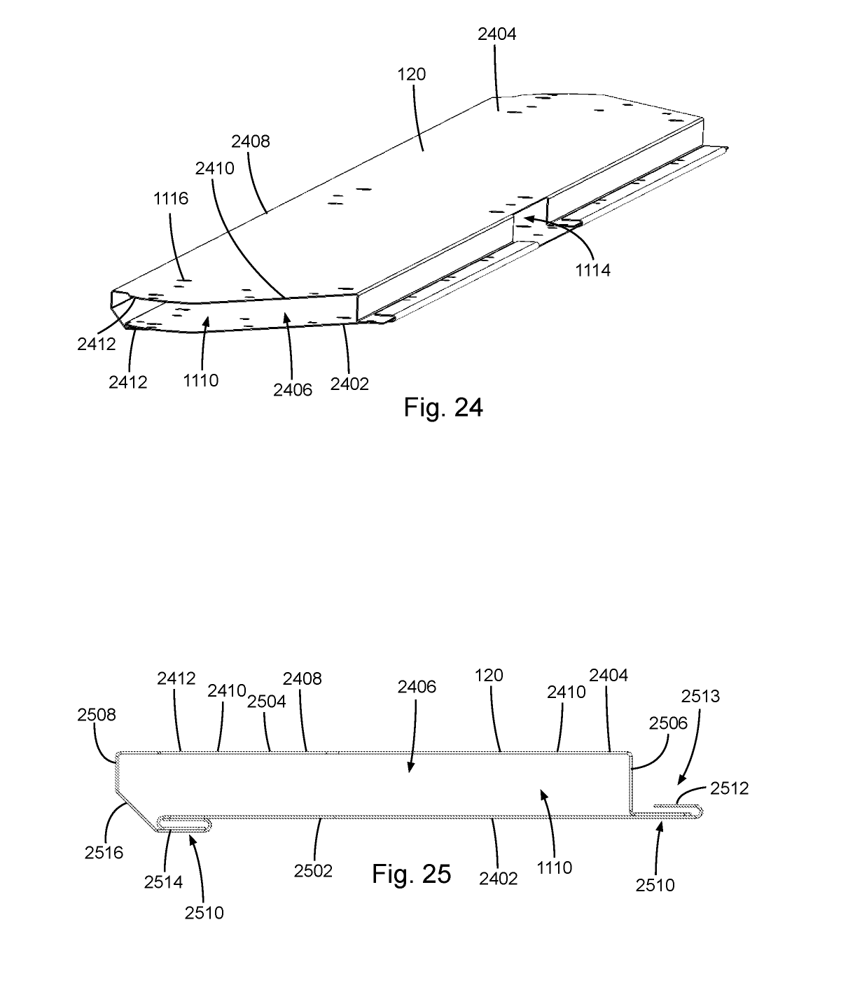

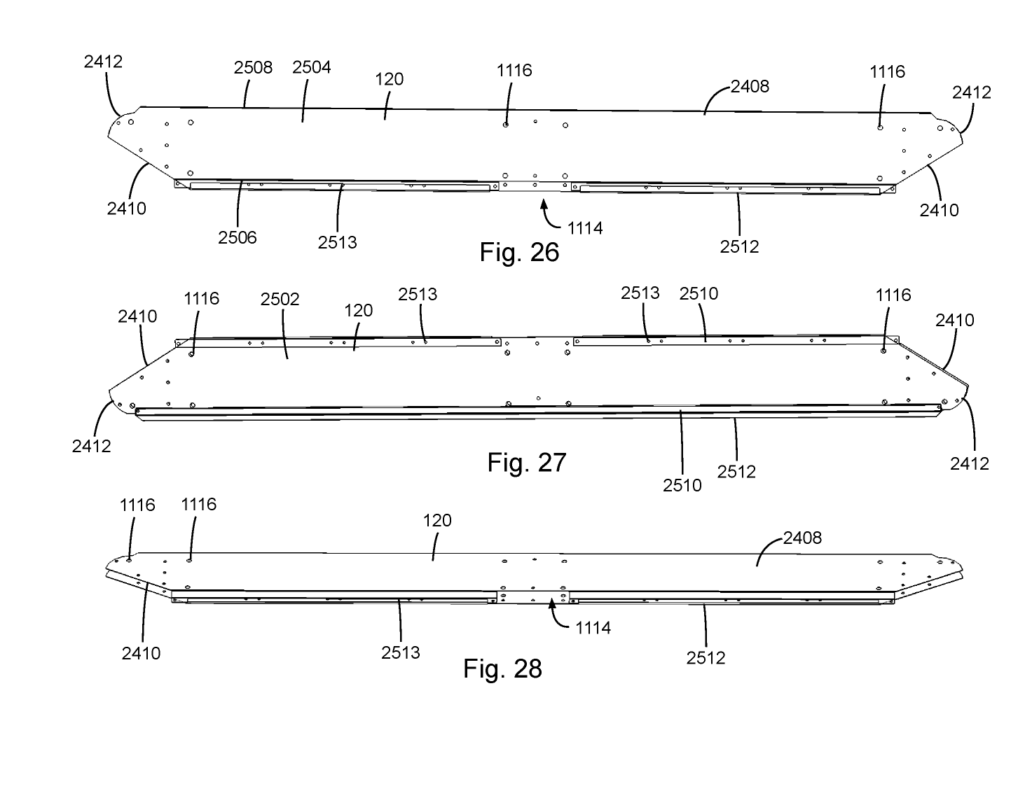

FIG. 24 shows a perspective view of the mortise opening 1110 of the top deck stile 120, and FIG. 25 shows an end view of the top deck stile 120. FIGS. 26, 27, and 28 respectively show top, bottom, and side views of the top deck stile 120. From the earlier discussion, it should be recognized that the bottom deck stile 204 has a similar general construction as the top deck stile 120, and for the sake of clarity as well as brevity, the following description applies to both types of stiles 120, 204, unless noted otherwise. As can be seen, the top deck stile 120 is formed by a base sheet 2402 that is covered by a cover sheet 2404 to define a fill cavity 2406 in a main body 2408 in which the fill material is filled. The main body 2408, which defines the fill cavity 2406, has a thickness that remains generally the same to the mortise opening 1110. The cover sheet 2404 at the main body 2408 form in part the outer surface of the pallet 100. As can be seen, the interface between the body 2408 the mortise opening 1110 is in the form of a miter edge 2410 that is angled at a transverse angle relative to the longitudinal axis of the top deck stile 120. In one form, the miter edge 2410 is angled at a 45° angle, but the miter edge 2410 can be angled at different angles in other variations. The top stile 120 further includes cap engagement edges 2412 that are positioned to engage the corner caps 121. In the illustrated example, the cap engagement edges 2412 are truncated to form the fill opening 1602 and arched shape so as to coincide with the shape of the ledge 1508 of the corner caps 121.

Turning to FIG. 25, the top deck stile 120 has an inner surface 2502 and an outer surface 2504 positioned opposite the inner surface 2502. Typically, but not always, the inner surface 2502 generally faces the fork openings 110 in the pallet 100. The outer surface 2504 forms the outer surface of the pallet 100 that normally, but not always, contacts the ground or items packed on the pallet 100. Spanning between the inner 2502 and outer 2504 surfaces, the top deck stile 120 has a window facing edge 2506 and an outer peripheral edge 2508 that is positioned opposite the window facing edge 2506. The window facing edge 2506 faces the window opening 123 (FIG. 1) when the pallet 100 is assembled. The outer peripheral edge 2508 in part forms the outer peripheral edge of the pallet 100. The top deck stile 120 includes seams 2510 where the base sheet 2402 and the cover sheet 2404 are joined together. In the illustrated example, the seams 2510 are generally in the form of a grooved seam joint and/or a single bottom seam, but in other examples, other types of seams for joining sheet metal can be used, such as a lap seam, a countersunk lap seam, an outside lap seam, a standing seam, a flat lock seam, a grooved flat lock seam, a lap bottom seam, and/or an insert bottom seam, to name just a few. To avoid the seams 2510 catching, being damaged and/or damaging other items, the seams 2510 are positioned in the interior of the pallet 100. In other words, the seams 2510 are exposed. Being located in such a manner, the seams 2510 can also help provide additional structural support for the stile 120 during assembly. At the window facing edge 2506, the seam 2510 forms a window ledge 2512 upon which panels 124 directly or indirectly rest. In the illustrated example, the window ledge 2512 is formed by a single bottom seam, but other types of seams can be used in other examples. The window ledge 2512 in the illustrated example is continuous, but the window ledge 2512 in other examples can be discontinuous. In the depicted example, the window ledge 2512 includes fastener openings 2513 for securing the panel slats 1102 when oriented to engage with the top deck stiles 120. At the outer peripheral edge 2508, the seam 2510 forms a spacer ledge 2514 that is configured to help align the spacer blocks 116 with the stile 120 during assembly. As depicted, the spacer ledge 2514 extends above the inner surface 2502. In the depicted example, the spacer ledge 2514 is formed by a flat lock seam between the base sheet 2402 and the cover sheet 2404, but other types of joints can be used. As shown, the outer peripheral edge 2508 has a beveled surface 2516 that forms the bevel of the pallet 100 for directing the forks into the fork openings 110. The beveled surface 2516 guides the forks so as to minimize damage to the pallet 100. Looking at FIGS. 24, 26, 27, and 28, approximately midway along the length of the top deck stile 120, the window facing edge 2506 of the stile 120 defines the mortise opening 1114.

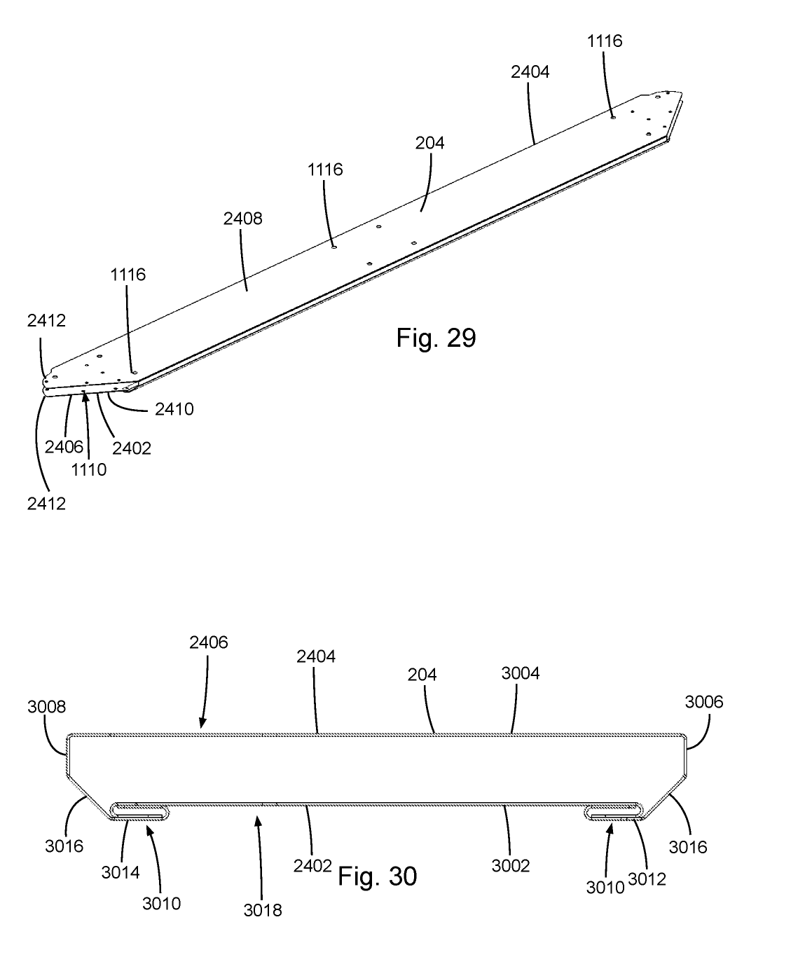

FIGS. 29 and 30 respectively show enlarged perspective and end views of the of the bottom deck stile 204. The bottom deck stile 204 is constructed in a fashion similar to that of the top deck stile 120 such that the bottom deck stile 204 shares a number of features in common with the top deck stile 120. For example, the bottom deck stile 204 includes the base sheet 2402, the cover sheet 2404, the fill cavity 2406, the main body 2408, the mitered edge 2410, and the cap engagement edge 2412 of the type described above with respect to the top deck stile 120. For the sake of clarity as well as brevity, these as well as other common features will not be discussed in detail below, but please refer to the previous discussion of these features.

Unlike the top deck stile 120, the bottom deck stile 204 does not include the mortise opening 1114 (FIG. 29) and the window ledge 2512 (FIG. 30) in this particular example. In other examples, the bottom deck rail 202 can include the mortise opening 1114 and/or the window ledge 2512, if so desired. Looking at FIG. 30, the bottom deck stile 204 has an inner surface 3002 and an outer surface 3004 positioned opposite the inner surface 3002. Typically, but not always, the inner surface 3002 generally faces the fork openings 110 in the pallet 100. The outer surface 3004 forms the outer surface of the pallet 100 that normally, but not always, contacts the ground (or items packed on the pallet 100). Spanning between the inner 3002 and outer 3004 surfaces, the bottom deck stile 204 has a jack opening facing edge 3006 and an outer peripheral edge 3008 that is positioned opposite the jack opening facing edge 3006. The jack opening facing edge 3006 faces the jack opening 112 (FIG. 1) when the pallet 100 is assembled. The outer peripheral edge 3008 in part forms the outer peripheral edge of the pallet 100. The bottom deck stile 204 includes seams 3010 where the base sheet 2402 and the cover sheet 2404 are joined together. In the illustrated example, the seams 3010 are generally in the form of a grooved seam joint, but in other examples, other types of seams for joining sheet metal can be used, such as a lap seam, a countersunk lap seam, an outside lap seam, a standing seam, a flat lock seam, a grooved flat lock seam, a lap bottom seam, and/or an insert bottom seam, to name just a few. To avoid the seams 3010 catching, being damaged and/or damaging other items, the seams 3010 are positioned in the interior of the pallet 100 (e.g., facing the fork openings 110) and not exposed. The seams 2130 also strengthen the stile 204.

At the jack opening facing edge 3006 and the outer peripheral edge 3008, the seams 3010 form first 3012 and second 3014 spacer ledges, respectively, that are configured to help generally align the spacer blocks 116 with the stile 204 during assembly. As depicted, the spacer ledges 3012, 3014 extend above the inner surface 3002. In the depicted example, the spacer ledges 3012, 3014 are formed by flat lock seams between the base sheet 2402 and the cover sheet 2404, but other types of joints can be used. As shown, both edges 3006, 3008 have a beveled surface 3016 that forms the bevel of the pallet 100 for directing the forks into or out of the fork openings 110. The beveled surface 3016 guides the forks so as to minimize damage to the pallet 100. As can be seen, the seams 3010 (3012, 3014) form a spacer channel 3018 in which the spacer blocks 116 can be guided, if so desired. As described before with reference to FIG. 12, approximately midway along the length of the bottom deck stile 204, the jack opening facing edge 3006 of the stile 204 defines the mortise opening 1206.

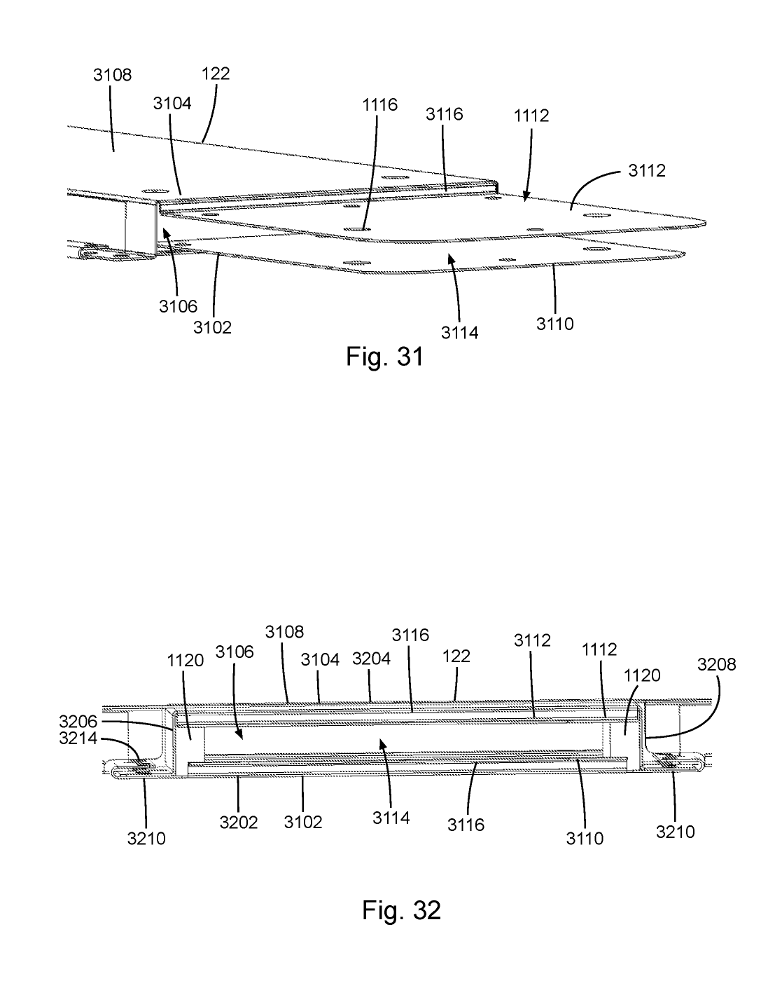

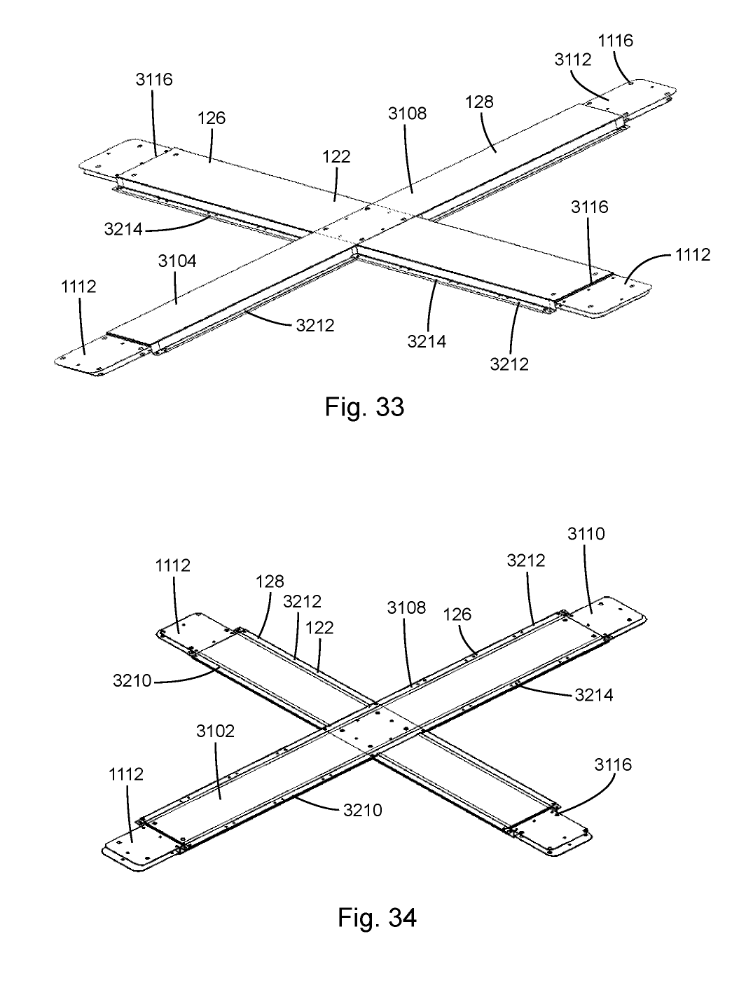

FIG. 31 shows an enlarged perspective view of the muntin tenon 1112 of the muntin structure 122, and FIG. 32 shows an end view of the muntin structure 122. FIGS. 33, 34, and 35 respectively show top, bottom, and exploded views of the muntin structure 122. The rail muntin 126 and the stile muntin 128 in the depicted embodiment are formed integrally together such that the muntin structure 122 has a unitary construction. In other examples, the rail muntin 126 and the stile muntin 128 are separate components that are joined together in a cross pattern to form the muntin structure 122. As can be seen, the muntin structure 122 is formed by a base sheet 3102 that is covered by a cover sheet 3104 to define a fill cavity 3106 in a main body 3108 in which the fill material is filled. The main body 3108, which defines the fill cavity 3106, is thicker than the muntin tenon 1112. The cover sheet 3104 at the main body 3108 forms in part the outer surface of the pallet 100. At the muntin tenon 1112, the base sheet 3102 and the cover sheet 3104 respectively have base 3110 and cover 3112 tenon tabs. As can be seen, the tenon tabs 3110, 3112 are offset from the main body 3108 so as to form the thinner muntin tenon 1112. The base tenon tab 3110 and the cover tenon tab 3112 are spaced apart from one another to form a tenon gap 3114 through which the fill material flows to fill the fill cavity 3106 of the muntin structure 122. As can be seen, the interface between the body 3108 and the tabs 3110, 3112 is in the form of a miter edge 3116 that is angled at a transverse angle relative to the longitudinal axis. In one form, the miter edge 3116 is angled at a perpendicular angle, but the miter edge 3118 can be angled at different angles in other variations. The base 3110 and cover 3112 tenon tabs further are positioned to retain the fiber reinforced ribs 1120 within the fill cavity 3106 in the main body 3108.

Turning to FIG. 32, the muntin structure 122 has an inner surface 3202 and an outer surface 3204 positioned opposite the inner surface 3202. Typically, but not always, the inner surface 3202 generally faces the fork openings 110 in the pallet 100. The outer surface 3204 forms the outer surface of the pallet 100 that normally, but not always, contacts the items packed on the pallet 100 (or the ground when the pallet 100 is flipped). Spanning between the inner 3202 and outer 3204 surfaces, the muntin structure 122 has a first window facing edge 3206 and a second window facing edge 3208 that is positioned opposite the first window facing edge 3206. The window facing edges 3206, 3208 each face their respective window openings 123 (FIG. 1) when the pallet 100 is assembled. The muntin structure 122 includes seams 3210 where the base sheet 3102 and the cover sheet 3104 are joined together. In the illustrated example, the seams 3210 are generally in the form of a single bottom seam, but in other examples, other types of seams for joining sheet metal can be used, such as a lap seam, a countersunk lap seam, an outside lap seam, a standing seam, a flat lock seam, a grooved flat lock seam, a lap bottom seam, and/or an insert bottom seam, to name just a few. To avoid the seams 3210 catching, being damaged and/or damaging other items, the seams 3210 are positioned in the interior of the pallet 100. Being located in such a manner, the seams 3210 can also help provide additional structural support for the rail 118 during assembly. At the window facing edges 3206, 3208, the seams 3210 form window ledges 3212 upon which panels 124 directly or indirectly rest. In the illustrated example, the window ledge 3212 is formed by a single bottom seam, but other types of seams can be used in other examples. The window ledge 3212 in the illustrated example is continuous, but the window ledge 3212 in other examples can be discontinuous. In the illustrated example, the window ledge 3212 along the rail muntin 126 include fastener openings 3214 for securing the panel slats 1102 via fasteners when oriented to engage with the top deck rails 118, and the stile muntin 128 does not include the fastener openings 3214. In other forms, all or some of the window ledges 3212 can include fastener openings 3214 in other manners than is illustrated.

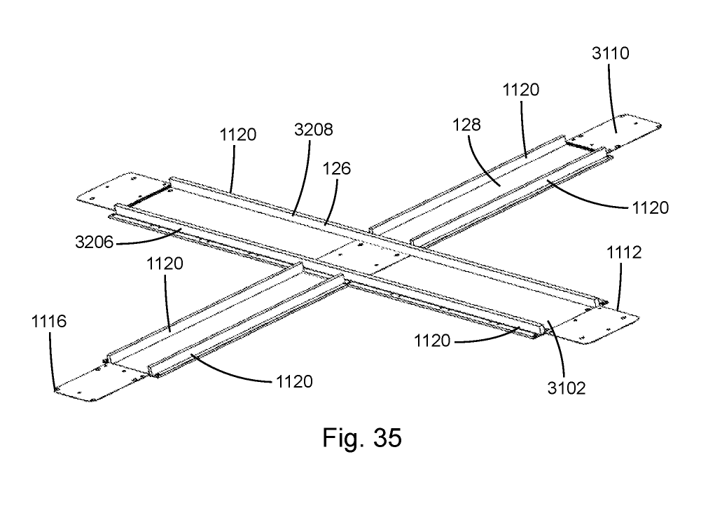

FIG. 35 shows a partial cross-sectional perspective view of the muntin structure with the cover sheet 3104 removed. As can be seen, rail 126 and stile 128 muntins in the muntin structure 122 have fiber reinforced ribs extending along the edges 3206, 3208. The fiber reinforced ribs 1120 for the rail muntin 126 extend for the full length of the rail muntin 126, while the stile muntin 128 has two sets of fiber reinforced ribs 1120 that are bisected by the fiber reinforced ribs 1124 at the rail muntin 126. The fiber reinforced ribs 1120 can be configured in an opposite fashion or in other manners in different examples.

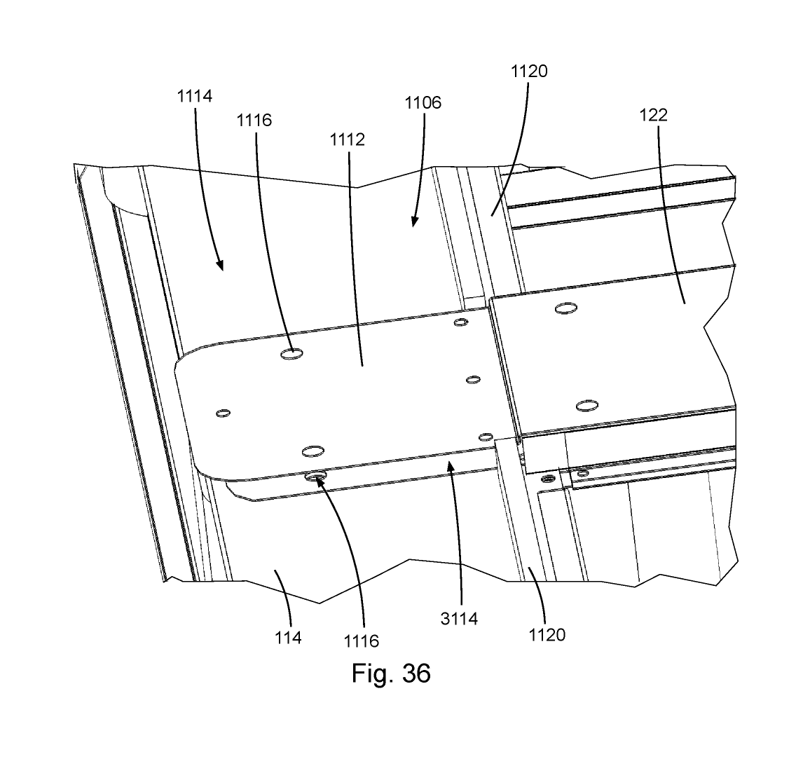

FIG. 36 shows a partial cross-sectional perspective view of a muntin joint 1106 with a cover sheet or layer of the frame member 114 removed. As shown, the muntin tenon 1112 is inserted into the mortise opening 1114. The fiber reinforced ribs 1120 in the frame member 114 are split apart at the mortise opening 1114 to allow the tenon tabs 310, 312 to extend through. Again, the tenon gap 3114 allows the fill material from the frame member 114 to flow inside the muntin structure 122 during filling.

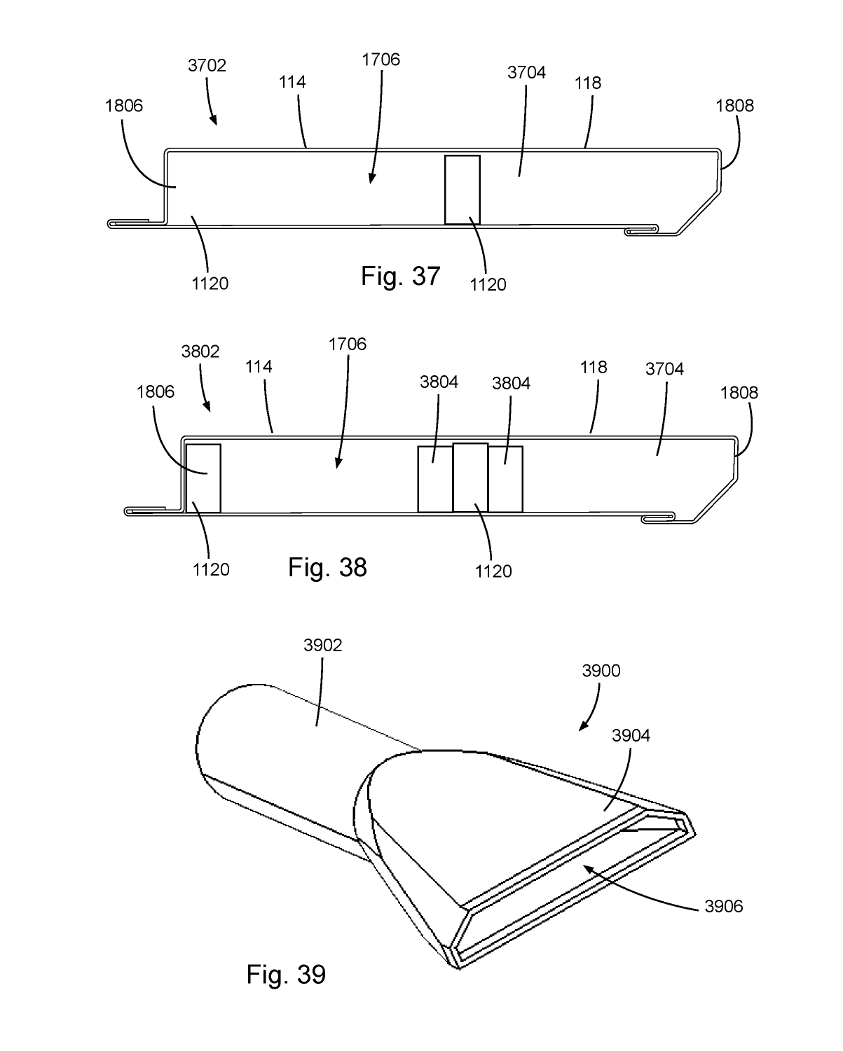

FIG. 37 shows a cross-sectional view of the top deck rail 118 with one example of internal reinforcement arrangement 3702. This same internal reinforcement arrangement 3702 can be used in other components of the pallet 100, such as the top deck stiles 120, muntin structure 122, bottom deck rails 202, bottom deck stiles 204, and bottom deck slat 206. As shown, a pair of the fiber reinforced ribs 1120 are embedded inside fill material 3704 that is located inside the fill cavity 1706 of the top deck rail 118. Various types of materials can be used for the fill material 3704. By way of non-limiting examples, all or part of the fill material 3704 for the pallet 100 can be made of concrete, such as FRC, ECC, lightweight ECC, self-compacting ECC, sprayable ECC, and/or extrudable ECC. The concrete can further contain air voids, glass bubbles, polymer spheres, and/or lightweight aggregate. As noted before, the fill material 3704 in one example is made of a composite concrete mixture so as to provide the requisite strength for the pallet 100. One of the fiber reinforced ribs 1120 is positioned at the window facing edge 1806 of the top deck rail 118, and the other fiber reinforced rib 1120 is positioned generally in the middle of the rail 118, closer to the outer peripheral edge 1808. The fiber reinforcement ribs 1120 in combination with the fill material 3704 enhances the overall strength of the pallet 100.

FIG. 38 shows a cross-sectional view of the top deck rail 118 with another example of internal reinforcement arrangement 3802. Like with the previous example, this same internal reinforcement arrangement 3802 can be used in other components of the pallet 100, such as the top deck stiles 120, muntin structure 122, bottom deck rails 202, and bottom deck stiles 204. As shown, a pair of the fiber reinforced ribs 1120 are again embedded inside the fill material 3704 that fills the fill cavity 1706 of the top deck rail 118. The fiber reinforced ribs 1120 are positioned at the same location as that in the FIG. 37 example. One or more foam ribs 3804 are positioned proximal to one of the fiber reinforced ribs 1120. In the example illustrated in FIG. 38, a pair of the foam ribs 3804 are positioned on opposite sides of the fiber reinforced rib 1120 that is positioned generally at the midway point between the edges 1806, 1808 of the top deck rail 118. In other words, the fiber reinforced rib 1120 is sandwiched between the foam ribs 3804. In one form, the foam ribs 3804 are made of polystyrene foam, but other types of foam material can be used. Having the foam ribs 3804 made of polystyrene foam reduces the overall weight of the pallet 100 so that the weight of the pallet 100 is comparable to a wooden pallet. The polystyrene foam also aids in the durability of the pallet 100. In particular, the polystyrene foam for the ribs 3804 acts as a shock absorber by absorbing, dispersing, and/or dampening the energy from an impact, especially around the fiber reinforcement rib 1120.

A method of manufacturing the pallet 100 will now be described with reference to the previously discussed drawings as well as FIGS. 39-43. In one example, the metal sheets of the frame members 114 are roll formed in a continuous or near continuous process to form the general outer shape of the frame members 114, such as the rails and stiles, including the rails 202 and stiles 204 of the muntin structure 122. When the muntin structure 122 (FIG. 33) is formed with its rails 126 and stiles 128 muntins integral with one another (FIG. 1), the sheets 3102, 3104 of the muntin structure 122 can be stamped to form the overall cross pattern. Alternatively or additionally, the overall shape of the frame members 114, such as including the tenon tabs, is created using a press brake forming process. The ends of the frame members 114 are further stamped and cut to form the miter angles as well as the tenons and mortise openings. In addition, the fastener openings 1116 are punched in one variation, but in other examples, the fastener openings 1116 are drilled or formed in other manners, such as via water jet cutting and/or photochemical etching. In still yet other examples, the metal sheets are cut via a laser or plasma cutter to form the general shapes of the frame members 114, including the various openings. While the tenons in the illustrated examples are formed by two tenon tabs that create a tenon gap, the tenons in other examples can have more or less tenon tabs (e.g., one or three). Press braking in one example is used to form the seams (e.g., 1810, 2310, 2510, 3010, 3210, etc.) where the two sheets are joined together to form the corresponding frame member 114. Alternatively or additionally, a roll forming process can be used to partially or fully form the seams between the sheets in the frame members 114. The panel supports 1102 in one form are stamped, but in other examples, the panel supports 1102 can be formed in other manners such as via roll forming.

When the frame members 114 include the fiber reinforcement ribs 1120, the fiber reinforcement ribs 1120 can be inserted inside the frame members 114 before the seams between the top and bottom sheets are formed. In another variation, the fiber reinforcement ribs 1120 are inserted or placed inside after one of the seams is formed. In still yet another example, the fiber reinforced ribs 1120 are inserted after both of the seams are formed. The offset created by the tenon tabs in one form is used to hold the fiber reinforced ribs 1120 in place during manufacturing. For example, looking at FIGS. 17 and 18, the tenon tabs 1710, 1712 are able to hold the fiber reinforced ribs 1120 in place before, during, or after the seams 1810 are formed. It should be recognized that the tenon tabs in other frame members 114 can be used to retain the fiber reinforced ribs 1120. In other words, the tenon tabs 1710, 1712 prevent the fiber reinforced ribs 1120 from partially or fully sliding out of the particular frame member 114 or otherwise move during assembly.

In one example, the spacer blocks 116 are made of plastic and formed via an injection molding process. In another example, the spacer blocks 116 are made of fiber reinforced material, such as fiberglass, and are press molded to form the final shape. The corner caps 121 are made of plastic and formed via an injection molding process in one variation, but in other variations, the corner caps 121 can be formed from other materials and in other manners, such using a traditional fiber glass manufacturing process. The fiber reinforced ribs 1120 in one example are manufactured using the traditional fiber glass manufacturing process. In another example, the fiber reinforced ribs 1120 are made from scraps of fiberglass from other manufacturing or recycling processes.

Returning to FIGS. 11, 12, and 13, once the various frame members 114 are formed, the frame members 114 are assembled together along with the spacer blocks 116. As noted before, the seams (e.g., 1810, 2310, 2510, etc.) form ledges or channels that help with aligning the spacer blocks 116 during assembly (FIGS. 18, 23, and 25). In one version, the top 102 and bottom 104 decks are first assembled and then attached to the spacer blocks 116. In another version, the top 102 and bottom 104 decks are assembled at the same time with the spacer blocks 116. In other variations, a combination of these approaches can be used. For example, the bottom deck 104 is assembled, the spacer blocks 116 are then attached to the assembled bottom deck 104, and then the top deck 102 is assembled in a piecewise manner to the spacer blocks. In another example, the pallet 100 is assembled in the reverse manner in which the top deck 102 is first assembled, the spacer blocks 116 are then attached to the top deck 102, and finally the bottom deck 104 is then assembled on the spacer blocks 116. During assembly of the frame structure 108, the tenons (e.g., 1108, 1112, 1204, etc.) are inserted into their corresponding mortise openings (e.g., 1110, 1114, 1206, etc.). For instance, the tenons 1108 of the top deck rail 118 are inserted into the mortise openings 1110 of the top deck stiles 120. When the frame member joints 1104 are formed, the fastener openings 1116 in both the top deck rail 118 and the top deck stiles 120 are aligned with the one another, such as is depicted in FIG. 16. The fastener openings 1116 in the frame member joints 1104 are also aligned with the fastener holes 1404 in the blocks 116. The fasteners 1118 are then inserted into the fastener openings 1116 in the frame members 114 and the fastener holes 1404 in the blocks 116. In one form, the fastener holes 1404 in the blocks 116 are threaded to secure fasteners 1118 in the form of screws, and in another version, nuts are used to secure the screws that extend completely through blocks 116 and frame members 114 of the pallet 100. In the illustrated examples, four fasteners 1118 are used to secure the frame members 114 to the blocks 116, but more or less fasteners 1118 can be used in other examples. In one variation, some but not all of the fasteners 1118 that are required to secure a particular frame member joint 1104 such that after frame structure 108 is assembled and the pallet 100 is filled with the fill material 3704, one or more fasteners 1118 are used to secure the caps 121 to the frame member joint 1104 so as to act as a stop or plug for the fill material 3704. In one particular example, three fasteners 1118 secure the frame member joints 1104 together during initial assembly of the frame structure 108, and the fourth fastener 1118 is secured through the cap 121 after the pallet is filled with the fill material so that the cap 121 is secured in place. In another variation, only one fastener 1118 secures the joint together during initial assembly of the frame structure 108, and the rest of the fasteners 1118 are secured during or after filling of the pallet 100 with the fill material 3704. The muntin 1106 and deck slat 1202 joints are secured in a similar fashion in which the fastener openings 1116 at the joints are aligned with the fastener holes 1404 in the blocks 116 so that the fasteners 1118 can be readily secured. As should be recognized, this fastening configuration for the joints allows the frame structure 108 to be assembled in a quick and accurate fashion. It also should be recognized that the open construction of the various joints allows the top 102 and bottom 104 decks to be filled rather quickly and fully with the fill material 3704. In other words, the gaps or openings at the frame member 1104, muntin 1106, and deck slat 1202 joints facilitate the flow into and through the various joined members, such as the rails, stiles, slats, and muntin structure.

Before, during, or after the frame structure 108 is assembled, the panel supports 1102 are attached to the ledges 2512, 3214 of the top deck rails 118 and muntin rail 126 via fasteners 1118. As shown in FIG. 11 as well as elsewhere in the drawings, the panel supports 1102 extend across the window openings 123. Once the panel supports 1102 are secured, the panels 124 are secured to the panel supports 1102 in the window openings 123. In one form, the panels 124 are secured via adhesives, and in another form, the panels 124 are secured via fasteners 1118. Alternatively or additionally, the panels 124 can be secured to the frame structure 108 in other manners. For instance, the panel supports 1102 may be absent from the frame structure 108 such that the panels 124 are directly attached to the ledges 1812, 2512, 3212, 3214 of the frame members 114 of the top deck 102. In another variation of this technique, the panels 124 are attached to the top deck 102 after the decks 102, 104 are filled with the fill material 3704.

As mentioned before, some or all of the blocks 116 can be filled with the fill material 3704. In one example, the blocks 116 are empty or unfilled with the fill material 3704 when attached to the decks 102, 104 such that the blocks 116 remain empty in the finished pallet 100. The blocks 116 in another example are fully or partially filled with the fill material 3704 before being attached to the decks 102, 104. The blocks 116 in another variation are attached to one of the decks 102, 104 (or their components) in an unfilled state, and filled with the fill material 3704 before the other deck 102, 104 is attached so as to seal the ends of the blocks 116 with the fill material 3704 inside. In still yet another example, the blocks 116 are fully or partially filled with a combination of foam inserts (e.g., like foam ribs 3804), such as made of polystyrene foam, and fill material 3704.

A perspective view of a nozzle 3900 used to fill the fill material 3704 into the frame structure 108 of the pallet 100 is shown in FIG. 39. As can be seen, the nozzle 3900 includes a neck 3902 and a head 3904 attached to the neck 3902. The nozzle 3900 defines a fill passage 3906 through which the fill material 3704 flows during filling of the pallet 100. The fill passage 3906 extends from the neck 3902 and opens at the head 3904. The neck 3902 is configured to connect to a hose or other supply conduit that supplies the fill material 3704 to the nozzle 3900.

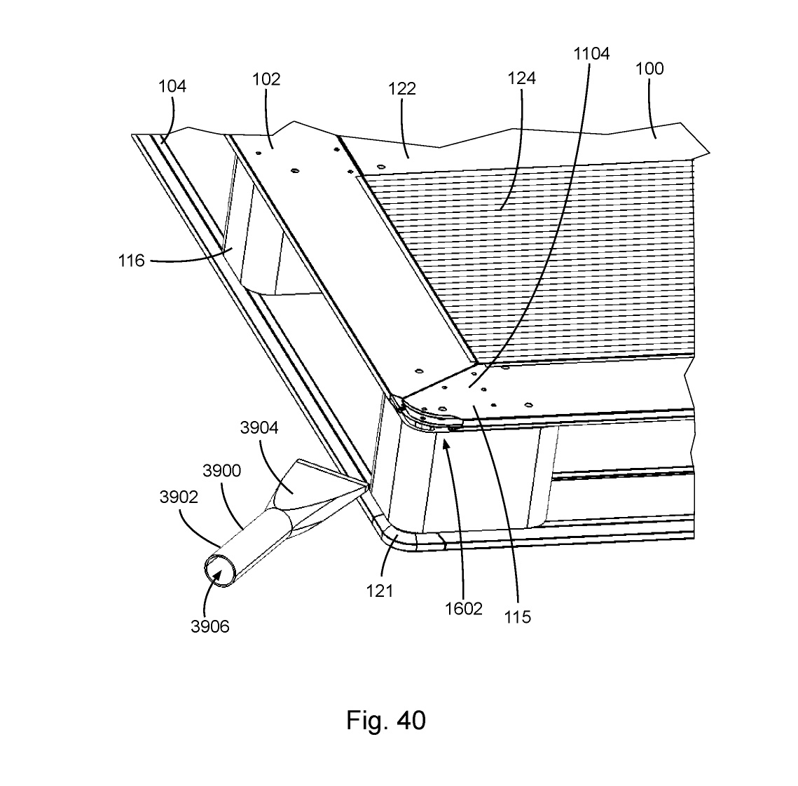

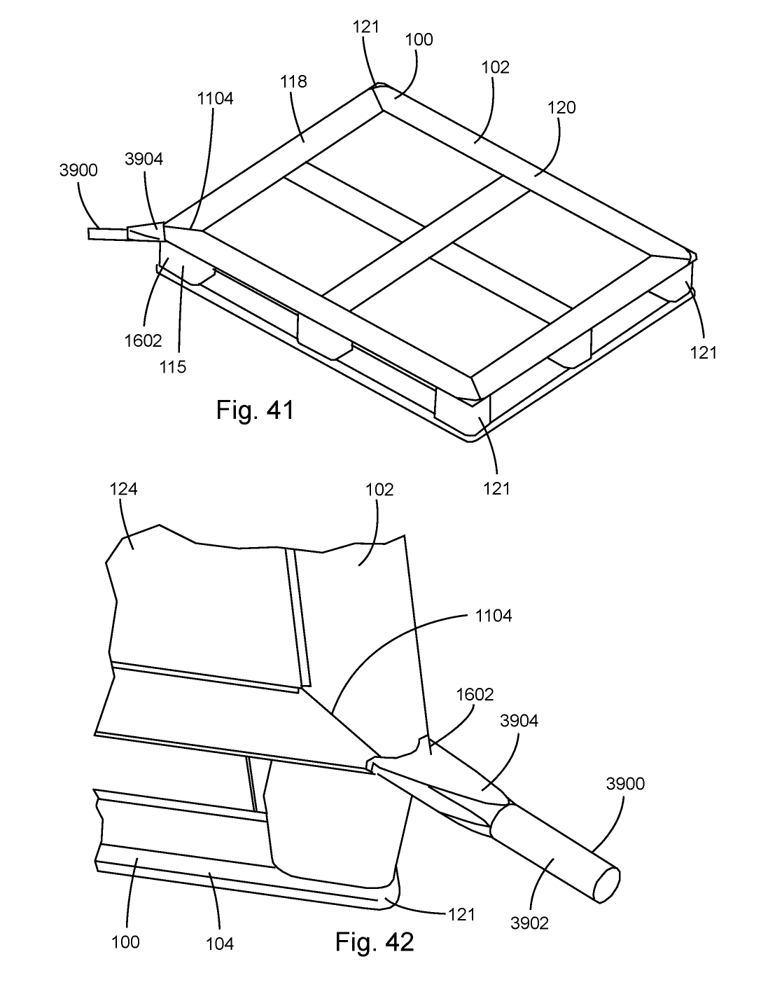

FIG. 40 shows an enlarged perspective view of one corner 115 of the pallet 100 before filling of the top deck 102 with the fill material 3704. In this example, one of the caps 121 is removed at one of the corners 115 so that the fill opening 1602 is exposed. The remaining caps 121 seal the other corners 115 so as to prevent leakage of the fill material 3704. As shown, the nozzle 3900 is positioned so that the head 3904 faces the fill opening 1602. Turning to FIGS. 41 and 42, the head 3904 of the nozzle 3900 is pressed or generally sealed against the frame member joint 1104 at the corner 115 of the pallet 100. The fill material 3704 in one example is pressurized when discharged from the nozzle 3900 so as to facilitate flowing of the fill material 3704 throughout the entire top deck 102. In another example, the pallet 100 is oriented generally vertically so that gravity can be used to pour the fill material 3704 inside the top deck 102. As mentioned before, the joints between the various frame members 114 have gaps at the tenons so that the entire top deck 102 can be readily filled. For instance, the fill material 3704 not only fills the top deck rails 118 and stiles 120, but the fill material 3704 is able to flow through the tenon gaps 3114 in the muntin structure 122 (FIGS. 31 and 32) so as to fill the muntin structure 122 at the same time. Once more, the caps 121 prevent leakage from the other corners 115. The bottom deck 104 is filled in the same manner as the top deck 102.

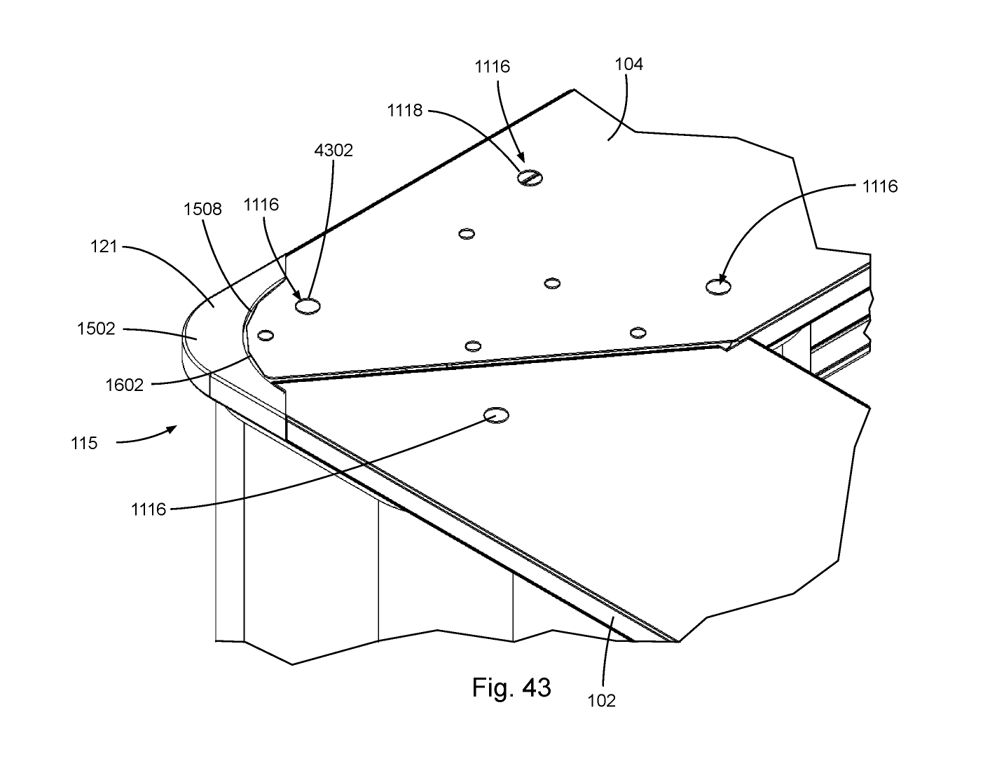

Once the decks 102, 104 are filled, the cap 121 is attached to fill the fill opening 1602, as is depicted in FIG. 43. In any of the fastener openings 1116 that are still open, the fasteners 1118 are secured. For instance, at fastener opening position 4302, the fastener 1118, such as a screw, is secured by being screwed through the body 1504 of the cap 121 which in turn prevents the cap 121 from being accidentally dislodged or removed.

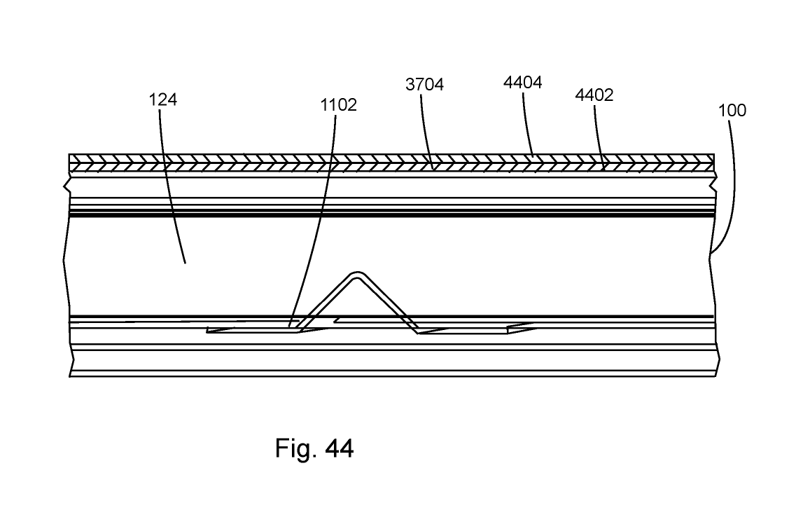

FIG. 44 shows an enlarged cross-sectional view of the pallet 100 around the panel 124. After the pallet 100 is filled with the fill material 3704, a skim coat 4402 of the fill material 3704 can be applied to the outside of the pallet 100, if so desired. Alternatively or additionally, a protective coating 4404 can be likewise applied to the outside of the pallet 100 so as to provide additional protection from moisture, the environment, and/or chemicals. These coatings 4402, 4404 can cover only selected parts or surfaces of the pallet 100, such as the decks 102, 104 or spacer 106, or the entire pallet 100. In one version, the protective coating 4404 is made of polyurethane and/or epoxy, but other types of coatings can be used.

The concrete can be cured through normal curing processes. Alternatively or additionally, the concrete is cured through a steam curing process and/or via an autoclave that applies pressure or a vacuum to the formed pallet. Further, the curing can be accelerated by exposing the concrete to CO₂. The frame structure 108 allows the pallet 100 to cure even after manufacturing. For instance, the concrete in the pallet 100 can cure while the pallet 100 is stored in a warehouse and/or during shipping to a customer. In one example, the fill material concrete is cured at 125 degrees Fahrenheit using a wet curing or steam curing process.

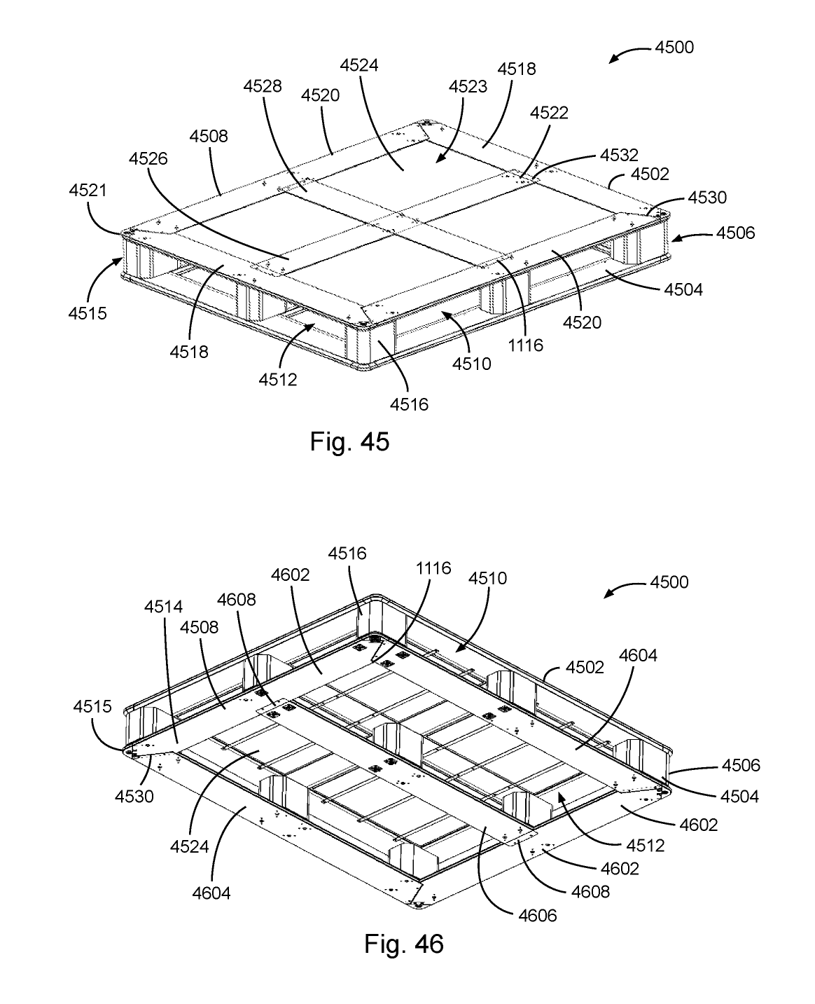

A pallet 4500 according to another example is illustrated starting in FIG. 45. FIG. 45 shows a top view of the pallet 4500 and FIG. 46 shows a bottom perspective view of the pallet 4500. Like in the previous example, the pallets 4500 includes a top deck 4502, a bottom deck 4504, and a spacer structure 4506. The top deck 4502, bottom deck 4504 and spacer 4506 form a frame structure 4508 in which the concrete fill material 3704 is enclosed. Like in the previous example, the pallet 4500 defines one or more fork openings 4510 and jack openings 4512. The top deck 4502 and bottom deck 4504 are formed by a series of frame members 4514 that are interconnected together at various joints. Again, the pallet 4500 includes a series of corners 4515. The spacer 4506 is created by one or more spacer blocks 4516 that are sandwiched between the top 4502 and bottom 4504 decks. The top deck 4502 is formed by a pair of top deck rails 4518 that are joined together via top deck stiles 4520. Like in the previous example, the corners 4515, where the top deck rails 4518 and top deck stiles 4520 are joined, are enclosed by corner caps 4521. A muntin structure 4522 extends between the frame members 4514 of the top deck 4502 to form one or more window openings 4523. Panels 4524 are supported in the window openings 4523. The muntin structure 4522 in the illustrated example includes a first or rail muntin 4526 that extends transversely to a second or stile muntin 4528 so as to form a cross pattern. The top deck rails 4518 and the top deck stiles 4520 are joined together at frame member joints 4530 which are located at the corners 4515 of the pallet 4500. The muntin structure 4522 is connected to the top deck rails 4518 and the top deck stiles 4520 at muntin joints 4532.

Turning to FIG. 46, the frame members 4514 of the bottom deck 4504 include one or more bottom deck rails 4602, bottom deck stiles 4604, and a bottom deck slat 4606. Like with the top deck 4502, the bottom deck rails 4602 and bottom deck stiles 4604 are connected at the corners 4515 of the pallet 4500 to form the frame member joints 4530. The bottom deck slat 4606 extends between the bottom deck rails 4602. The bottom deck slat 4606 is joined to the bottom deck rails 4602 via deck slat joints 4608. In addition, the frame members 4514 have a series of fastener openings 1116 that are used to secure the various frame members 4514 together as well as to the spacer 4516 via fasteners 1118. For instance, the frame members 4514 are made from sheet metal and joined together to form seams that are positioned in a fashion similar to that described above with respect to FIG. 1. As should be recognized, the pallets illustrated in FIGS. 45 and 46 share most of the features in common with that of the pallet 100 illustrated in FIG. 1. Moreover, the pallet 4500 can be manufactured using the similar process as described above. For instance, the pallet can be filled with the concrete fill material 3704 at the corners 4515 using the same techniques as described above. For the sake of clarity as well as brevity, these common features will not be discussed in detail below, but please refer to the previous discussion of the pallet 100 described above. Generally speaking, the unique distinctions between the pallet 100 of FIG. 1 and the pallet of FIG. 5 will be highlighted below.

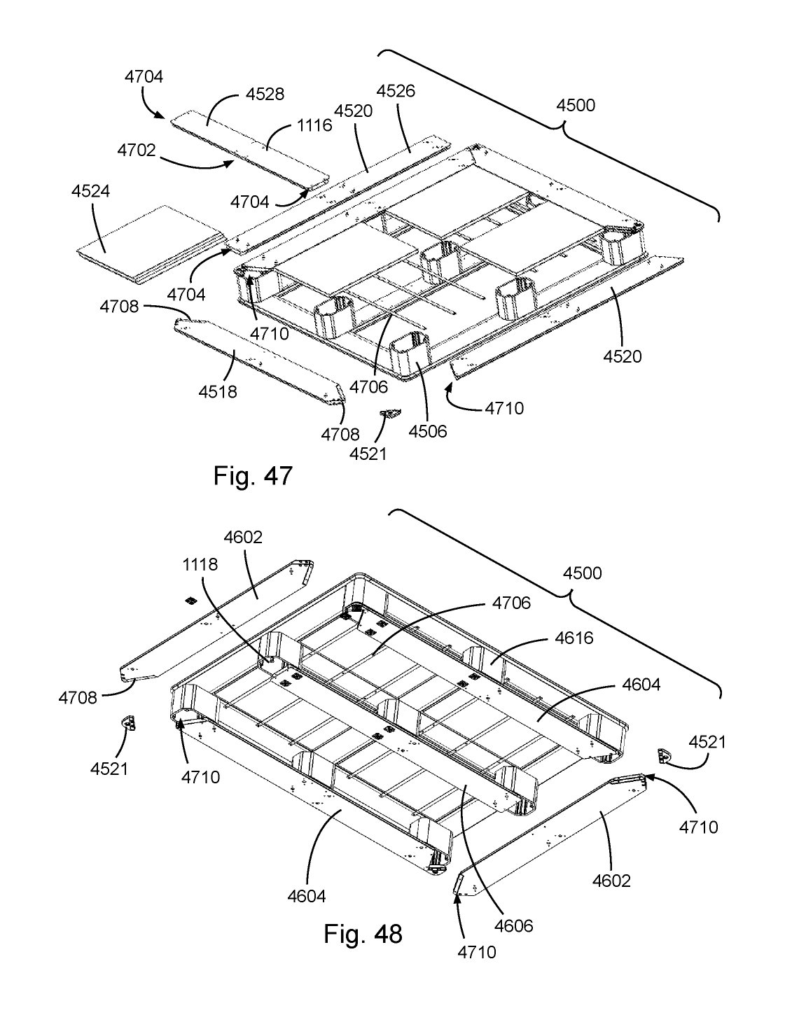

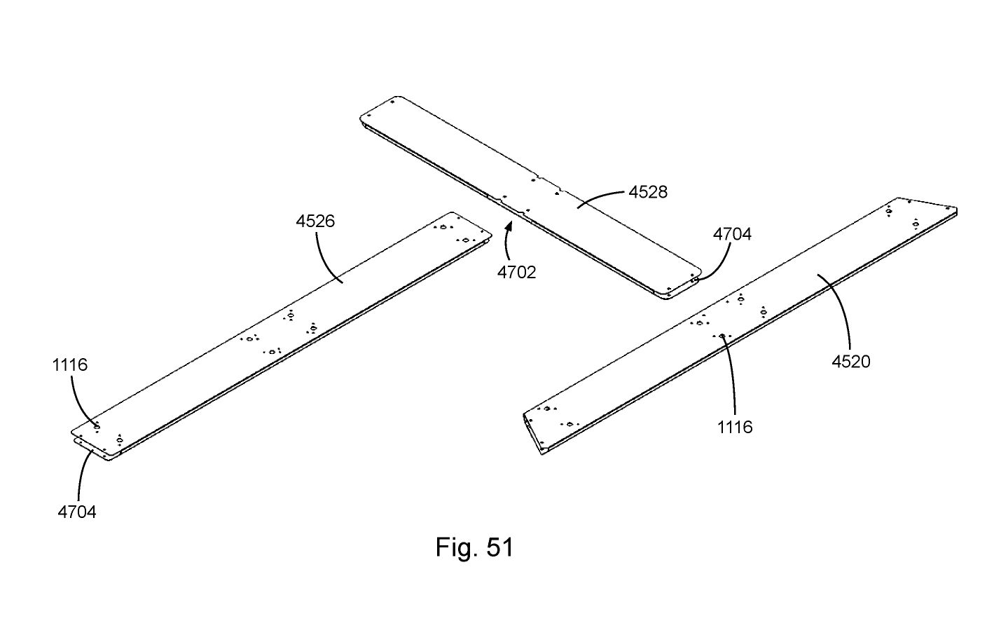

FIG. 47 shows a top exploded perspective view of the pallet 4500, and FIG. 48 shows a bottom perspective partial exploded view of the pallet 4500. As can be seen, the rail muntin 4526 and the stile muntin 4528 are separate components that are joined together to form the muntin structure 4522. In particular, the rail muntin 4526 extends through a rail slat 4702 in the stile muntin 4528 so as to form the cross-shaped pattern. The fasteners are received in the fastener openings 1116 to join the rail muntin 4526 and the stile muntin 4528 to form the cross pattern of the muntin structure 4522. As shown in FIGS. 47 and 51, the ends of both the rail 4526 and stile 4528 muntins have mortise openings 4704 that are formed in a slat fashion to receive the side edges of the corresponding frame member 4514 to which they are attached via fasteners 1118. Unlike the pallet 100 shown in FIG. 1, the pallet 4500 has panel support slats 4706 that extend completely from between the top deck stiles 4520. In particular, the panel supports slats 4706 are fastened to the underside or bottom of the frame numbers 4514. Like in the previous pallet 100, the pallet 4500 uses mortise and tenon type joints at the frame member joints 4530 that are open to allow the free flow of the fill material 3704.

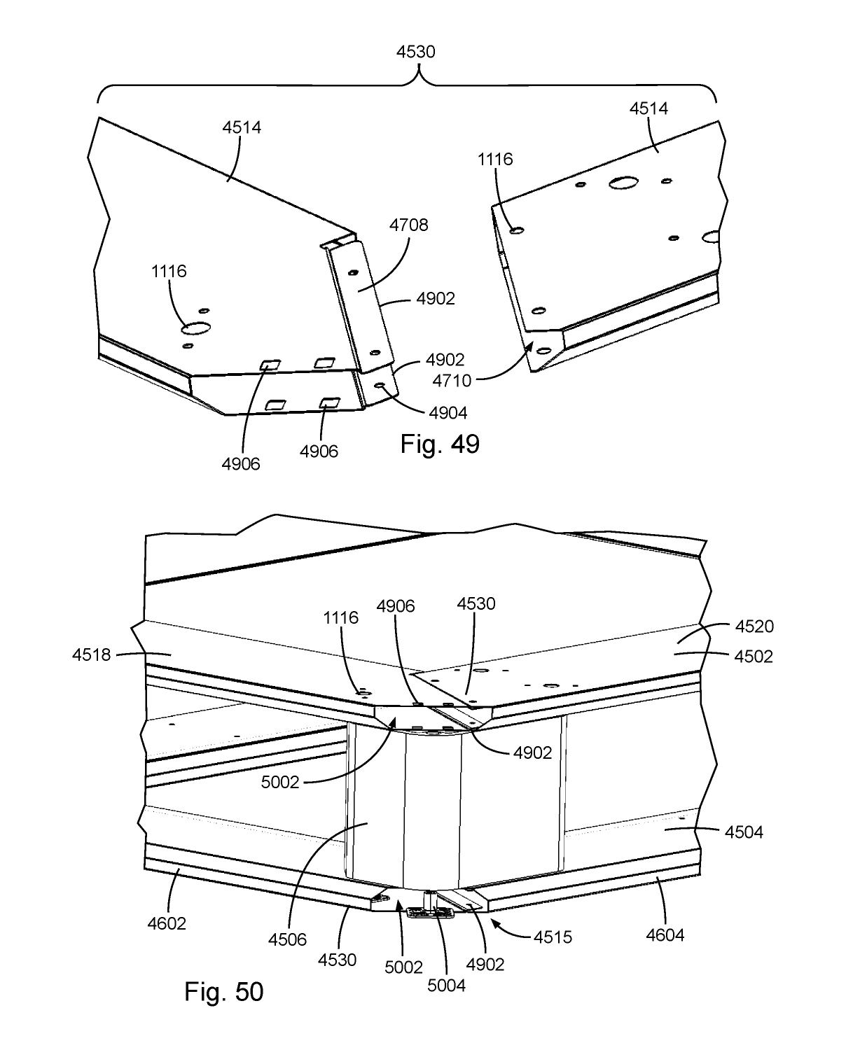

Referring to FIGS. 47, 48, and 49, the frame member joints 4530 are in the form of a mortise and tenon joint. As shown, the rails 4518, 4602 have tenons 4708 that are received in the corresponding mortise openings 4710 of the stiles 4520, 4604. FIG. 49 shows an exploded view of a frame member joint 4530 that can be found in either the top 4502 or bottom 4504 deck. In the illustrated example, a pair of tenon tabs 4902 define a tenon gap 4904 through which the fill material 3704 is able to flow. As shown, the frame members 4514 at the frame member joints 4530 are truncated like in the previous pallet 100. To help facilitate joining the frame members 4514 together, fasteners 1118 are secured into the fastener joints 1116. The frame members 4514 further include cap retention notches 4906 that are used to assist in holding the cap 45452114 in place. Like the previous example, the selected fastener joints 1116 are designed to align with the fastener openings and the spacer blocks 4516 when the joints are assembled. However, some of the fastener openings 1116 may simply be used to join the various frame members 4514 together such as via screws or rivets. FIG. 50 shows an enlarged perspective view of one corner 4515 with the caps 4521 removed such as present during assembly and/or before filling of the frame structure 4508. Again, the corners 4515 at the frame member joints 4530 are truncated to form the fill openings 5002. The fasteners 1118 can be secured through grommets 5004 that have skid pads to prevent unnecessary wear to the pallet 4500. Again, the pallet 4500 can be filled with the concrete fill material 3704 through these fill openings 5002 while the other corners 4515 are capped with the corner caps 4521.

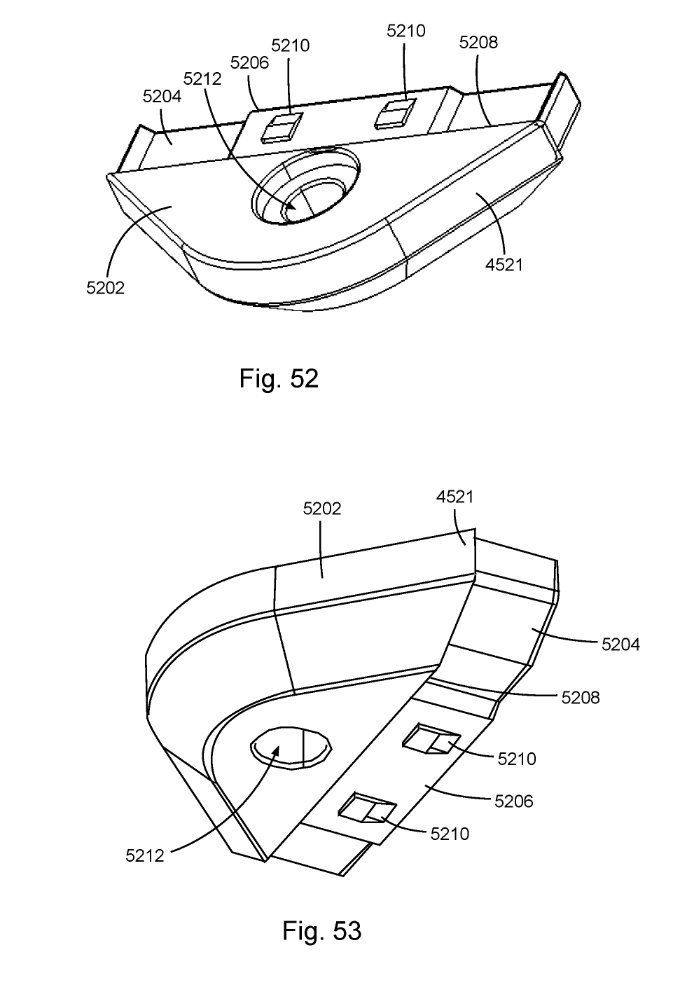

FIGS. 52 and 53 respectively show top and bottom perspective views of the corner cap 4521. The corner cap 4521 shares a number of features in common with the one described with respect to pallet 100 in FIG. 1, but as should be recognized, it is shaped slightly differently. Like before, the corner cap 4521 includes a crown 5202, a body 5204, and a root 5206. The body 5204 is separated from the crown 5202 via a lip or ledge 5208 that provides a smooth, flush surface with the rest of the outside of the pallet 4500. The root 5206 includes one or more lock tabs 5210 that are configured to clip into the cap retention notches 4906 in the frame members 4514. The corner cap 4521 further defines a fastener opening 5212 in which the fastener 1118 is received to secure the corner cap 4521 in place. The fastener opening 4512 in selected examples can also receive the grommet 5004 and can have a counter sink to make sure the fastener 1118 is flush or unable to catch any items. Again, the pallet 4500 can be constructed in the manner as described above. In one example, the top 4502 and bottom 4504 decks are filled with the fill material 3704 in the manner as described above. Alternatively or additionally, some or all or the frame member 4514 in the decks 4502, 4502 can include fiber reinforced ribs 1120 and/or foam ribs 3804 of the type described above (see e.g., FIGS. 37 and 38). The muntin structure 4522 can be filled with the concrete fill material or be empty. Likewise, the blocks 4516 can be unfilled or include other materials such as foam filler material.

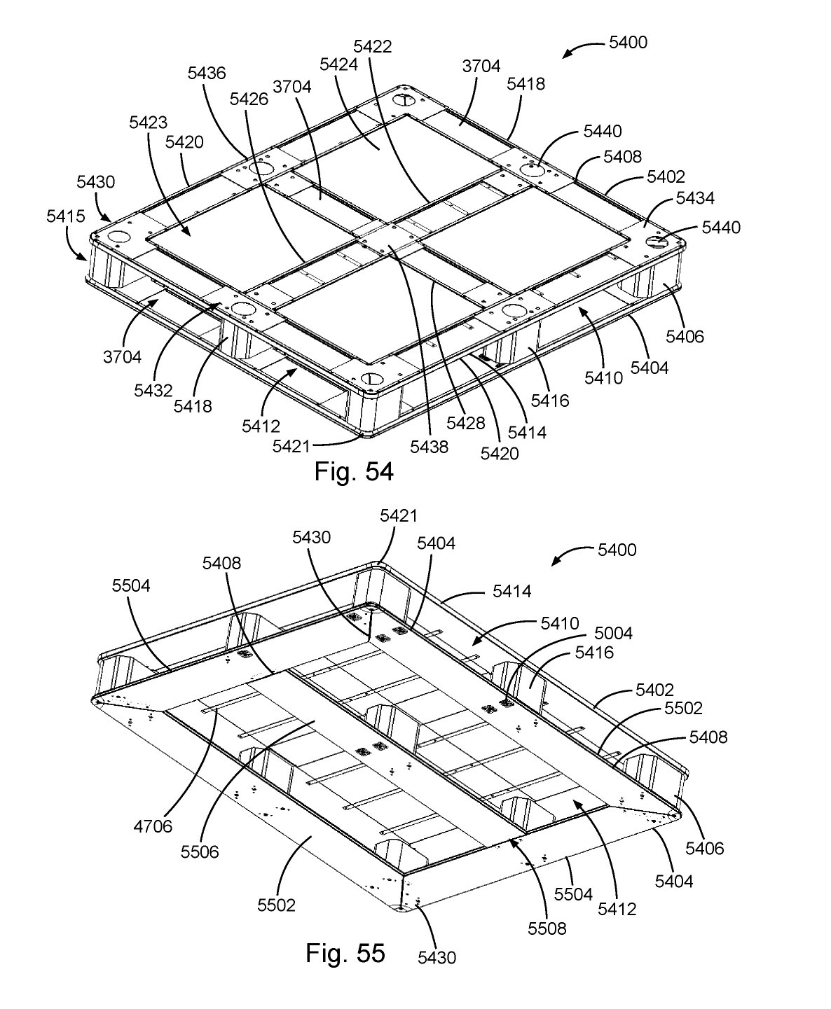

A pallet 5400 according to another example will be initially described with respect to FIGS. 54, 55, and 56. In this example, the pallet 5400 has an open exoskeleton type design in which the cured concrete material is exposed. Like in the other previously-described pallets, the pallet 5400 in FIG. 54 includes a top deck 5402, a bottom deck 5404, and a space or structure 5406 sandwiched between the top deck 5402 and the bottom deck 5404. Together the top deck 5402, bottom deck 5404, and spacer structure 5406 form a frame structure 5408 that forms the outer shell or skeleton of the pallet 5400. The frame structure 5408 of the pallet 5400 defines fork openings 5410 and jack openings 5412. Like in the other examples, the top deck 5402 and the bottom deck 5404 are formed by a series of frame members 5414. The pallet further has corners 5415 where some of the frame members 5414 are joined. The spacer structure 5406 in the illustrated example includes an array of spacer blocks 5416 that are secured in between the top deck 5402 and the bottom deck 5404. The frame members 5414 for the top deck 5402 include a top deck rail 5418 and a top deck stile 5420 that is joined to the top deck rail 5418. As in the previous examples, a corner cap 5421 seals the corners 5415 of the decks 5402, 5404. The frame members 5414 further includes a muntin structure 5422 that defines a series of window openings 5423. Panels 5424 are positioned and supported inside the window openings 5423. The muntin structure 5422 is formed by a first or rail muntin 5426 and a second or stile muntin 5428 that are attached to one another in a cross-shaped pattern. In the illustrated example, the rail 5426 and stile 5428 muntins are separate components joined together, but in other examples the muntin structure 5422 can be an integrated unit. The frame members 5414 at the corners 5415 form a number of frame member joints 5430. The muntin structure 5422 is attached to the top deck rails 5418 and top deck stiles 5420 via muntin joints 5432. The pallet 5400 has an open design in which one side of the fill material 3704 is exposed to the outside environment. In other words, all or some of the fill material 3704 is exposed after being cured. The frame members 5414 of the top deck 5402 and the bottom deck 5404 act as trays in which the concrete composite fill mixture 3704 is poured and cured in a fashion similar to that of an ice cube tray. At the frame member joint 5430, the pallet 5400 includes frame joint braces 5434 that provide additional structural support at the frame member joint 5430. Similarly, muntin joint braces 5436 brace the muntin joints 5432, and a cross brace 5438 braces the joint that is formed between the rail 5426 and stile 5428 muntins. In addition to providing structural support, the braces 5434, 5436, 5438 have fastener openings 1116 for facilitating securing of the spacers 5416 via fasteners 1118. In addition, the frame 5434 and muntin 5436 joint braces define alignment openings 5440 that facilitate alignment during manufacturing and use. The alignment openings 5440 can provide a guide or fill opening for the concrete fill material hose and/or can be used to align the pallets 5400 during stacking.

FIG. 55 shows a bottom perspective view of the pallet 5400. As can be seen, the bottom deck 5404 includes a bottom deck rail 5502 that is joined to a bottom deck stile 5504 at frame member joint 5430. A bottom deck slat 5506 extends in a parallel manner between the bottom deck rails 5502 and are attached to the bottom deck stiles 5504 at bottom deck slat joints 5508. As should be recognized, the pallet 5400 shares a number of features in common with the previously-described examples, and for the sake of brevity as well as clarity, these common features will not be again discussed in great detail below but reference is made to the previous discussion of these features.

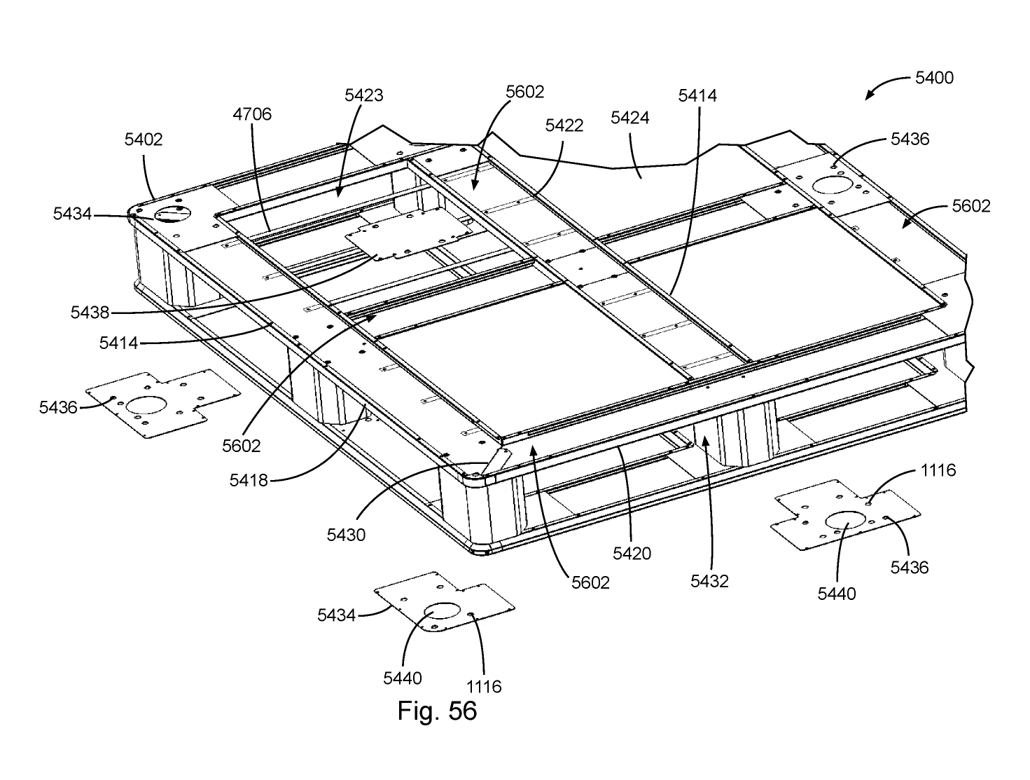

FIG. 56 shows a partial exploded view of the pallet 5400. The frame members 5414 for the top deck 5402 (i.e., top deck rails 5418, top deck stiles 5420, and muntin structure 5422) all define an open fill channel 5602 in which the fill material 3704 is poured and cured. Once cured the concrete fill material 3704 provides the structural support for the pallet 5400. Alternatively or additionally, some or all or the frame member 5414 can include fiber reinforced ribs 1120 and/or foam ribs 3804 of the type described above (see e.g., FIGS. 37 and 38). In one form, the top deck rails 5418 and top deck stiles 5420 are filled with the fill material 3704 and the muntin structure 5422 is empty. In another form, both the muntin structure 5422 and the rails 5418 and stiles 5420 are filled with the fill material 3704. Like in the other designs, some or all of the joints are open to facilitate flowing of the fill material 3704 during manufacturing. For example, as shown, the frame member joint 5430 uses a modified mortise and tenon joint that still forms a fill gap in the form of channel 5602 to allow the fill material 3704 to flow between the top deck rails 5418 and stiles 5420. Again, the braces 5434, 5436, 5438 brace the various joints before, during, or after curing of the fill material 3704.

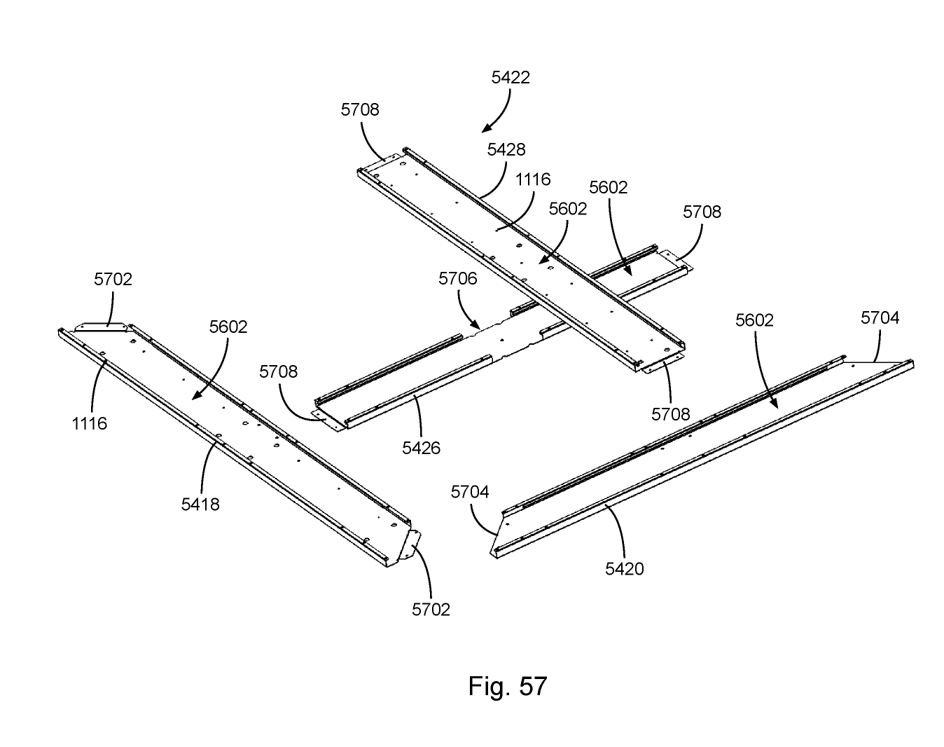

Turning to FIG. 57, the rails for the frame member frame members 5414 have tenon tabs 5702 that are secured in mortise opening 5704 in the stiles. In the illustrated example, the top deck 5418, top deck rail 5418, and the top deck stile 5428 are illustrated as having the tenon tabs 5702 and mortise openings 5704, but it should be recognized that the bottom deck rails 5502 and the bottom deck stiles 5504 are configured in the same fashion. In the illustrated example, each end of the rail 5418 has a single tab, which is unlike the previous examples which had a pair of tabs defining a gap. In this example, the single tab defines a gap that is part of the open fill channels 5602. Once more, the corners are truncated and the corner caps 5421 enclose the corners to minimize leakage of the fill material. Once more, the muntin structure 5422 is formed by attaching the rail 5426 and the stile muntin 5428 in a cross-shaped pattern. A stile notch 5706 is formed in the rail muntin 5426.

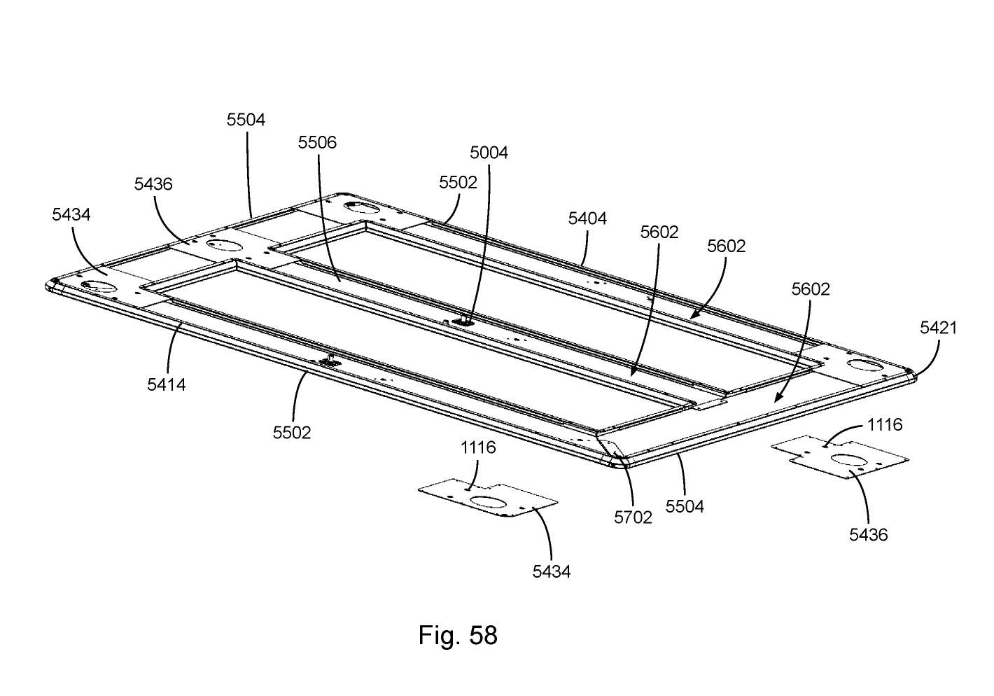

In order to receive the stile muntin 5428. The rail 5426 and stile 5428 muntin are attached together with fasteners via fastener openings 1116 in the manner as described above. Muntin tabs 5708 are secured to their corresponding rails and stiles via fasteners 1118 and fastener openings 1116. FIG. 58 illustrates a partial exploded view of the bottom deck 5404. Again braces 5434 and 5436 are used to brace the various frame members 5414. Like the top deck 5402, the bottom deck 5404 has a series of open fill channels 5602 into which the fill material 3704 is poured and cured. As can be seen, the fill channels are all connected together including the fill channel 5602 for the bottom deck slat 5506. To manufacture the pallet, the fill material 3704 is poured into both the top deck 5402 and the bottom deck 5404. Once secured, the spacer blocks 5416 are secured at the corresponding braces 5434, 5436, 5438 through fastener openings 1116 and fasteners 1118. In the illustrated example, the grommets 5004 of the type described above are also used to provide skid padding for the pallet 5400.

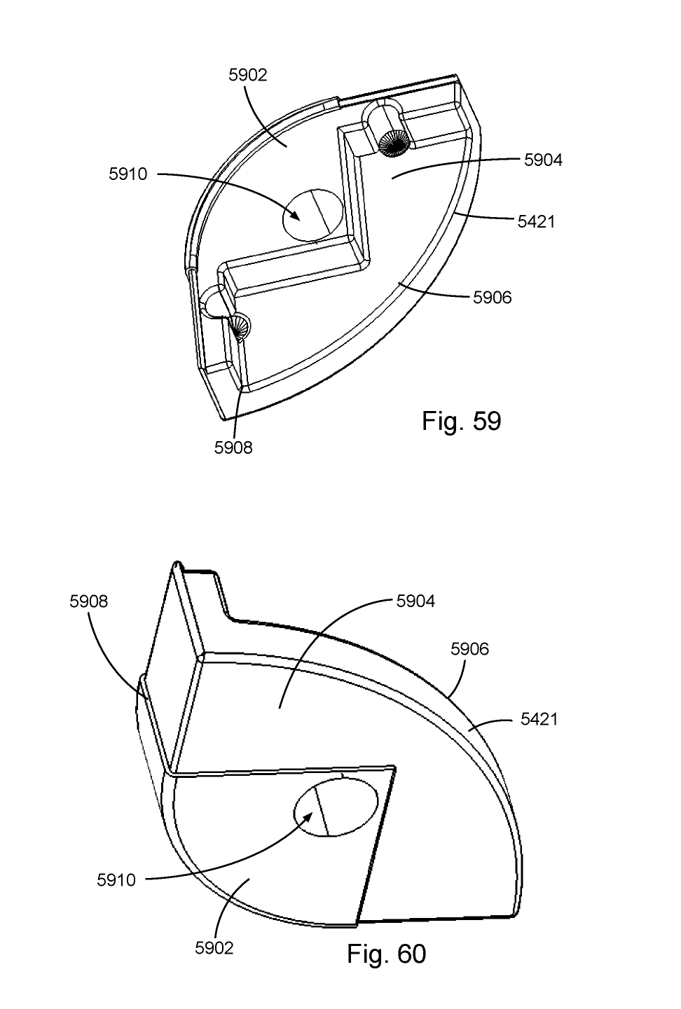

FIGS. 59 and 60 show bottom and top perspective views of the corner cap 5421. Like the previous example, the corner cap 5421 includes a crown 5902, a body 5904 extending from the crown 5902, as well as a root section 5906. A lip or ledge 5908 forms a transition between the crown 5902 and the body 5904. The lip or ledge 5908 provides a means to have the cap 5421 be flush with the rest of the pallet 5400. The cap 5421 further includes a fastener opening 5910 for securing the cap to the frame member joint 5430 and the spacer block 5416.

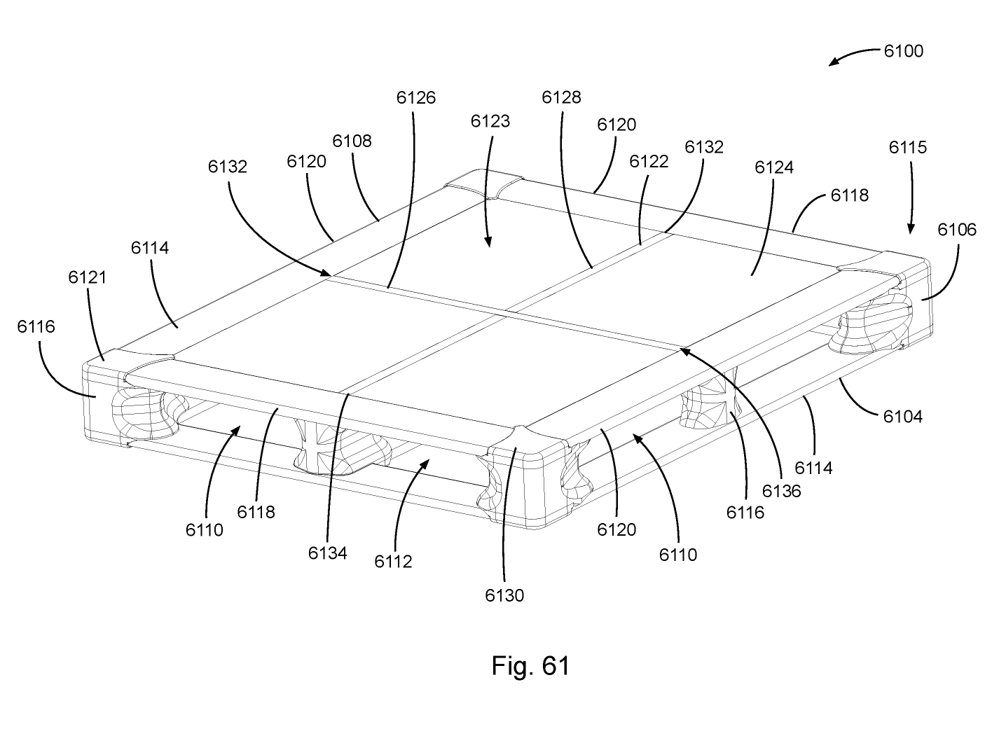

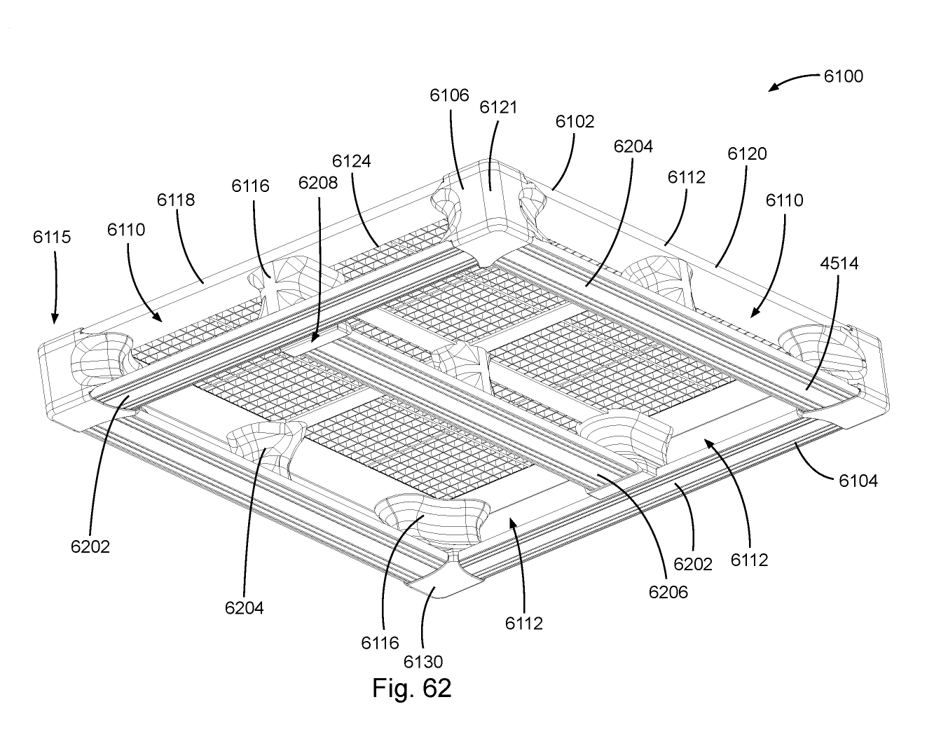

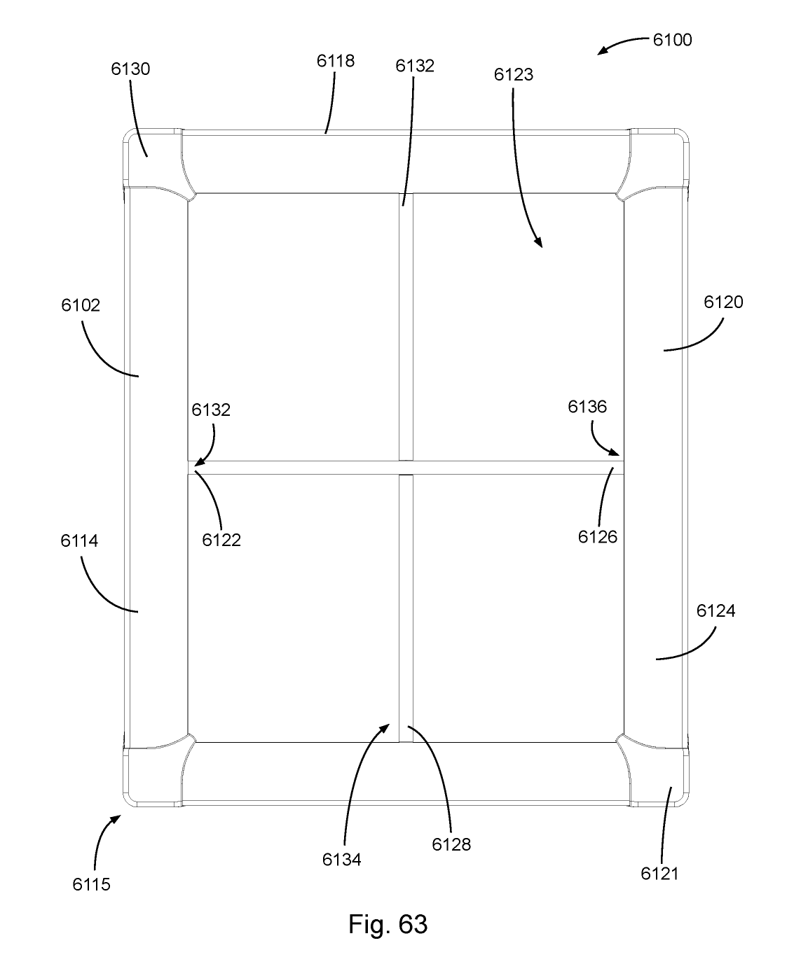

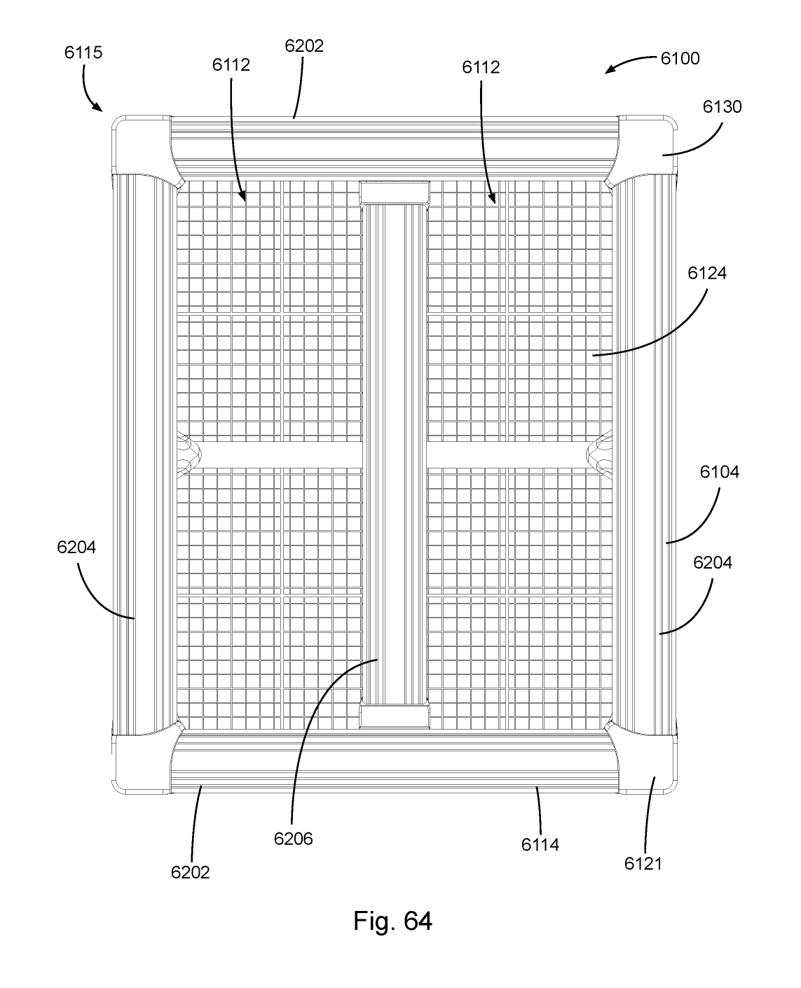

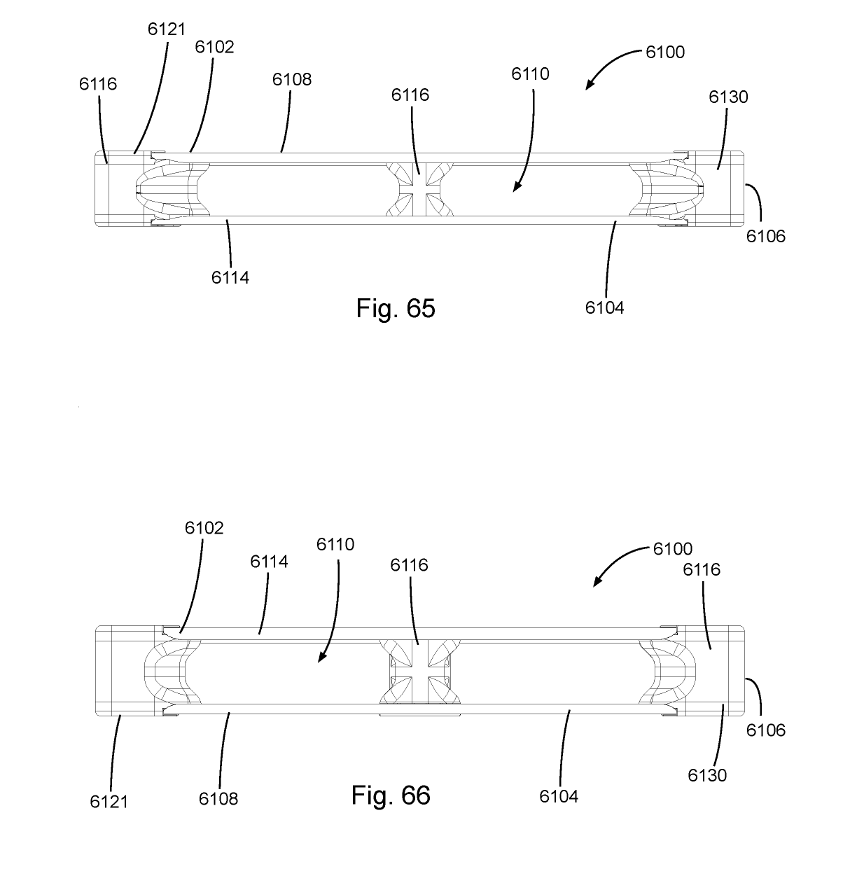

A pallet 6100 according to a further example is illustrated starting at FIG. 61. FIG. 61 shows a top view of the pallet 6100 and FIG. 62 shows a bottom perspective view of the pallet 6100. FIGS. 63 and 64 respectively show top and bottom views of the pallet 6100, and FIGS. 65 and 66 respectively show front and side views of the pallet 6100. Like in the previous examples, the pallets 6100 includes a top deck 6102, a bottom deck 6104, and a spacer structure 6106. The top deck 6102, bottom deck 6104 and spacer structure 6106 form a frame structure 6108 in which the concrete fill material 3704 is enclosed. Like in the previous examples, the pallet 6100 defines one or more fork openings 6110 and jack openings 6112. The top deck 6102 and bottom deck 6104 are formed by a series of frame members 6114 that are interconnected together at various joints. Again, the pallet 6100 includes a series of corners 6115. The spacer structure 6106 is created by one or more spacer blocks 6116 that are sandwiched between the top 6102 and bottom 6104 decks. The top deck 6102 is formed by a pair of top deck rails 6118 that are joined together via top deck stiles 6120. Similar to the previous examples, the corners 6115, where the top deck rails 6118 and top deck stiles 6120 are joined, are enclosed by corner caps 6121. A muntin structure 6122 extends between the frame members 6114 of the top deck 6102 to form one or more window openings 6123. Panels 6124 are supported in the window openings 6123. The muntin structure 6122 in the illustrated example includes a first muntin or mid-rail 6126 that extends transversely to a second muntin or mid-stile 6128 so as to form a cross pattern. The top deck rails 6118 and the top deck stiles 6120 are joined together at frame member joints 6130 which are located at the corners 6115 of the pallet 6100. The muntin structure 6122 is connected to the top deck rails 6118 and the top deck stiles 6120 at muntin joints 6132. As shown, the muntin joints 6132 includes one or more rail muntin joints 6134 and stile muntin joints 6136.

Turning to FIG. 62, the frame members 6114 of the bottom deck 6104 include one or more bottom deck rails 6202, bottom deck stiles 6204, and a bottom deck slat 6206. Like with the top deck 6102, the bottom deck rails 6202 and bottom deck stiles 6204 are connected at the corners 6115 of the pallet 6100 to form the frame member joints 6130. The bottom deck slat 6206 extends between the bottom deck rails 6202. The bottom deck slat 6206 is joined to the bottom deck rails 6202 via deck slat joints 6208. As will be explained below, various components of the pallet 6100 are secured via fasteners 1118. In one example, the frame members 6114 are made from sheet metal and joined together to form seams that are positioned in a fashion similar to that described above with respect to FIG. 1. As should be recognized, the pallets illustrated in FIGS. 61 and 62 share most of the features in common with that of the pallets 100, 4500, 5400 illustrated in FIGS. 1, 45, and 54. Moreover, the pallet 6100 can be manufactured using the similar process as described above. For instance, the pallet can be filled with the concrete fill material 3704 at the corners 6115 using the same techniques as described above. For the sake of clarity as well as brevity, these common features will not be discussed in detail below, but please refer to the previous discussion of the pallets 100, 4500, 5400 described above. Generally speaking, the unique distinctions between the pallets 100, 4500, 5400 described above and the pallet 6100 of FIG. 61 will be highlighted below.

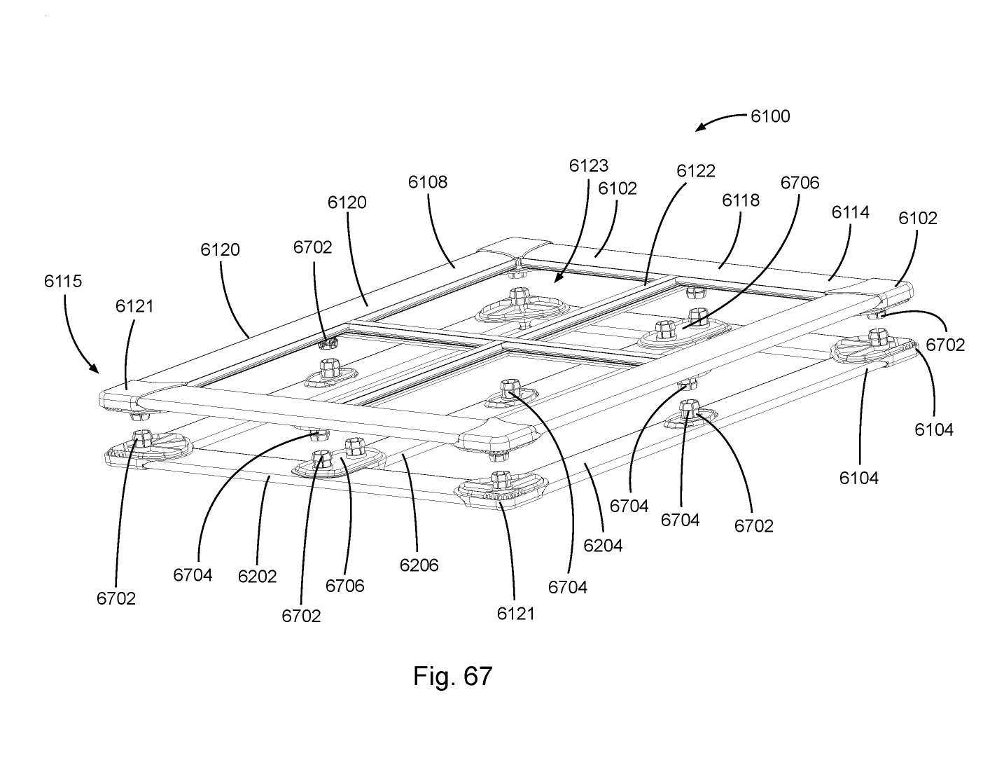

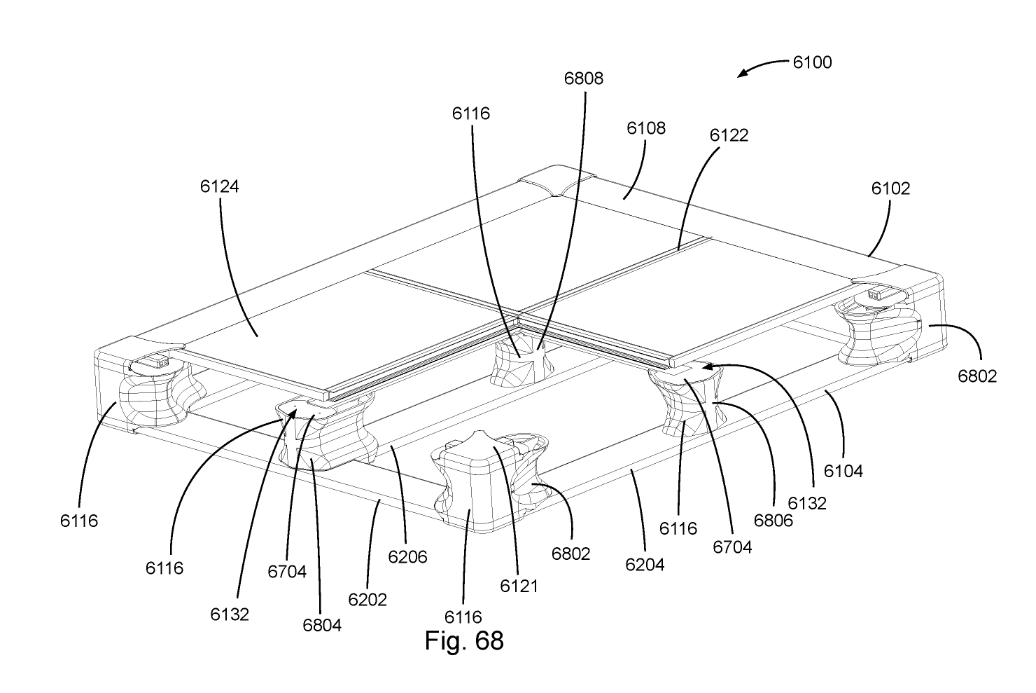

Among other things, the pallet 6100 is designed to be manufactured quickly and inexpensively. The modular design of the pallet 6100 allows the pallet 6100 to be quickly reconfigured during assembly. Turning to FIG. 67, the corner cap 6121 connects the frame members 6114 together at the corners 6115 to form the top deck 6102 and the bottom deck 6104. The pallet 6100 includes one or more snap-fit connectors 6702 that connect the top deck 6102 to the bottom deck 6104 through the spacer blocks 6116. In the illustrated example, part of the snap-fit connectors 6702 are incorporated into the corner cap 6121. As shown, the pallet 6100 further includes one or more mid-spacer connectors 6704 and slat caps 6706 with snap-fit connectors 6702. During manufacturing, the top deck 6102 and bottom deck 6104 can be assembled independently of one another. Once assembled, the top deck 6102 and bottom deck 6104 can be snapped together through the snap-fit connectors 6702 snap connecting to the spacer structure 6106 with the spacer blocks 6116 sandwiched in between. As shown in FIG. 68, the spacer blocks 6116 for the spacer structure 6106 include one or more corner spacers 6802, rail spacers 6804, and stile spacers 6806. At the center of the muntin structure 6122, the spacer blocks 6116 further include a muntin spacer 6808 that supports that muntin structure 6122. With this type of snap-fit construction, other variations of the pallet 6100 can be created. For example, a top deck 6102 can be connected to another top deck 6102 to form another pallet design. In another example, a bottom deck 6104 can be snap connected to another bottom deck 6104 with the spacer blocks 6116 to form an alternative design. Alternatively or additionally, other decks with different designs and/or constructions can be readily snap fitted together.

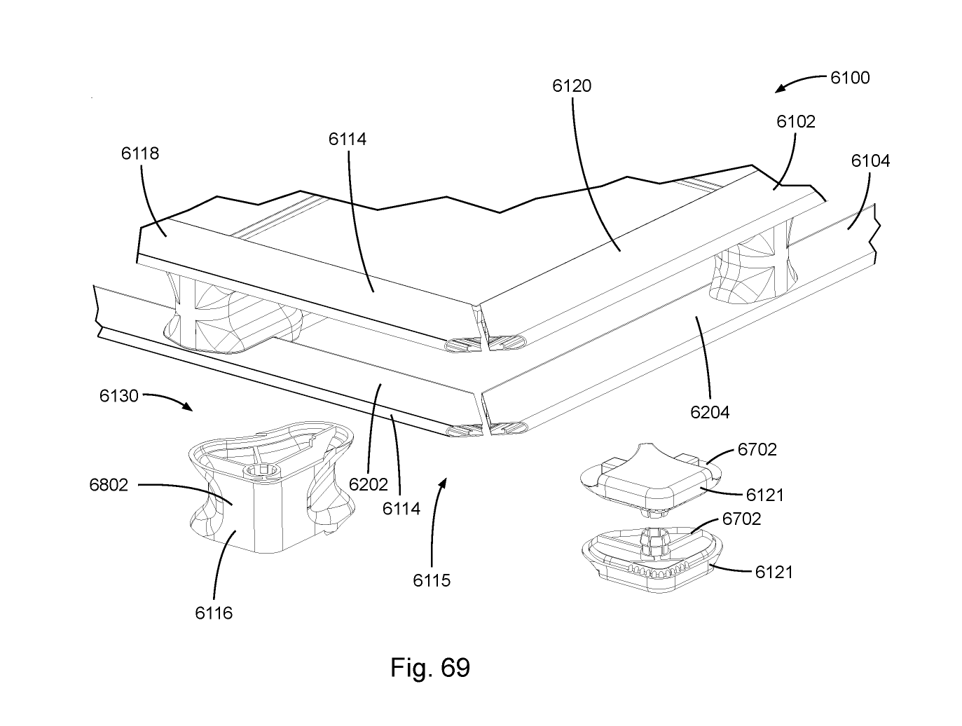

FIG. 69 shows an exploded view of the frame member joints 6130 formed at the corners 6115 of the frame members 6114. As noted before, the corner cap 6121 is used to secure the frame members 6114 at the corners 6115. For instance, the corner cap 6121 at each of the corners 6115 in the top deck 6102 joins each of the top deck rails 6118 and top deck stiles 6120 together. At the corners 6115 of the bottom deck 6104, the corner cap 6121 secures each of the bottom deck rails 6202 and bottom deck stiles 6204 together. Through the snap-fit connectors 6702 formed at least in part on each corner cap 6121, the top deck 6102, bottom deck 6104 are then snap-fitted together via the frame structure 6108. This snap fitting can occur before, during, or after filling and/or curing of the fill material 3704 (e.g., concrete, ECC, etc.).

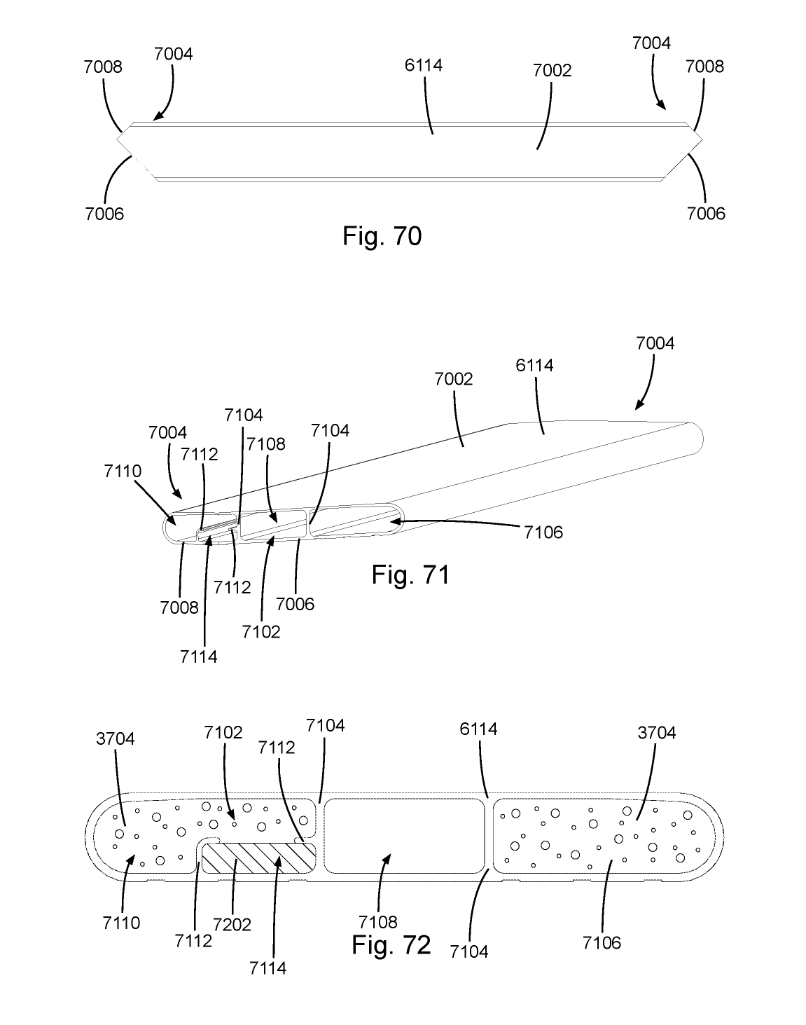

As noted before, the frame members 6114 include the top deck rails 6118, top deck stiles 6120, bottom deck rails 6202, and bottom deck stiles 6204. The general features of each of these frame members 6114 will now be described with reference to FIGS. 70, 71, and 72. The frame members 6114 can be created in a number of manners. For example, sheet metal, such as aluminum or steel can be roll-formed, press-formed, and/or extruded to form the exterior of the frame members 6114. As shown, each of the frame members 6114 includes a shell 7002 that is made of metal, such as aluminum and/or steel. At corner cap ends 7004, the frame members 6114 have a miter edge 7006 and cap engagement edge 7008. Referring to FIG. 71, the shell 7002 forms one or more fill cavities 7102. One or more divider walls 7104 inside the shell 7002 define multiple fill cavities 7102. In the illustrated example, the fill cavities 7102 include an interior fill cavity 7106, an intermediate fill cavity 7108, and an exterior fill cavity 7110. As shown, the intermediate fill cavity 7108 is disposed between the interior fill cavity 7106 and the exterior fill cavity 7110. The exterior fill cavity 7110 has one or more rib engagement flanges 7112 that define a support rib channel 7114. During manufacturing of the pallet 6100, some or all of the fill cavities 7102 are filled with the fill material 3704, such as concrete, ECC, fiber reinforced material, polystyrene foam, and/or FRC of the type described herein. In the example shown in FIG. 72, the interior fill cavity 7106 and exterior fill cavity 7110 are filled with fill material 3704 and the intermediate fill cavity 7108 remains empty (i.e., not filled with fill material 3704). While not certain, it is thought that having the interior fill cavity 7106 and exterior fill cavity 7110 filled with the fill material 3704 allows the frame members 6114 to be strong, and having the intermediate fill cavity 7108 empty reduces the weight of the pallet 6100 without significantly impacting overall strength and durability of the pallet 6100. To further strengthen the frame members 6114, a support rib 7202 is received in the support rib channel 7114. In other examples, the support rib channel 7114 may not have the support rib 7202, but instead, the support rib channel 7114 is filled with the fill material 3704.

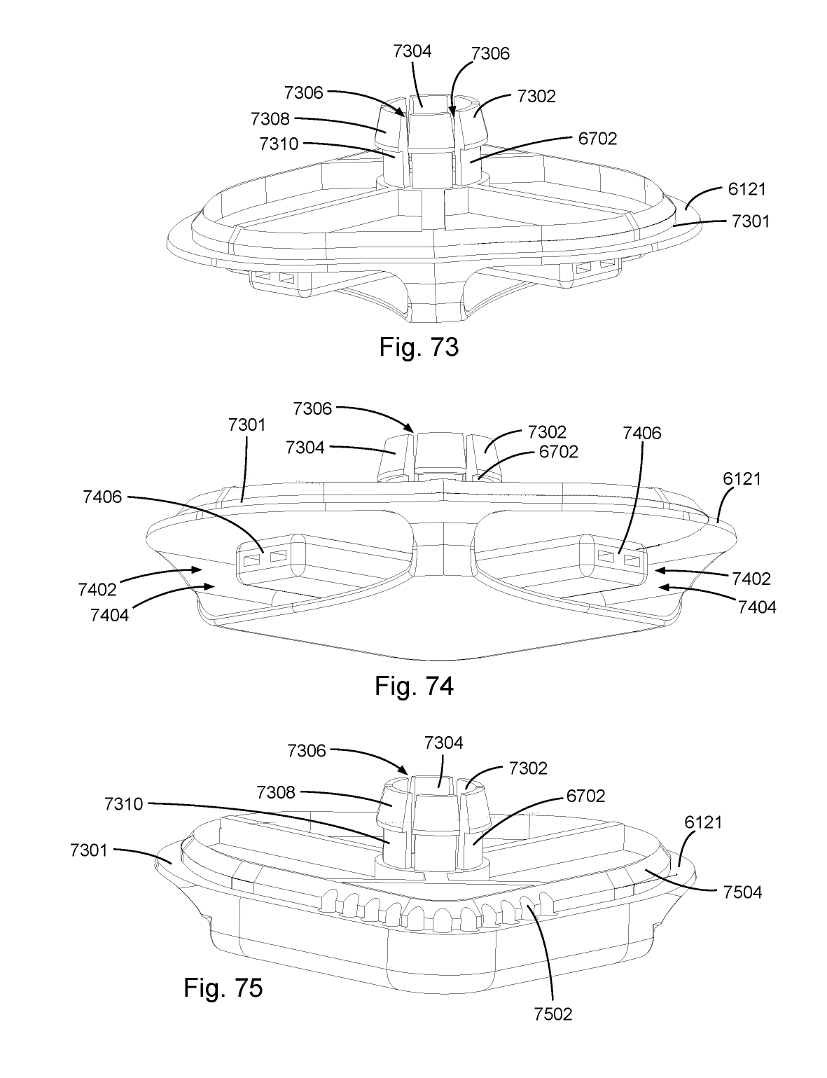

Referring to FIGS. 73, 74, and 75, the corner cap 6121 once more is configured to connect the frame members 6114 together as well as connect to the corner spacers 6802 through the snap-fit connectors 6702. As shown in FIG. 73, the snap-fit connectors 6702 in the illustrated example are in the form of a discontinuous annular snap joint connector, but in other examples, other types of snap connectors can be used. In the depicted example, the snap-fit connectors 6702 include a base 7301 and a connector protrusion 7302 extending from the base 7301 with one or more cantilever lugs 7304 generally arranged in a circle. The cantilever lugs 7304 are separated by slits 7306. Each of the cantilever lugs 7304 has a snap head 7308 with an undercut notch 7310. Turning to FIG. 74, the corner cap 6121 further has one or more frame sockets 7402 in the base 7301 where the frame members 6114 are secured. In the illustrated example, the corner cap 6121 has two (2) frame sockets 7402 that extend generally perpendicular to one another. In other examples, the corner cap 6121 can include more or less frame sockets 7402 than is shown, and the frame sockets 7402 can be oriented at other angles. Each of the frame sockets 7402 includes a socket cavity 7404 in which the frame members 6114 are received. Inside the socket cavity 7404, the corner cap 6121 has a frame plug 7406 that is configured to extend inside the frame members 6114. In the illustrated example, the frame plug 7406 is configured to extend inside and/or plug the intermediate fill cavity 7108 in the frame members 6114, but in other examples, the frame plug 7406 can plug other fill cavities 7102 in the frame members 6114. Looking at FIG. 75, the corner cap 6121 further has one or more engagement teeth 7502 that are configured to deform and secure the corner cap 6121 to the corner spacers 6802. The corner cap 6121 also includes a spacer flange 7504 that is configured to be received in the corner spacers 6802 so as to minimize rotation.

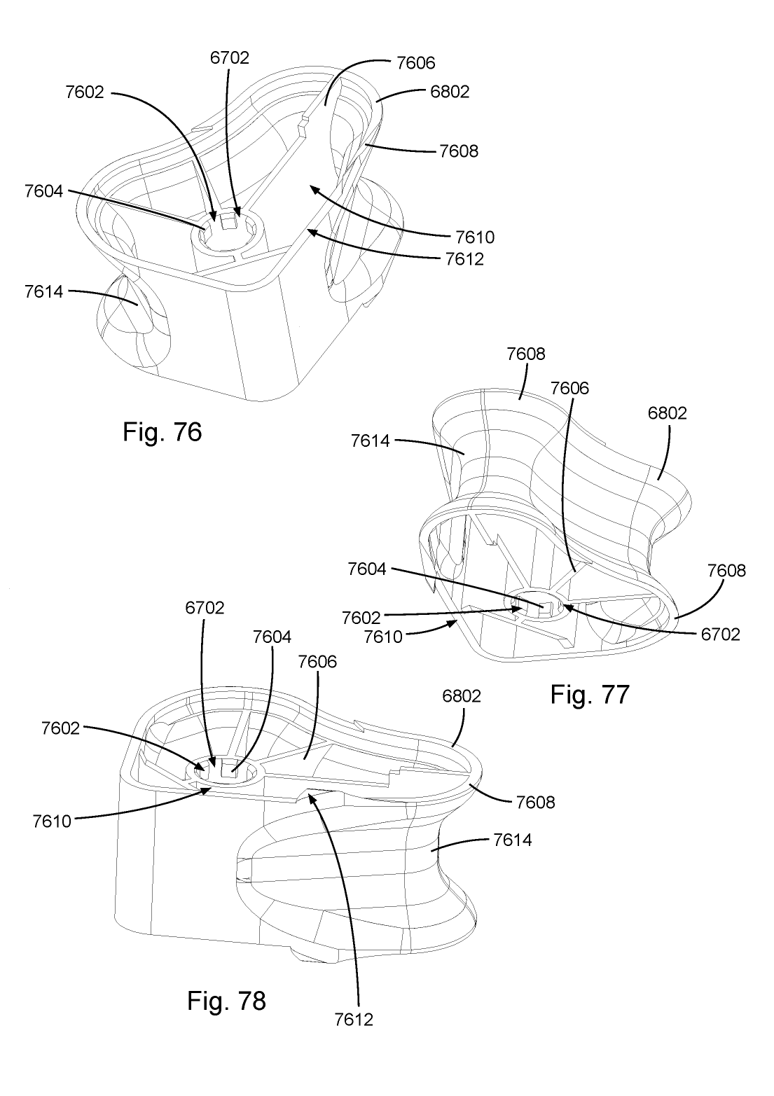

The corner spacers 6802 will now be described with reference to FIGS. 76, 77, and 78. The corner spacers 6802 form part of the snap-fit connectors 6702 with the corresponding corner cap 6121. At the ends of each corner spacers 6802, the snap-fit connectors 6702 includes a connector socket 7602 with one or more socket lugs 7604 configured to engage the cantilever lugs 7304 on the corner cap 6121. Together, the connector socket 7602 of the corner spacers 6802 and the connector protrusion 7302 of the corner cap 6121 form the snap-fit connectors 6702. As shown, the corner spacers 6802 further have one or more spacer ribs 7606 that provide structural support as well as reduce the overall weight of the corner spacers 6802. The corner spacers 6802 further include one or more cap engagement edges 7608 that surround a cap cavity 7610 in which the spacer flange 7504 of the corner cap 6121 is received. The cap engagement edges 7608 have one or more cap alignment notches 7612 that align the corner cap 6121 with the corner spacers 6802. The corner spacers 6802 further have a fork engagement surface 7614 that guides the forks in the fork openings 6110. In the depicted example, the fork engagement surface 7614 has an hourglass shape.

In one example, the spacer blocks 6116 and corner cap 6121 are made of injection molded plastic. Alternatively or additionally, the spacer blocks 6116 and corner cap 6121 can be made in other ways and with other materials such as composite materials like fiberglass. During assembly, the fill material 3704 is poured into the interior fill cavity 7106 and exterior fill cavity 7110, and the corner cap ends 7004 of the appropriate frame members 6114 are inserted into the frame sockets 7402 of the corner cap 6121. As noted previously, the frame plug 7406 in one example is inserted into the intermediate fill cavity 7108 of the frame members 6114 to stabilize and strengthen the connection. The fill material 3704 in the fill cavities 7102 can partially pour out of the fill cavities 7102 of the frame members 6114 to partially fill the socket cavity 7404 in the corner cap 6121. Once cured in the frame sockets 7402, the fill material 3704 helps to secure the corner cap 6121 to the frame members 6114. The frame plug 7406 of the corner cap 6121 also provides a friction fit in the intermediate fill cavity 7108 of the frame members 6114 that helps to secure the frame members 6114 to the corner cap 6121. Alternatively or additionally, at least one fastener 1118 can be fastened through the frame members 6114 and the frame plug 7406 (or elsewhere) on the corner cap 6121 to secure the frame members 6114 to the corner cap 6121. Before, during, or after the fill material 3704 is cured, the connector protrusion 7302 of the corner cap 6121 is snapped into the connector socket 7602 of the corner spacers 6802 to secure the top deck 6102 and bottom deck 6104 together. When snapped together, the spacer flange 7504 of the corner cap 6121 is received in the cap cavity 7610, and the cap alignment notches 7612 minimize rotation of the corner cap 6121 relative to the corner spacers 6802.

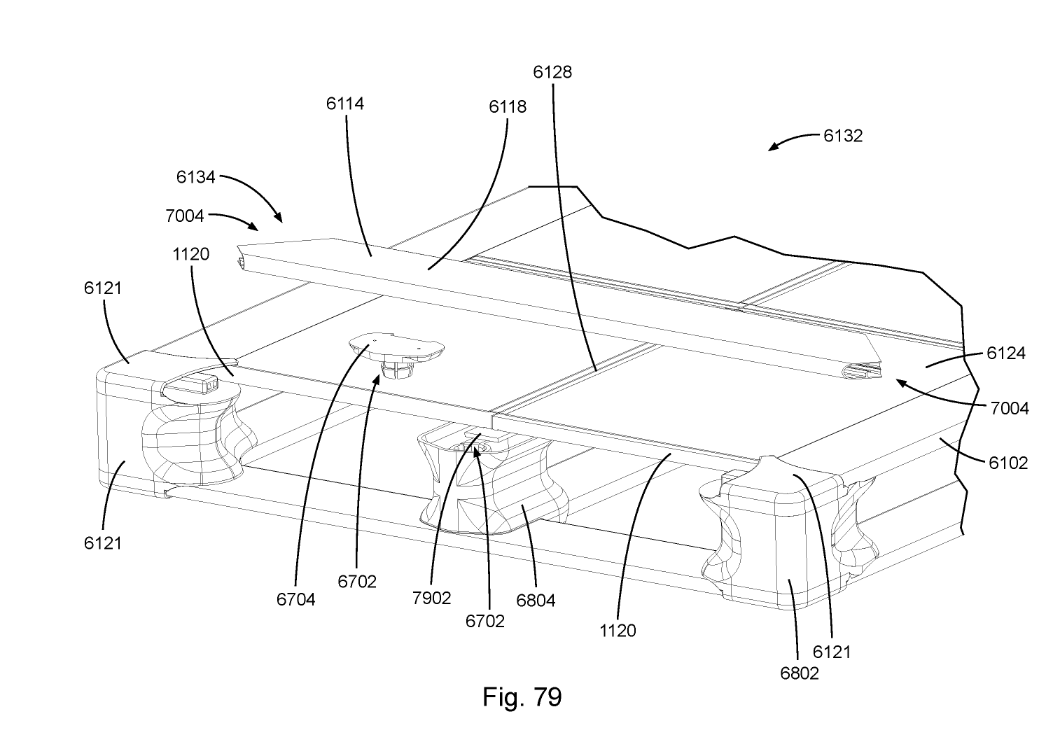

FIG. 79 shows an exploded view of one of the muntin joints 6132, and particularly, the rail muntin joint 6134. As illustrated, the corner cap ends 7004 are connected to the corner cap 6121 in the manner as described before. One or more fiber reinforcing ribs 1120 span between the corner cap 6121 and the rail spacers 6804. At the rail spacers 6804, the ends of the fiber reinforcing ribs 1120 rest on a muntin support rib 7902 which also supports the mid-stile 6128 of the muntin structure 6122 and the panels 6124. In one example, the muntin support rib 7902 is made of fiberglass, but the muntin support rib 7902 can be made of other materials, such as metal, plastic, wood, and the like. Via snap-fit connectors 6702, the mid-spacer connectors 6704 are connected to the rail spacers 6804. Among other things the mid-spacer connectors 6704 support the top deck rails 6118 and the muntin support rib 7902. In one form, the mid-spacer connectors 6704 are secured to the top deck rails 6118 via fasteners, such as screws, but in other variations, the mid-spacer connectors 6704 can be secured to the top deck rails 6118 in other ways like with adhesives.

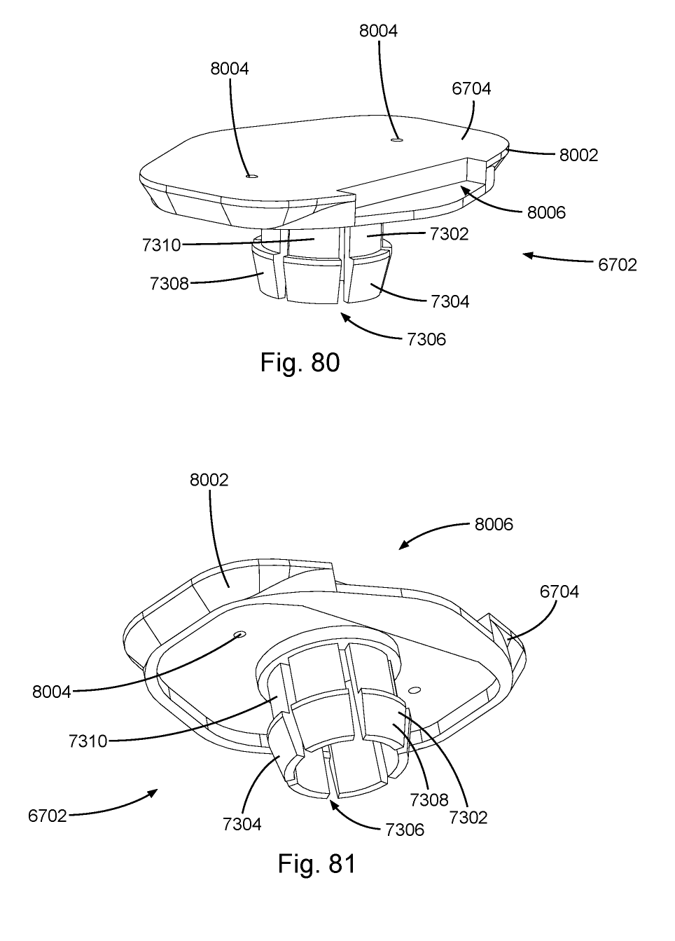

Looking at FIGS. 80 and 81, the mid-spacer connectors 6704 are configured to connect the frame members 6114 together as well as connect to the rail spacers 6804 through the snap-fit connectors 6702. The snap-fit connectors 6702 for the mid-spacer connectors 6704 and the rail spacers 6804 are configured in the same manner as in the previously described example. Once more, the snap-fit connectors 6702 in the illustrated example are in the form of a discontinuous annular snap joint connector, but in other examples, other types of snap connectors can be used. In the depicted example, the snap-fit connectors 6702 include a base 8002 and a connector protrusion 7302 extending from the base 8002 with one or more cantilever lugs 7304 generally arranged in a circle with connector protrusion 7302 in between. Like before, the cantilever lugs 7304 are separated by slits 7306. Each of the cantilever lugs 7304 has a snap head 7308 with a undercut notch 7310. The base 8002 has at least one fastener opening 8004 in which fasteners secure the mid-spacer connectors 6704 to the frame members 6114. As shown, the base 8002 further has a muntin support notch 8006 in which the muntin support rib 7902 is received to support the mid-stile 6128. The base 8002 further supports the corners of the panels 6124.

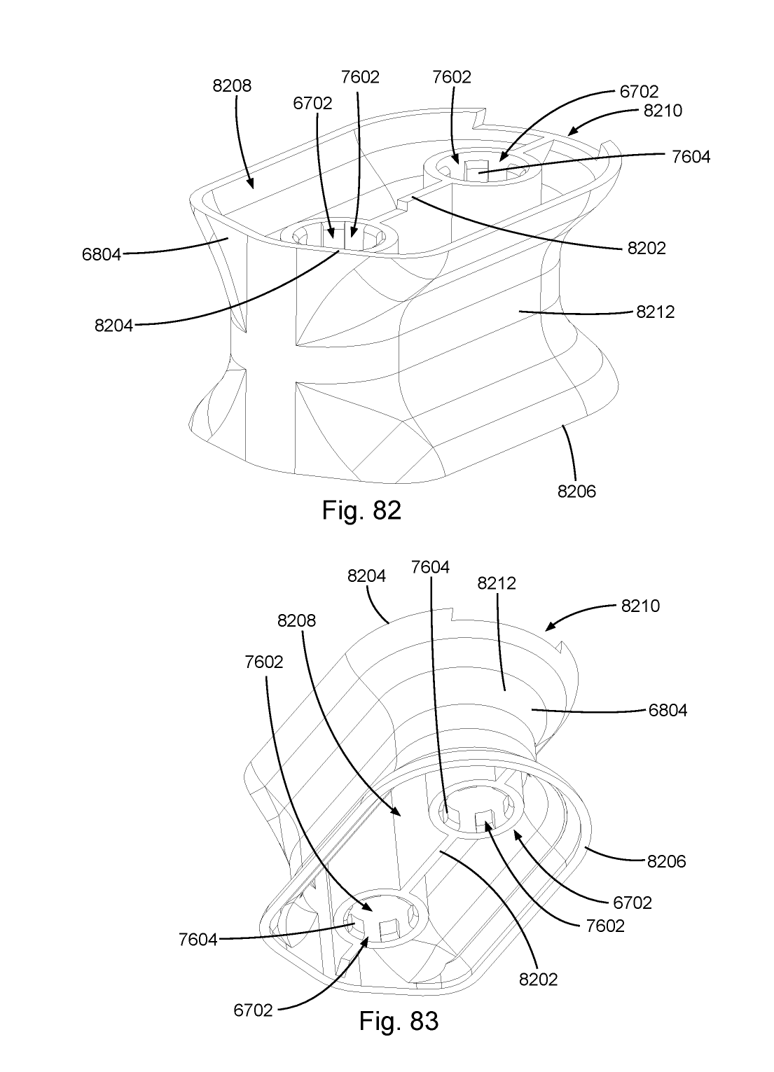

Top and bottom perspective views of the rail spacers 6804 are shown in FIGS. 82 and 83. The corner spacers 6802 form part of the snap-fit connectors 6702 with the mid-spacer connectors 6704. At the ends of each of the rail spacers 6804, the snap-fit connectors 6702 include the connector socket 7602 with one or more socket lugs 7604 configured to engage the cantilever lugs 7304 on the corner cap 6121. Together, the connector socket 7602 of the corner spacers 6802 and the connector protrusion 7302 of the 61212 form the snap-fit connectors 6702. In the illustrated example, the rail spacers 6804 include two (2) connector socket 7602, but in other examples, the rail spacers 6804 can have more or less. As shown, the rail spacers 6804 further have one or more spacer ribs 8202 that provide structural support as well as reduce the overall weight of the rail spacers 6804. The rail spacers 6804 further include a top deck engagement edge 8204 and bottom deck engagement edge 8206 that surrounds a cap cavity 8208 in which the mid-spacer connectors 6704 and slat caps 6706 are respectively received. The top deck engagement edge 8204 has a muntin notch 8210 that receives the muntin support rib 7902. The rail spacers 6804 further has a fork engagement surface 8212 that guides the forks in the fork openings 6110. In the depicted example, the fork engagement surface 8212 has an hourglass shape.

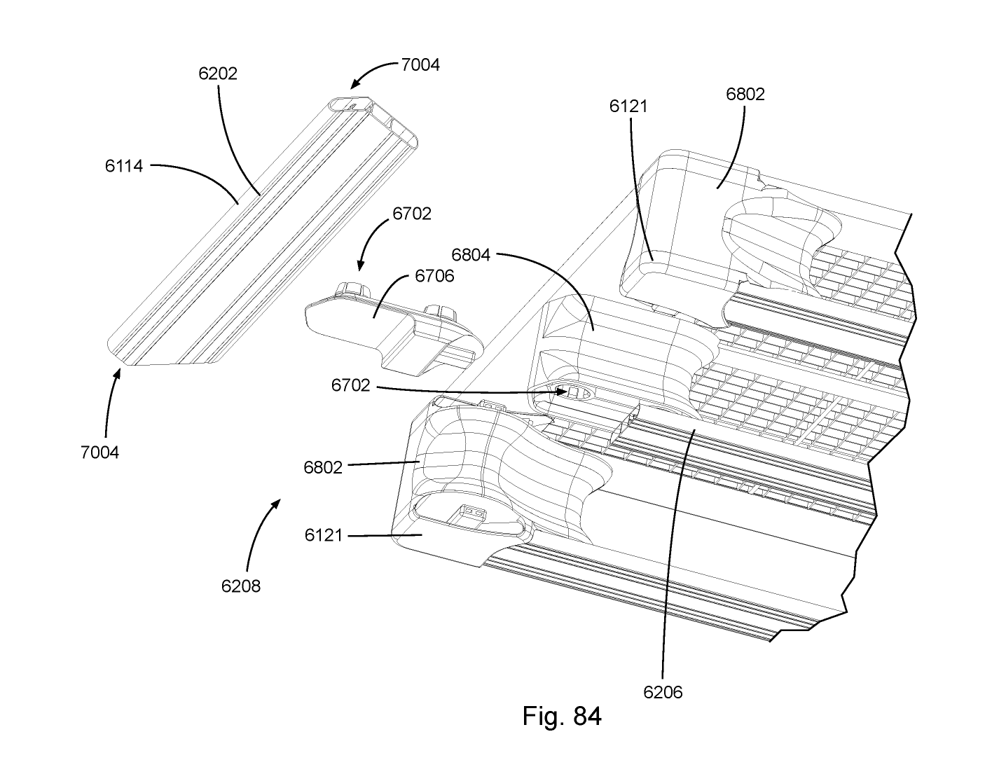

FIG. 84 shows an exploded view of one of the slat joint 6208. As illustrated, the corner cap ends 7004 of the bottom deck rails 6202 are connected to the corner cap 6121 in the manner as described before. The slat caps 6706 rest on the bottom deck rails 6202, and the slat caps 6706 are connected to the end of the bottom deck slat 6206. The slat caps 6706 are connected to the rail spacers 6804 via one or more snap-fit connectors 6702.

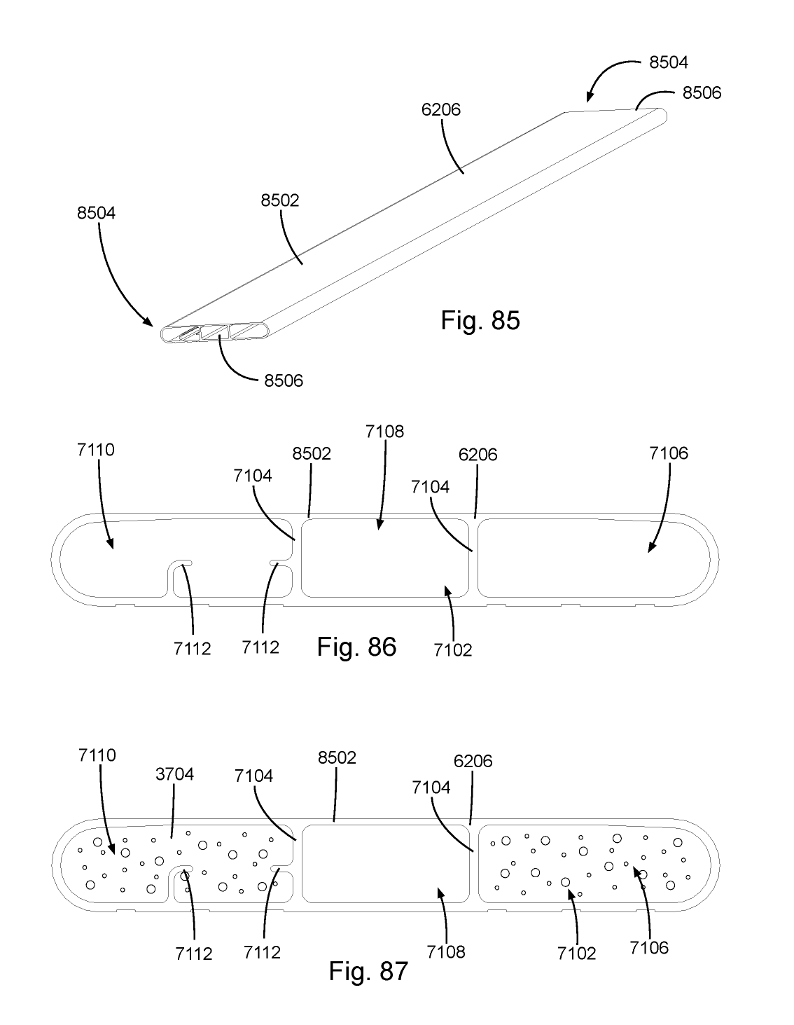

Turning to FIGS. 85, 86, and 87, the bottom deck slat 6206 is manufactured in a fashion similar to the other frame members 6114 with the exception of how their respective ends are formed. Like with the other frame members 6114 described before, the bottom deck slat 6206 can be created in a number of manners. For example, sheet metal, such as aluminum or steel can be roll-formed, press-formed, and/or extruded to form the exterior of the bottom deck slat 6206. As shown, each of the bottom deck slat 6206 includes a shell 8502 that is made of metal, such as aluminum and/or steel. At slat ends 8504, the slat joint 6208 has slat edges 8506 that are flat. The frame members 6114 and bottom deck slat 6206 are formed in the same process, but the slat edges 8506 in the bottom deck slat 6206 are stamped to be straight rather than angled in the other frame members 6114. The interiors of the frame members 6114 and the bottom deck slat 6206 in the illustrated example are the same, but in other examples, the interiors can be different. Referring to FIG. 86, the shell 8502 forms one or more fill cavities 7102. One or more divider walls 7104 inside the shell 8502 define multiple fill cavities 7102. In the illustrated example, like before, the fill cavities 7102 include the interior fill cavity 7106, the intermediate fill cavity 7108, and the exterior fill cavity 7110. As shown, the intermediate fill cavity 7108 is disposed between the interior fill cavity 7106 and the exterior fill cavity 7110. The exterior fill cavity 7110 has one or more rib engagement flanges 7112 that define a support rib channel 7114. During manufacturing of the bottom deck slat 6206, some or all of the fill cavities 7102 are filled with the fill material 3704, such as concrete, ECC, fiber reinforced material, polystyrene foam, and/or FRC of the type described herein. In the example shown in FIG. 87, the interior fill cavity 7106 and exterior fill cavity 7110 are filled with the fill material 3704 and the intermediate fill cavity 7108 remains empty (i.e., not filled with fill material 3704). While not certain, it is thought that having the interior fill cavity 7106 and exterior fill cavity 7110 filled with the fill material 3704 allows the bottom deck slat 6206 to be strong, and having the intermediate fill cavity 7108 empty reduces the weight of the pallet 6100 without significantly impacting overall strength and durability of the pallet 6100. In the illustrated example, the support rib channel 7114 is filled with the fill material 3704. To further strengthen the frame members 6114, the support rib 7202 can be received in the support rib channel 7114 such as in the manner illustrated in FIG. 72.

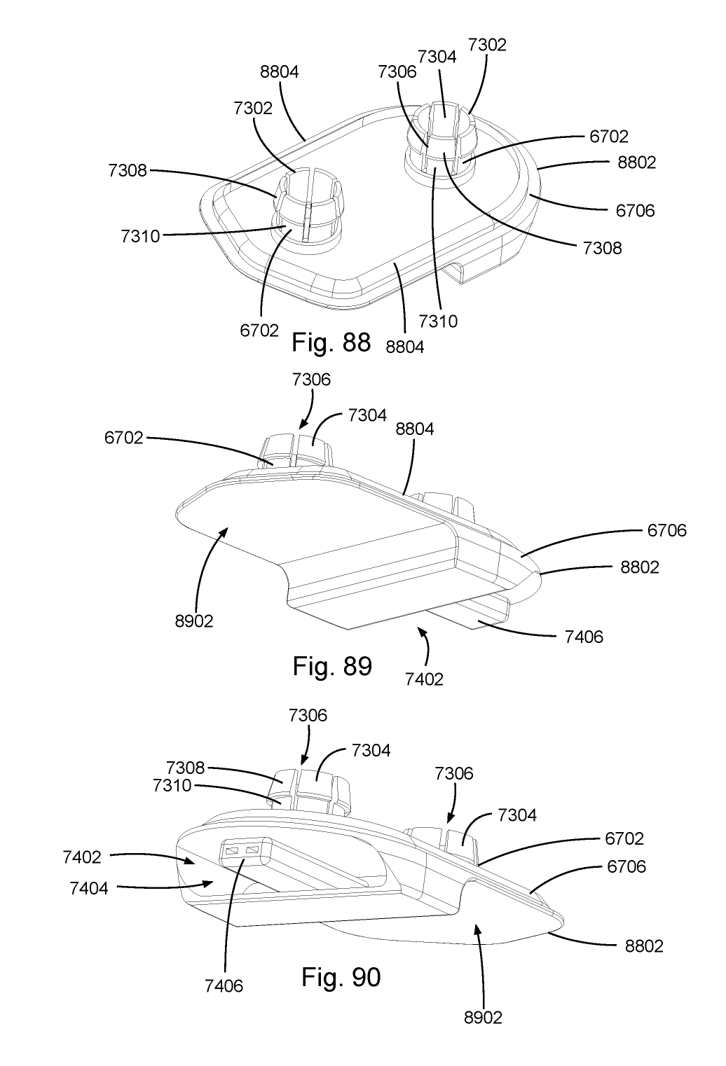

Referring to FIGS. 88, 89, and 90, the slat caps 6706 once more are configured to connect the bottom deck slat 6206 to the rail spacers 6804. As shown in FIG. 88, like before, the snap-fit connectors 6702 in the illustrated example are in the form of a discontinuous annular snap joint connector, but in other examples, other types of snap connectors can be used. In the depicted example, the snap-fit connectors 6702 include a base 8802 and a connector protrusion 7302 extending from the base 8802 with one or more cantilever lugs 7304 generally arranged in a circle. Again, the cantilever lugs 7304 are separated by slits 7306. Each of the cantilever lugs 7304 has a snap head 7308 with an undercut notch 7310. The base 8802 has a spacer flange 8804 configured to received in the cap cavity 8208. Turning to FIGS. 89 and 90, The base 8802 defines a rail notch 8902 where the slat caps 6706 engages the bottom deck slat 6206. The slat caps 6706 has the frame sockets 7402 in the base 8802 where the bottom deck slat 6206 is secured. In the illustrated example, the slat caps 6706 have a single one of the frame sockets 7402 that extends longitudinally. In other examples, the slat caps 6706 can include more frame sockets 7402 than are shown (or none), and the frame sockets 7402 can be oriented in other ways. Each of the frame sockets 7402 includes the socket cavity 7404 in which the bottom deck slat 6206 is received. Inside the socket cavity 7404, each of the slat caps 6706 has the frame plug 7406 that is configured to extend inside the fill cavities 7102. In the illustrated example, the frame plug 7406 is configured to extend inside and/or plug the intermediate fill cavity 7108 in the bottom deck slat 6206, but in other examples, the frame plug 7406 can plug other fill cavities 7102 in the bottom deck slat 6206.

The slat caps 6706 and rail spacers 6804 in one variation are made of injection molded plastic. Alternatively or additionally, the slat caps 6706 and rail spacers 6804 can be made in other ways and with other materials such as composite materials like fiberglass. During assembly, the top deck rails 6118, bottom deck rails 6202, and bottom deck slat 6206 are filled with the fill material 3704 in the manner as depicted in FIGS. 72 and 87. The fill material 3704 in the fill cavities 7102 can partially pour out of the fill cavities 7102 of the frame members 6114 to partially fill the socket cavity 7404 in the slat caps 6706. Once cured in the frame sockets 7402, the fill material 3704 helps to secure the bottom deck slat 6206 to the slat caps 6706. The frame plug 7406 of the slat caps 6706 also provides a friction fit in the intermediate fill cavity 7108 of the bottom deck slat 6206 that helps to secure the bottom deck slat 6206 to the slat caps 6706. Alternatively or additionally, at least one fastener 1118 can be fastened through the bottom deck slat 6206 and the frame plug 7406 (or elsewhere) on the slat caps 6706 to secure the bottom deck slat 6206 to the slat caps 6706. Before, during, or after filling of the fill material 3704, the mid-spacer connectors 6704 are fastened to the top deck rails 6118 with fasteners like screws. The top deck rails 6118 and bottom deck rails 6202 are capped by their corresponding corner cap 6121, and the rest of the top deck 6102 and bottom deck 6104 are assembled. The slat ends 8504 of the bottom deck slat 6206 are likewise capped by the slat caps 6706. In one form, the corner spacers 6802 and rail spacers 6804 are snap connected to the top deck 6102, and subsequently, the slat caps 6706 along with the bottom deck slat 6206 are snap connected to the rail spacers 6804 and the rest of the bottom deck 6104 is snap connected to the corner spacers 6802. As for example shown in FIGS. 79, 84, and 89, the bottom deck rails 6202 float in the rail notch 8902 of the slat caps 6706. In other approaches, some or all of the spacer blocks 6116 can be attached to the bottom deck 6104 before being attached to the top deck 6102.

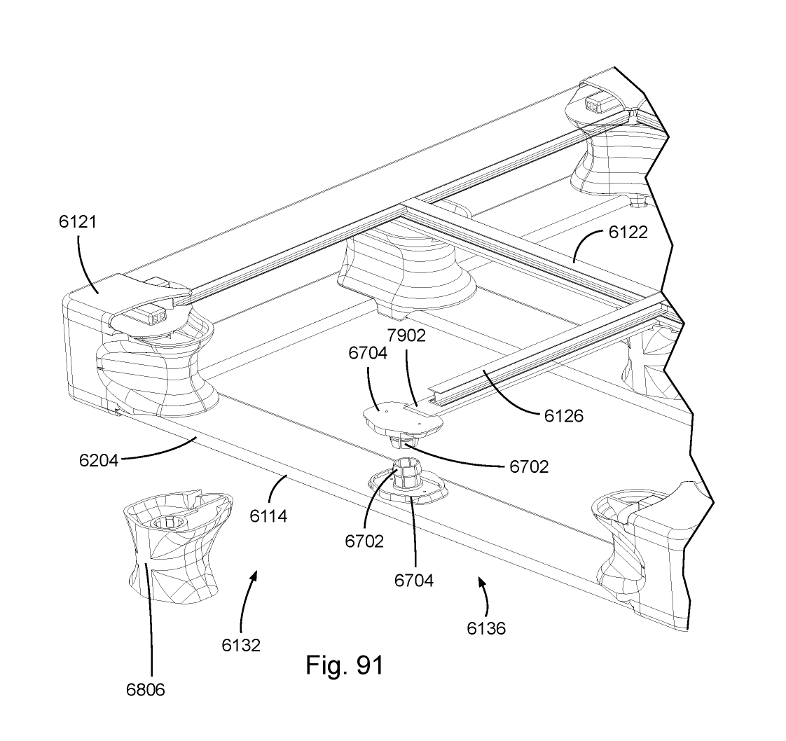

FIG. 91 shows a partial exploded view of one of the muntin joints 6132, and particularly, the stile muntin joint 6136. As illustrated, the frame members 6114 (e.g., the top deck stiles 6120 and bottom deck stiles 6204) are connected to the corner cap 6121 in the manner as described before. One or more fiber reinforcing ribs 1120 span between the corner cap 6121 and the stile spacers 6806. At the rail spacers 6804, the ends of the fiber reinforcing ribs 1120 rest on the muntin support rib 7902 which also supports the mid-rail 6126 of the muntin structure 6122 and the panels 6124. The mid-spacer connectors 6704 in one form are secured to the frame members 6114 via fasteners such as screws, but in other variations, the mid-spacer connectors 6704 can be secured to the top deck rails 6118 in other ways like with adhesives. Via the snap-fit connectors 6702, the mid-spacer connectors 6704 are connected to the stile spacers 6806.

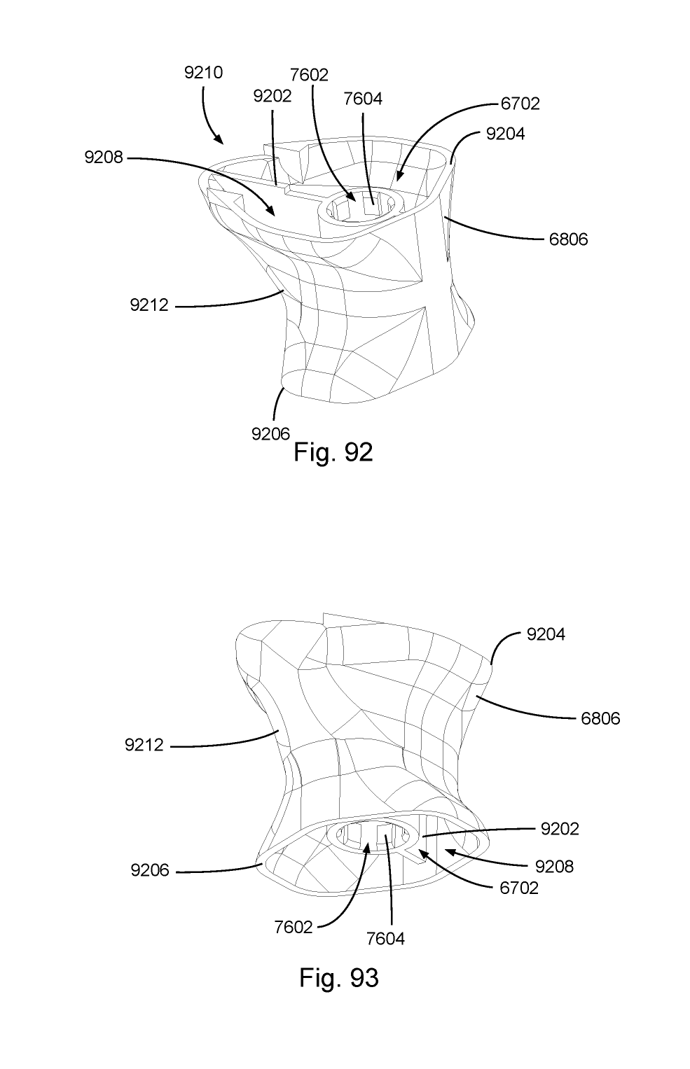

Top and bottom perspective views of the stile spacers 6806 are shown in FIGS. 92 and 93. The stile spacers 6806 form part of the snap-fit connectors 6702 with the socket lugs 7604. At the ends of each of the rail spacers 6804, the snap-fit connectors 6702 include the connector socket 7602 with one or more socket lugs 7604 configured to engage the cantilever lugs 7304 on the mid-spacer connectors 6704. Together, the connector socket 7602 of the stile spacers 6806 and the connector protrusion 7302 of the mid-spacer connectors 6704 form the snap-fit connectors 6702. In the illustrated example, the stile spacers 6806 include one connector socket 7602 at each end, but in other examples, the stile spacers 6806 can have more or less. As shown, the stile spacers 6806 further have one or more spacer ribs 9202 that provide structural support as well as reduce the overall weight of the stile spacers 6806. The stile spacers 6806 further include a top deck engagement edge 9204 and a bottom deck engagement edge 9206 that surrounds a cap cavity 9208 in which the mid-spacer connectors 6704 are received. The top deck engagement edge 9204 has a muntin notch 9210 that receives the muntin support rib 7902. The stile spacers 6806 further has a fork engagement surface 9212 that guides the forks in the fork openings 6110. In the depicted example, the fork engagement surface 9212 has an hourglass shape.

The stile spacers 6806 in one variation are made of injection molded plastic. Alternatively or additionally, the stile spacers 6806 can be made in other ways and with other materials such as composite materials like fiberglass. During assembly, the top deck stiles 6120 and bottom deck stiles 6204 are filled with the fill material 3704 in the manner as depicted in FIG. 72. Before, during, or after filling of the fill material 3704, the mid-spacer connectors 6704 are fastened to the top deck stiles 6120 and bottom deck stiles 6204 with fastener 1118 like screws. The top deck stiles 6120 and bottom deck stiles 6204 are capped by their corresponding corner cap 6121, and the rest of the top deck 6102 and bottom deck 6104 are assembled. Once the top deck 6102 and bottom deck 6104 are assembled, all of the stile spacers 6806 can be snap connected to the mid-spacer connectors 6704 to one of the decks, or some of the stile spacers 6806 can be snap connected to each of the decks. Both the top deck stiles 6120 and bottom deck stiles 6204 can be snap connected together.

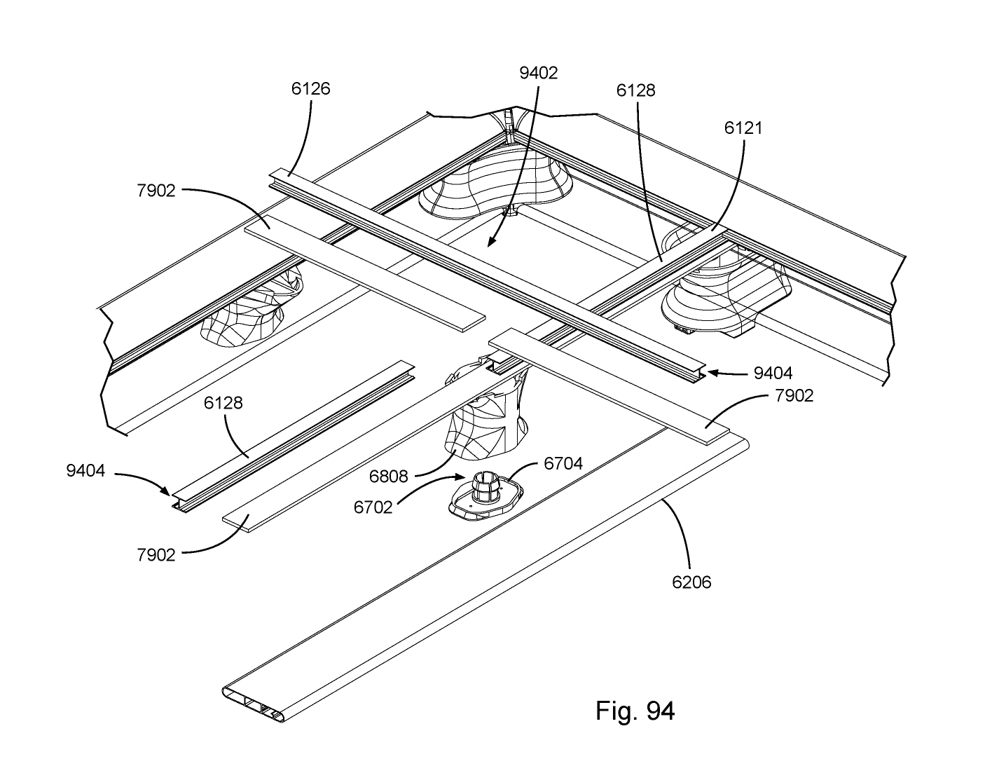

FIG. 94 shows an exploded view of a muntin support joint 9402 that supports generally the center of the muntin structure 6122. As noted before, the muntin structure 6122 includes the mid-rail 6126 and mid-stile 6128 that are each supported by a muntin support rib 7902. In the illustrated example, both the mid-rail 6126 and the mid-stile 6128 are in the form of I-beams with opposing panel channels 9404 for receiving the panels 6124. At the muntin support joint 9402 where the mid-rail 6126 and the mid-stile 6128 intersect, the muntin spacer 6808 supports the muntin structure 6122 via the muntin spacer 6808 and the bottom deck slat 6206. The mid-spacer connectors 6704 in one form are secured to the bottom deck slat 6206 via at least one fastener 1118 such as a screw, but in other variations, the mid-spacer connectors 6704 can be secured to the bottom deck slat 6206 in other ways like with adhesives. The snap-fit connectors 6702 between the mid-spacer connectors 6704 and the muntin spacer 6808 anchors the muntin spacer 6808 to the bottom deck slat 6206.

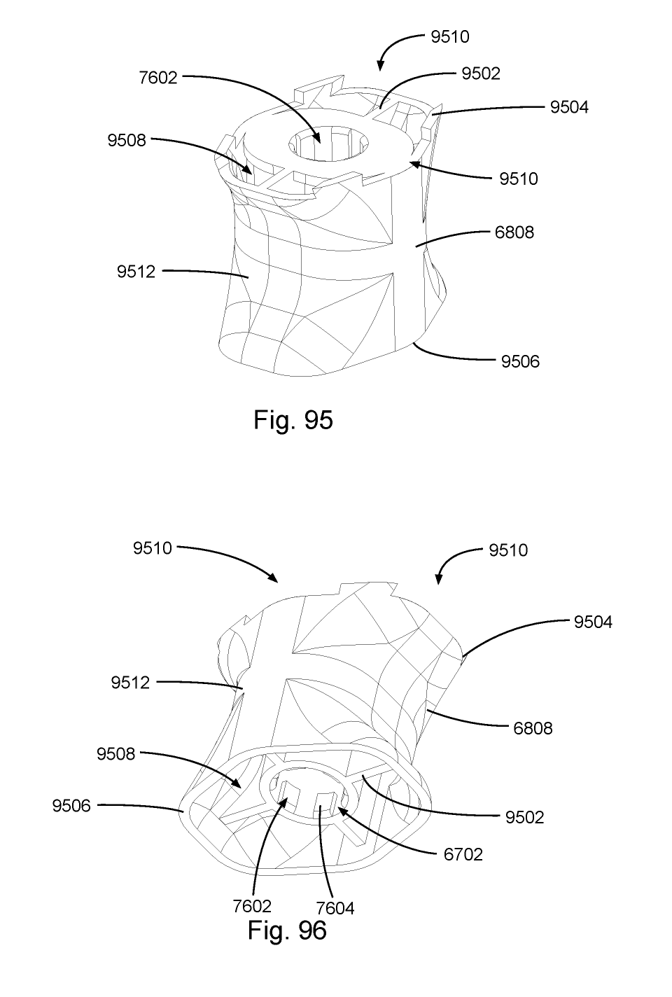

Looking at FIGS. 95 and 96, the muntin spacer 6808 includes the connector socket 7602. At the ends of each rail spacers 6804, the snap-fit connectors 6702 includes the connector socket 7602 with socket lugs 7604. While both ends of the muntin spacer 6808 have a connector socket 7602, only the one facing the mid-spacer connectors 6704 on the bottom deck slat 6206 is used to form a snap fit type connection. Together, the connector socket 7602 of the stile spacers 6806 and the connector protrusion 7302 of the mid-spacer connectors 6704 form the snap-fit is connectors 6702. In the illustrated example, the muntin spacer 6808 includes one connector socket 7602 at each end, but in other examples, the stile spacers 6806 can have more or less. As shown, the muntin spacer 6808 further has one or more spacer ribs 9502 that provide structural support as well as reduce the overall weight of the muntin spacer 6808. The muntin spacer 6808 further include a top deck engagement edge 9504 and a bottom deck engagement edge 9506 that surrounds a cap cavity 9508. The top deck engagement edge 9504 has at least one muntin notch 9510 that receive the muntin support rib 7902. The muntin spacer 6808 further has a fork engagement surface 9512 that guides the forks in the fork openings 6110. In the depicted example, the fork engagement surface 9512 has an hourglass shape. The muntin spacer 6808 in one variation is made of injection molded plastic. Alternatively or additionally, the muntin spacer 6808 can be made in other ways and with other materials such as composite materials like fiberglass.

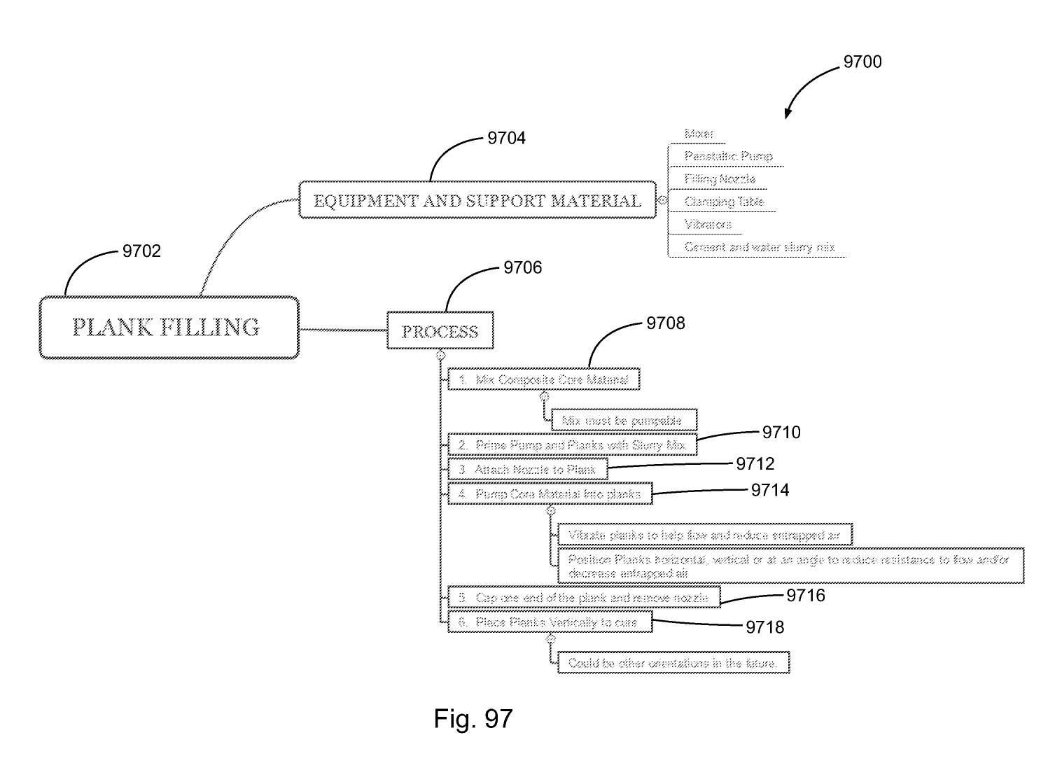

A technique for manufacturing the frame members 6114 for the pallet 6100 will now be described with reference to flowchart 9700 shown in FIG. 97. In stage 9702, the process for filling the frame members 6114, including the bottom deck slat 6206, (planks) is initiated. In one example, the ends of the frame members 6114 and bottom deck slat 6206 are shaped into their final shapes before filling, and in other examples, the frame members 6114 and bottom deck slat 6206 are initially generic planks that have their ends cut or otherwise shaped after being filled. The equipment and support material for performing the process are provided in stage 9704. Among other things, a mixer for mixing the fill material 3704 is used along with a peristaltic pump for pumping the fill material 3704 into the frame members 6114 and bottom deck slat 6206. At least one nozzle 3900 (FIG. 39) is used to pump the fill material 3704 into the fill cavities 7102. Clamping tables in one example are used to hold the frame members 6114 and bottom deck slat 6206 in place during filling, but in other examples, the planks can be filled using a continuous process where the planks move. Vibrators are used to remove any air pockets in the fill material 3704 when filled, and a slurry mix is used to prime the fill cavities 7102 before being filled with the fill material 3704.

Starting at stage 9706, the process is initiated. The fill material 3704 is formulated and mixed by the mixer in stage 9708. In one form, the fill material 3704 is formulated to include, among other things, water, cement, fiber reinforced material, and microspheres. In one particular example, the fill material 3704 is formulated in accordance with the composite core formulation described in U.S. patent application Ser. No. 15/941,416, filed on Mar. 30, 2018, entitled “Fiber Reinforced Composite Core Formulation” (Attorney Docket No. 003436-000144) which is hereby incorporated by reference in its entirety. The fill material 3704 is formulated in the manner as described above not only to be lightweight and durable, but the fill material 3704 is also formulated to be pumpable such that the fill material 3704 is able to flow in the fill cavities 7102. To facilitate smooth flow of the fill material 3704 in the fill cavities 7102, the pump is primed in stage 9710 with a cement and water slurry mix, and this cement and water slurry mix is pumped into the fill cavities 7102 to help lubricate the subsequent flow of the fill material 3704. After priming, the nozzle 3900 is attached to the plank (e.g., the frame members 6114 and/or bottom deck slat 6206) in stage 9712, and the fill material 3704 is pumped into the fill cavities 7102 of the planks such as in the manner illustrated in FIGS. 72 and 87. During stage 9714, the planks can be vibrated by a vibrating mechanism to reduce the amount of air entrapped in the fill cavities 7102. The planks can also be angled to reduce entrapped air and/or reduce flow resistance of the fill material 3704 in the fill cavities 7102. In stage 9716, one or both ends of the plank are capped to retain the fill material 3704. For the frame members 6114, the corner cap 6121 is used to cap at least one end in one example, and the slat caps 6706 is used to cap at least one end of the bottom deck slat 6206. The fill material 3704 in the planks are cured in stage 9718. In one example, the frame members 6114 and bottom deck slat 6206 are cured in a vertical orientation to allow any entrapped air to escape, and in other examples, the planks can be cured in other orientations. The planks in one variation are fully cured before being assembled into the pallet 6100, but in other variations, the frame members 6114 and bottom deck slat 6206 can be at least partially cured during or after assembly of the pallet 6100. For instance, the fill material 3704 in the top deck 6102 and the bottom deck 6104 can be cured before the top deck 6102 and the bottom deck 6104 are snap fitted together with the spacer structure 6106. In another example, the curing continues after the top deck 6102 and the bottom deck 6104 are snap fitted together with the spacer structure 6106. After assembly of the pallet 6100, a skim coat of the fill material 3704 in one example is applied to the muntin structure 6122 and panels 6124. In other examples, no skim coat is applied.

Referring to FIGS. 61, 69, and 72, the spacer structure 6106 in one example is again made of injection molded plastic. The spacer blocks 6116 in the spacer structure 6106 are empty (only contain air) in one variation, but in other variations, some or all of the spacer blocks 6116 are filled with fill material 3704. As noted previously, the frame plug 7406 in one example is inserted into the intermediate fill cavity 7108 of the frame members 6114 to stabilize and strengthen the connection. Before, during, or after filling of the fill material 3704, the mid-spacer connectors 6704 is fastened to the top deck rails 6118 with fasteners like screws. The top deck rails 6118 and bottom deck rails 6202 are capped by their corresponding corner cap 6121, and the rest of the top deck 6102 and bottom deck 6104 are assembled. The slat ends 8504 of the bottom deck slat 6206 are likewise capped by the slat caps 6706. In one form, the corner spacers 6802 and rail spacers 6804 are snap connected to the top deck 6102, and subsequently, the slat caps 6706 along with the bottom deck slat 6206 are snap connected to the rail spacers 6804 and the rest of the bottom deck 6104 is snap connected to the corner spacers 6802. As for example shown in FIGS. 79, 84, and 89, the bottom deck rails 6202 float in the rail notch 8902 of the slat caps 6706. In other approaches, some or all of the spacer blocks 6116 can be attached to the bottom deck 6104 before being attached to the top deck 6102. The mid-spacer connectors 6704 are fastened to the top deck stiles 6120 and bottom deck stiles 6204 with fasteners like screws. The top deck stiles 6120 and bottom deck stiles 6204 are capped by their corresponding corner cap 6121, and the rest of the top deck 6102 and bottom deck 6104 are assembled. Once the top deck 6102 and bottom deck 6104 are assembled, all of the stile spacers 6806 can be snap connected to the mid-spacer connectors 6704 on one of the decks or some of the stile spacers 6806 can be snap connected to each of the decks. Both the top deck stiles 6120 and bottom deck stiles 6204 can be snap connected together. As should be recognized, this technique allows the pallet 6100 to be assembled rather quickly and efficiently.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Bottom Deck” generally refers to one or more panels and/or assemblies of boards that form the load-bearing surface of the pallet that typically rests against another object such as the floor, ground, other pallet, and/or other unit load. The bottom deck usually, but not always, includes jack openings that allow pallet jack wheels to engage the floor or ground.

“Brittle Inorganic Matrix Precursor” refers generally to one or more conventional hydraulic cements or inorganic polymers as a hydraulic inorganic component and/or epoxy or inorganic polymers such as geopolymers based on silicoaluminates. “Hydraulic cement” is meant to include a cement which sets, or hardens, in the presence of water, including but not limited to Portland cement, blended Portland cement, expansive cement, rapid setting and hardening cement, calcium aluminate cement, magnesium phosphate, and mixtures thereof may also be used.

“Carbon Fiber Material” refers generally to a type of fiber reinforced material that includes, but is not limited to, a material of thin, strong crystalline filaments of carbon, used as a strengthening material, such as in resins and ceramics. For example, carbon fiber materials include strong lightweight synthetic fibers made especially by carbonizing a fiber at high temperatures.

“Cement” generally refers to a binder that sets, hardens, and adheres to other materials, binding them together. Typically, but not always, cement is inorganic, often lime or calcium silicate based. By way of non-limiting examples, cement can include a powdery substance made with calcined lime and clay. In one form, cement can be mixed with water to form mortar. In another form, when mixed with water, cement can bind sand and gravel (or other aggregate) together to produce concrete. Cement can be categorized as being hydraulic or non-hydraulic which depends on the ability of the cement to set in the presence of water. Non-hydraulic cement typically does not set in wet conditions or under water. Non-hydraulic cement sets as the cement dries and reacts with carbon dioxide in the air. Once set, the non-hydraulic cement is normally resistant to chemical attack. Hydraulic cement, such as Portland cement, sets and becomes adhesive due to a chemical reactions between the dry ingredients and water. The chemical reaction results in mineral hydrates that are not very water-soluble and so are quite durable in water and safe from chemical attack. Hydraulic cement is typically able to set in wet conditions or under water. Once set, the hydraulic cement can protect the hardened material from chemical attack.

“Concrete” generally refers to a material made from a mixture of broken stone or gravel, sand, cement, and water that can be spread/poured into molds and/or extruded to form a stone like mass on hardening.

“Deck” generally refers to a surface of a pallet, including one or more boards and/or panels, with or without space between the elements. Pallets can typically include one or more of the following types of decks: a top deck and/or a bottom deck. The directional terms “top” and “bottom” when referring to these types of deck are common nomenclature used in industry, and it is not the intent that these directional terms limit the types of decks to a specific orientation or direction. For example, in a reversible pallet, the pallet has identical or similar top and bottom decks that can be flipped on either face of the pallet to support the unit load.

“Elastic” generally refers to a solid material and/or object that is capable of recovering size and/or shape after deformation. Elastic material typically is capable of being easily stretched, expanded, and/or otherwise deformed, and once the deforming force is removed, the elastic material returns to its original shape. By way of non-limiting examples, elastic materials include elastomers and shape memory metals. For instance, elastic materials can include rubber bands and bungee cords.

“Engineered Cementitious Composite” (ECC), also known as “bendable concrete” or “Engineered Cementitious Concrete”, generally refers to a type of concrete composite material that is reinforced with short random polymer fibers, such as polyvinylalcohol (PVA) fibers. These polymer fibers may be used in a low volume fraction, such as 2-3% by volume, in a concrete mixture to create a concrete matrix with greater tensile strain capacities than a traditional concrete mixture. In other words, ECC is one specific species of Fiber Reinforced Concrete (FRC) that uses polymer fibers so as to provide superior qualities. Unlike regular concrete, ECC has a strain capacity in the range of 3-7%, compared to 0.1% for Ordinary Portland Cement (OPC). ECC therefore acts more like a ductile metal than a brittle concrete (as does OPC). Tests done on ECC material have shown a higher relative strength in tension, greater resistance to catastrophic fatigue cracking, increased durability under reversed loading, and greater dynamic tensile loading capability under projectile impact. More specifically, in some cases, the tensile strain capacity may be approximately 500 times greater than that of standard concrete aggregate mixtures. In one example, the polymer fibers in the concrete mixture are selected to optimize the concrete matrix for the highest tensile strain capacity. PVA fibers are often selected due to the high chemical bonds between the PVA fiber and the concrete and/or the appropriate frictional stresses at this interface. If the interaction between the fibers and the concrete mixture is too strong, the fibers will not stretch properly and the supporting concrete matrix may rupture. In one embodiment, the strength of the interaction between the fibers and the concrete mixture is in a selected range such that when micro cracks form, they will propagate to other locations in the concrete matrix, thus causing strain hardening in the macro level of the ECC material. There are a number of different varieties of ECC.

“Extrudable ECC” generally refers to an ECC material that is formulated for extrusion. Extrudable ECC materials have both higher load capacity and higher deformability than other extruded fiber-reinforced composite materials.

“Fastener” generally refers to a hardware device that mechanically joins or otherwise affixes two or more objects together. By way of nonlimiting examples, the fastener can include bolts, dowels, nails, nuts, pegs, pins, rivets, screws, and snap fasteners, to just name a few.

“Fiber Reinforced Concrete” (FRC) generally refers to concrete containing fibrous material which increases its structural integrity. FRC contains short discrete fibers that are uniformly distributed and randomly oriented. These fibers can include steel fibers, glass fibers, synthetic fibers, and/or natural fibers that tend to vary the properties to the concrete. The characteristics of FRC can change by changing concretes, fiber materials, geometries, distribution, orientation, and/or densities.

“Fiber Reinforced Material” refers generally to any material including fibers of high strength and modulus embedded in or bonded to a matrix with distinct interfaces (boundary) between them. In one example, the fiber reinforced material includes a fiber reinforcement and an encapsulating matrix. A fiber (a fiber or fiber tow typically includes a bundle of filaments) is generally considered to be continuous if the fiber extends from one edge of a ply of material to another edge, most often the opposing edge. While all fibers in a fiber reinforced material need not be continuous, a substantial majority of the fibers will be continuous in some examples.

“Frame” generally refers to a structure that forms part of an object and gives strength and/or shape to the object.

“Lightweight ECC” or “low density ECC” generally refers to ECC that contains air voids, glass bubbles, polymer spheres, and/or lightweight aggregate. Compared to other lightweight concretes, lightweight ECC has superior ductility.

“Mean Diameter” or average diameter generally refers to the sum of the diameters divided by the number of diameters summed.

“Mean Length” or average length generally refers to the sum of the lengths divided by the number of lengths summed.

“Mean Particle Size” generally refers to a particle size measured in microns by volume.

“Microspheres” or “Microparticles” generally refer to small typically spherical particles, with diameters in the micrometer range (usually 1 μm to 1000 μm). Microspheres are generally made from various natural and synthetic materials. The microspheres can be made from recycled material. Glass microspheres, polymer microspheres, and ceramic microspheres are common types of microspheres. More specifically, microspheres can include glass, polyethylene, polystyrene, and/or expandable microspheres. The microspheres can be solid or hollow and can vary widely in density.

“Mortise and tenon joint” generally refers to a structure where at least two parts are interlocked together through a mortise hole or opening and the tenon tongue or member. Typically, but not always, the components attached together with the mortise and tenon joint are oriented transverse to one another, usually at a 90 degree angle. The mortise is a hole, slot or other opening in which the tenon is received. By way of nonlimiting examples, the mortise can include an open mortise, a stub mortise, a through mortise, a wedged half-dovetail mortise, and through-wedge half dovetail designs, to name just a few. The tenon is a projecting structure that is received in the mortise. By way of nonlimiting examples, the tenon can include stub tenon, through tenon, loose tenon, biscuit tenon, pegged/pinned tenon, tusk tenon, teasel tenon, top tenon, hammer-headed tenon, and half shoulder tenon type designs, to name just a few examples. Typically, but no always, the mortise and tenon have similar dimensions to promote a tight fit between the two attached components.

“Pallet” generally refers to a portable platform or other structure on which goods or items can be assembled, stacked, stored, packaged, handled, transported, and/or moved, such as with the aid of a forklift or pallet jack, as a unit load. Typically, but not always, the pallet is rigid and forms a horizontal base upon which the items rest. Goods, shipping containers, and other items are often placed on a pallet secured with strapping, stretch wrap, and/or shrink wrap. Often, but not always, the pallet is equipped with a superstructure. In one form, the pallet includes structures that support goods in a stable fashion while being lifted by a forklift, pallet jack, front loader, and/or other lifting devices. In particular, pallets typically include a top deck upon which items are stacked, a bottom deck that rests on the ground, and a spacer structure positioned between the top and bottom decks to receive the forks of the forklift or pallet jack. However, the pallets can be configured differently. For example, the term pallet is used in a broader sense to include skids that have no bottom deck. One or more components of the pallet, or even the entire pallet, can be integrally formed together to form a single unit. By way of non-limiting examples, these pallets can include stringer, block, perimeter, skid, solid deck, multiple deck board, panel-deck, slave, double-deck (or face), single-way entry, two-way entry, four-way entry, flush, single-wing, double-wing, expendable, limited-use, multiple-use, returnable, recycled, heat treated, reversible, non-reversible, and/or warehouse type pallets.

“Polystyrene Foam” generally refers to a substance in which pockets of gas are trapped in a synthetic aromatic polymer made from the monomer styrene. In other words, polystyrene foam generally refers to a multicellular expanded and/or extruded synthetic resinous material. The polystyrene material is typically, but not always, foamed with the aid of a blowing agent, such as chlorofluorocarbon (now typically banned due to environmental concerns), pentane, and/or carbon dioxide gas blowing agents, to name just a few examples, in order to form bubbles in the polystyrene foam. The trademark STYROFOAM® by Dow Chemical Company is commonly used to refer to all forms of polystyrene foam products. The term polystyrene foam is used in a broad context to include expanded polystyrene (EPS) and extruded polystyrene.

“Seam” generally references to an interface where two or more metal sheets are rolled or otherwise folded to join the two sheets together. Typically, but not always, the seam is formed near or at the edges of the sheet. By way of non-limiting examples, the seams can include a grooved seam joint, a single bottom seam, a lap seam, a countersunk lap seam, an outside lap seam, a standing seam, a flat lock seam, a grooved flat lock seam, a lap bottom seam, and/or an insert bottom seam, to name just a few.

“Self-compacting ECC” generally refers to an ECC material that can flow under its own weight. For instance, a self-compacting ECC material is able to fill a mold containing elaborate pre-positioned steel reinforcement without the need of vibration or shaking to ensure even distribution. Self-compacting ECC contains chemical admixtures to decrease viscosity and control particle interactions with mix proportioning.

“Snap-Fit Connector” or “Snap-Fit Connection” generally refers to a type of attachment device including at least two parts, with at least one of which being flexible, that are interlocked with one another by pushing the parts together. The term “Snap-Fit Connector” may refer to just one of the parts, such as either the protruding or mating part, or both of the parts when joined together. Typically, but not always, the snap-fit connector includes a protrusion of one part, such as a hook, stud and/or bead, that is deflected briefly during the joining operation and catches in a depression and/or undercut in the mating part. After the parts are joined, the flexible snap-fit parts return to a stress-free condition. The resulting joint may be separable or inseparable depending on the shape of the undercut. The force required to separate the components can vary depending on the design. By way of non-limiting examples, the flexible parts are made of a flexible material such as plastic, metal, and/or carbon fiber composite materials. The snap-fit connectors can include cantilever, torsional and/or annular type snap-fit connectors. In the annular snap-fit type connector, the connector utilizes a hoop-strain type part to hold the other part in place. In one form, the hoop-strain part is made of an elastic material and has an expandable circumference. In one example, the elastic hoop-strain part is pushed onto a more rigid part so as to secure the two together. Cantilever snap-fit type connectors can form permanent type connections or can be temporary such that the parts can be connected and disconnected multiple times. A multiple use type snap-fit connector typically, but not always, has a lever or pin that is pushed in order to release the snap-fit connection. For a torsional snap fit connector, protruding edges of one part are pushed away from the target insertion area, and the other part then slides in between the protruding edges until a desired distance is reached. Once the desired distance is reached, the edges are then released such that the part is held in place.

“Spacer Structure” generally refers to any component, part, object, device, and/or assembly that separates the top deck from an object on which the pallet rests, such as the ground, floor, other pallet, and/or other unit load. By way of nonlimiting examples, the spacer structure can include one or more blocks, stringers, and/or other spacers. Typically, but not always, the spacer structure defines one or more fork entries that each form an entry for admitting one or more forks of a forklift or pallet jack. The fork entry can for instance be formed by the space created between the top and bottom decks by stringers and/or blocks as well as one or more notches in the stringers or other parts of the pallet to name just a few examples. In one form, the fork entries can be located on opposite ends of the pallet to create a two-way entry pallet, and in another form, the fork entries can be located on both opposite ends and opposite sides of the pallet to create a four-way entry pallet. In other examples, the spacer structure can include more or less, and even none, fork entries.

“Sprayable ECC” generally refers to an ECC material that is able to be pneumatically sprayed. Sprayable ECC includes one or more superplasticizing agents and viscosity-reducing admixtures.

“Top Deck” generally refers to one or more panels and/or assemblies of boards that form the load carrying face of the pallet on which goods or items are supported.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 pallet
102 top deck
104 bottom deck
106 spacer structure
108 frame or exoskeleton structure
110 fork openings
112 jack openings
114 frame members
115 corners
116 blocks
118 top deck rails
120 top deck stiles
121 corner cap
122 muntin structure
123 window openings
124 panes
126 rail muntin
128 stile muntin
202 bottom deck rails
204 bottom deck stiles
206 bottom deck slat
310 tenon tabs
312 tenon tabs
1102 panel support slats
1104 frame member joints
1106 muntin joints
1108 tenons
1110 mortise openings
1112 muntin tenons
1804 outer surface
1114 mortise openings
1116 fastener opening
1118 fastener
1120 fiber reinforcing ribs
1124 fiber reinforced ribs
1202 deck slat joints
1204 tenons
1206 mortise openings
1402 fill cavity
1404 fastener holes
1406 fastener ribs
1408 corners
1502 crown
1504 body
1506 root
1508 lip
1602 fill opening
1604 fill gap
1702 base sheet
1704 cover sheet
1706 fill cavity
1708 main body
1710 base tenon tab
1712 cover tenon tab
1714 tenon gap
1716 cap engagement edge
1718 miter edge
1720 rib retention lips
1802 inner surface
2514 spacer ledge
1806 window facing edge
1808 outer peripheral edge
1810 seams
1812 window ledge
1814 spacer ledge
1816 beveled surface
2130 seams
2302 inner surface
2304 outer surface
2306 jack opening facing edge
2308 outer peripheral edge
2310 seams
2312 first spacer ledges
2314 second spacer ledges
2316 beveled surface
2318 spacer channel
2402 base sheet
2404 cover sheet
2406 fill cavity
2408 main body
2410 miter edge
2412 cap engagement edge
2502 inner surface
2504 outer surface
2506 window facing edge
2508 outer peripheral edge
2510 seams
2512 window ledge
2513 fastener opening
3802 internal reinforcement arrangement
3804 foam ribs
2516 beveled surface
3002 inner surface
3004 outer surface
3006 jack opening facing edge
3008 outer peripheral edge
301O seams
3012 first spacer ledges
3014 second spacer ledges
3016 beveled surface
3018 spacer channel
3102 base sheet
3104 cover sheet
3106 fill cavity
3108 main body
3110 base tenon tab
3112 cover tenon tab
3114 tenon gap
3116 miter edge
3118 miter edge
3202 inner surface
3204 outer surface
3206 first window facing edge
3208 second window facing edge
3210 seams
3212 window ledge
3214 ledges
3214 fastener opening
3702 internal reinforcement arrangement
3704 fill material
4602 bottom dock rails
4604 bottom deck stiles
3900 nozzle
3902 neck
3904 bead
3906 fill passage
4302 fastener opening position
4402 skim coal
4404 protective coating
4500 pallet
4502 top deck
4504 bottom deck
4506 spacer structure
4508 frame structure
4510 fork openings
4512 fastener opening
4512 jack openings
4514 frame members
4515 corners
4316 spacer blocks
4518 top deck rails
4520 top deck stiles
4521 corner cap
4522 muntin structure
4523 window openings
4524 panels
4526 rail muntin
4528 stile muntin
4530 frame member joints
4532 muntin joints
5416 spacer blocks
5418 top deck rails
5420 top deck stiles
4606 bottom dock slat
4608 deck slat joints
4702 rail slat
4704 mortise openings
4706 panel support slats
4708 tenons
4710 mortise openings
4902 tenon tabs
4904 tenon gap
4906 cap retention notches
5002 fill opening
5004 grommets
5202 crown
5204 body
5206 root
5208 lip
5210 lock tabs
5212 fastener opening
5400 pallet
5402 top deck
5404 bottom deck
5406 spacer structure
5406 spacer structure
5408 frame structure
5410 fork openings
5412 jack openings
5414 frame members
5415 corners
6100 pallet
6102 top deck
6104 bottom deck
5421 corner cap
5422 muntin structure
5423 window openings
5424 panels
5426 tint or rail muntin
5428 stile muntin
5430 frame member joints
5432 muntin joint
5434 frame joint braces
5434 frame
5436 muntin joint braces
5438 cross brace
5440 alignment openings
5502 bottom deck rails
5504 bottom deck stiles
5506 bottom deck slat
5508 bottom deck slat joints
5602 fill channel
5702 tenon tabs
5704 mortise openings
5706 stile notch
5708 muntin tabs
5902 crown
5904 body
5906 root section
5908 lip
5910 fastener opening
6804 rail spacers
6806 stile spacers
6808 muntin spacer
7002 shell
6106 spacer structure
6108 frame structure
6110 fork openings
6112 jack openings
6114 frame members
6115 corners
6116 spacer blocks
6118 top deck rails
6120 top deck stiles
6121 corner cap
6122 muntin structure
6123 window openings
6124 panels
6126 mid-rail
6128 mid-stile
6130 frame member joints
6132 muntin joints
6134 rail muntin joint
6136 stile muntm joint
6202 bottom deck rails
6204 bottom deck stiles
6206 bottom deck slat
6208 slat joint
6702 snap-fit connectors
6704 mid-spacer connectors
6706 slat caps
6802 corner spacers
7610 cap cavity
7612 cap alignment notches
7614 fork engagement surface
7902 muntin support rib
7004 corner cap ends
7006 miter edge
7008 cap engagement edge
7102 fill cavities
7104 divider walls
7106 interior fill cavity
7108 intermediate fill cavity
7110 exterior fill cavity
7112 rib engagement flanges
7114 support rib channel
7202 support rib
7301 base
7302 connector protrusion
7304 cantilever lugs
7306 slits
7308 snap bead
7310 undercut notch
7402 frame sockets
7404 socket cavity
7406 frame plug
7502 engagement teeth
7504 spacer flange
7602 connector socket
7604 socket lugs
7606 spacer ribs
7608 cap engagement edges
9508 cap cavity
9510 muntin notch
9512 fork engagement surface
9700 flowchart
9702 stage
8002 base
8004 fastener opening
8006 muntin support notch
8202 spacer ribs
8204 top deck engagement edge
8206 bottom deck engagement edge
8208 cap cavity
8210 muntin notch
8212 fork engagement surface
8502 shell
8504 slat ends
8506 slat edges
8802 base
8804 spacer flange
8902 rail notch
9202 spacer ribs
9204 top deck engagement edge
9206 bottom deck engagement edge
9208 cap cavity
9210 muntin notch
9212 fork engagement surface
9402 muntin support joint
9404 panel channels
9502 spacer ribs
9504 top deck engagement edge
9506 bottom deck engagement edge
9704 stage
9706 stage
9708 stage
9710 stage
9712 stage
9714 stage
9716 stage
9718 stage

What is claimed is:

1. A pallet, comprising:
a frame member at least partially filled with concrete;
a spacer structure defining at least in part with the frame member a fork opening; and
a snap connector connecting the frame member to the spacer structure.

2. The pallet of claim 1, wherein the spacer structure includes a spacer block having at least part of the snap connector.

3. The pallet of claim 2, further comprising:
a cap secured to an end of the frame member, wherein the cap is connected to the spacer block through the snap connection.

4. The pallet of claim 3, further comprising:
wherein the frame member is a first frame member;
a second frame member at least partially filled with the concrete; and
wherein the cap secures the first frame member and the second frame member together.

5. The pallet of claim 4, wherein the cap is a corner cap securing the first frame member and the second frame member at a transverse orientation.

6. The pallet of claim 5, wherein the first frame member and the second frame member each has a mitered edge angled at an acute angle.

7. The pallet of claim 3, wherein the cap has a frame socket receiving the end of the frame member.

8. The pallet of claim 7, wherein the frame socket has a frame plug extending into the frame member.

9. The pallet of claim 8, wherein the frame plug extends into one of a plurality of fill cavities in the frame member.

10. The pallet of claim 9, wherein:
at least one of the fill cavities is an empty fill cavity that is unfilled with the concrete; and
the frame plug extends into the empty fill cavity.

11. The pallet of claim 10, wherein the empty fill cavity is an intermediate cavity located between at least two of the fill cavities that are at least partially filled with the concrete.

12. The pallet of claim 11, further comprising:
wherein at least one of the fill cavities filled with the concrete have a support rib channel; and
a support rib received in the rib support channel.

13. The pallet of claim 3, wherein:
the cap is a slat cap; and
the frame member is a deck slat secured to the slat cap.

14. The pallet of claim 13, further comprising:
a rail; and
wherein the slat cap has a rail notch through where the rail extends.

15. The pallet of claim 3, wherein the snap connector includes:
a connector protrusion extending from the cap; and
a connector socket in the spacer block where the connector protrusion is secured.

16. The pallet of claim 2, further comprising:
a mid-spacer connector secured to the frame member; and
the mid-spacer having at least part of the snap connector.

17. The pallet of claim 16, further comprising:
a muntin structure; and
the mid-spacer connector having a muntin notch supporting the muntin structure.

18. The pallet of claim 17, wherein:
the spacer structure includes a spacer block having a muntin notch;
the mid-spacer connector is connected to the spacer block; and
the muntin notch of the mid-spacer connector and the muntin notch of the spacer block are aligned.

19. The pallet of claim 18, wherein the spacer block has at least two connector sockets at each end.

20. The pallet of claim 17, wherein the spacer block is a muntin spacer with muntin notches formed in a cross pattern.

21. The pallet of claim 17, wherein the muntin structure supports one or more panels.

22. The pallet of claim 21, further comprising:
a fiber reinforcement rib supporting at least one of the panels.

23. The pallet of claim 1, further comprising:
a top deck having the frame member;
a bottom deck at least partially filled with the concrete; and
the top deck and the bottom deck being connected together through the spacer structure at least in part through the snap connector.

24. The pallet of claim 1, wherein the concrete includes cement, reinforcement fibers, and microspheres.

25. The pallet of claim 24, wherein the frame member has a metal exterior.

26. A method, comprising:
filling one or more fill cavities in a deck with concrete; and
snap connecting the deck to a spacer structure with a snap connector to at least in part define one or more fork openings of a pallet.

27. The method of claim 26, further comprising:
filling one or more fill cavities in a second deck with the concrete; and
snap connecting the second deck to the spacer structure with a second snap connector.

28. The method of claim 26, further comprising:
priming the fill cavities by pouring a slurry through the fill cavities before said filling, wherein the slurry consists essentially of water and cement.

29. The method of claim 26, wherein:
the fill cavities include an interior fill cavity, an exterior fill cavity, and an intermediate fill cavity located between the interior fill cavity and the exterior fill cavity in a frame member; and
said filling includes filling the interior fill cavity and the exterior fill cavity with the concrete while the intermediate fill cavity is empty of concrete.

30. The method of claim 29, further comprising:
inserting the frame member into a frame socket of a cap that has at least part of the snap connector, wherein said inserting the frame member includes inserting a frame plug of the cap into the intermediate cavity in the frame member.

31. The method of claim 26, further comprising:
mixing cement, reinforcement fibers, and microspheres to create the cement before said filling.

32. The method of claim 31, further comprising:
forming a first frame member and a second frame each of which having the fill cavities, wherein said forming includes manufacturing the first frame member and the second frame member out of metal;
assembling the deck by attaching the first frame member to the second frame member with a corner cap, wherein the corner cap has a connector protrusion;
wherein the spacer structure includes a corner spacer having a socket cavity; and
wherein said snap connecting includes inserting the connector protrusion of the corner cap into the socket cavity of the corner spacer.
